(19) United States
(12) Patent Application Publication
(10) Pub. No.: US 2009/0103054 A1
(43) Pub. Date: Apr. 23, 2009

(54) Projection apparatus comprising spatial light modulator

(76) Inventors: Hirotoshi Ichikawa, Tokyo (JP); Yoshihiro Maeda, Tokyo (JP); Fusao Ishii, Menlo Park, CA (US)

Correspondence Address: Bo-In Lin, 13445 Mandoli Drive, Los Altos Hills, CA, 94022, US

(21) Appl. No.: 12/286,806

(22) Filed: Oct. 1, 2008

Related U.S. Application Data
(63) Continuation-in-part of application No. 11/121,543, filed on May 4, 2005, now Pat. No. 7,268,932.
Application No. 11/121,543 is a continuation-in-part of application No. 10/698,620, filed on Nov. 1, 2003.
Application No. 10/698,620 is a continuation-in-part of application No. 10/699,140, filed on Nov. 1, 2003, now Pat. No. 6,862,127.
Application No. 10/699,140 is a continuation-in-part of application No. 10/699,143, filed on Nov. 1, 2003, now Pat. No. 6,903,860.
(60) Provisional application No. 60/997,436, filed on Oct. 2, 2007.

(51) Int. Cl. G03B 21/14

(52) U.S. Cl. 353/33

(57) ABSTRACT

The present invention provides a projection apparatus, comprising: a light source; a plurality of spatial light modulators each comprising a micromirror for modulating and deflecting an incident light emitted from the light source in an intermediate direction between a first and a second directions and all angles between the first and second directions The projection apparatus further includes a projection optical system for projecting a modulation light modulated by the spatial light modulator The projection apparatus further includes a first joinder prism comprising a first optical surface with at least two of the incident lights with different frequencies projected thereto, a second optical surface for ejecting the incident light incident from the first optical surface and for projecting the modulation light thereto, and a selective reflection surface for reflecting the incident light incident from the first optical surface and transmitting the modulation light. The projection apparatus further includes and a second joinder prism comprising a third optical surface with the modulation light ejected from the first joinder prism transmitted thereto, a synthesis surface for synthesizing the modulation lights with different frequencies incident from the third optical surface transmitted in the same light path, and an ejection surface disposed at a position approximately opposite to the projection optical system for ejecting a synthesized light synthesized on the synthesis surface, wherein the first optical surface is approximately perpendicular to the synthesis surface.

### CROSS REFERENCE TO RELATED APPLICATIONS

This application is a Non-provisional Application claiming a Priority date of Oct. 2, 2007 based on a previously filed Provisional Application 60/997,436 and a Non-provisional patent application Ser. No. 11/121,543 filed on May 3, 2005 issued into U.S. Pat. No. 7,268,932. The application Ser. No. 11/121,543 is a Continuation In Part (CIP) Application of three previously filed Applications. These three Applications are Ser. No. 10/698,620 filed on Nov. 1, 2003, Ser. No. 10/699,140 filed on Nov. 1, 2003 now issued into U.S. Pat. No. 6,862,127, and 10/699,143 filed on Nov. 1, 2003 now issued into U.S. Pat. No. 6,903,860 by the Applicant of this patent applications. The disclosures made in these patent applications are hereby incorporated by reference in this patent application.

### BACKGROUND OF THE INVENTION

1. Field of the Invention

The present invention relates generally to the system configuration and methods for controlling and operating a projection apparatus comprising a spatial light modulator. More particularly, this invention related to an image projection apparatus implemented with a spatial light modulator and joinder prisms for separating and synthesizing lights transmitted in different wavelengths for projecting images of a plurality of colors.

2. Description of the Related Art

Even though there have been significant advances made in recent years on the technologies of implementing electromechanical micromirror devices as spatial light modulator, there are still limitations and difficulties when these devices are employed to provide high quality image displays. Specifically, when the display images are digitally controlled, the image qualities are adversely affected due to the fact that the image is not displayed with a sufficient number of gray scales.

Electromechanical micromirror devices have drawn considerable interest because of their application as spatial light modulators (SLMs). A spatial light modulator requires an array of a relatively large number of micromirror devices. In general, the number of devices required ranges from 60,000 to several million for each SLM. FIG. 1A refers to a digital video system 1 disclosed in a U.S. Pat. No. 5,214,420, that includes a display screen 2. A light source 10 is used to generate light energy for the ultimate illumination of the display screen 2. Light 9 generated is further concentrated and directed toward lens 12 by mirror 11. Lens 12, 13 and 14 form a beam columnator, which operates to columnate light 9 into a column of light 8. A spatial light modulator 15 is controlled by a computer 19 through data transmitted over data cable 18 to selectively redirect a portion of the light from path 7 toward lens 5 to display on screen 2. As shown in FIG. 1B, the SLM 15 has a surface 16 that includes an array of switchable reflective elements, e.g., micromirror devices 32, such as elements 17, 27, 37, and 47 as reflective elements attached to a hinge 30. When element 17 is in one position, a portion of the light from path 7 is redirected along path 6 to lens 5, where it is enlarged or spread along path 4 to impinge onto the display screen 2, so, as to form an illuminated pixel 3. When element 17 is in another position, light is not redirected towards the display screen 2, and hence pixel 3 remains dark.

The on-and-off states of the micromirror control scheme, as that implemented in the U.S. Pat. No. 5,214,420 and by most of the conventional display systems, impose a limitation on the quality of the display. Specifically, in a conventional configuration of the control circuit, the gray scale (PWM between ON and OFF states) is limited by the LSB (least significant bit, or the least pulse width). Due to the ON-OFF states implemented in conventional systems, there is no way to provide a shorter pulse width than LSB. The least amount of controllable light intensity, which determines gray scale, is the light reflected during the least pulse width. The limited gray scales lead to degradations of image display.

Specifically, FIG. 1C shows a conventional circuit diagram of a control circuit for a micromirror according to U.S. Pat. No. 5,285,407. The control circuit includes memory cell 32. Various transistors are referred to as M*″ where “*” designates a transistor number, and each transistor is an insulated gate field effect transistor. Transistors M5, and M7 are p-channel transistors; transistors M6, M8, and M9 are n-channel transistors. The capacitances, C1 and C2, represent the capacitive loads of the memory cell 32. Memory cell 32 includes an access switch transistor M9 and a latch 32a, which is the basis of the Static Random Access switch Memory (SRAM) design. All access transistors M9 in a row receive a DATA signal from a different bit-line 31a. The particular memory cell 32 to be written is accessed by turning on the appropriate row select transistor M9, using the ROW signal functioning as a word-line. Latch 32a is formed from two cross-coupled inverters, M5/M6 and M7/M8, which permit two stable states. State 1 is Node A high and Node B low, and state 2 is Node A low and Node B high.

The dual states switching, as illustrated by the control circuit, controls the micromirrors to position either at an ON or an OFF angular orientation, as that shown in FIG. 1A. The brightness, i.e., the gray scales of display for a digitally control image system is determined by the length of time the micromirror stays at an ON position. The length of time a micromirror is controlled at an ON position is in turned controlled by a multiple bit word. For simplicity of illustration, FIG. 1D shows the “binary time intervals” when controlled by a four-bit word. As shown in FIG. 1D, the time durations have relative values of 1, 2, 4, 8 that in turn define the relative brightness for each of the four bits, where 1 is for the least significant bit, and 8 is for the most significant bit. According to the control mechanism as shown, the minimum controllable difference between gray scales is a brightness represented by a “least significant bit” that maintains the micromirror at an ON position.

When adjacent image pixels are shown with a great degree of difference in the gray scales due to a very coarse scale of controllable gray scale, artifacts are shown between these adjacent image pixels. That leads to image degradations. The image degradations are especially pronounced in bright areas of display where there are “bigger gaps” between gray scales of adjacent image pixels. In bright areas of the display, the adjacent pixels are displayed with visible gaps of light intensities.

As the micromirrors are controlled to have a fully on and fully off position, the light intensity is determined by the length of time the micromirror is at the fully on position. In order to increase the number of gray scales of a display, the speed of the micromirror must be increased such that the digital control signals can be increased to a higher number of bits. However, when the speed of the micromirrors is increased, a stronger hinge is necessary for the micromirror to sustain the required number of operational cycles for a designated lifetime of operation, In order to drive micromirrors supported on a stronger hinge, a higher voltage is required. In this case, the voltage may exceed twenty volts, and may even be as high as thirty volts. Micromirrors manufactured by applying the CMOS technologies would probably not be suitable for operation this higher range of voltages, and therefore, DMOS micromirror devices may be required. In order to achieve higher degree of gray scale control, more complicated manufacturing processes and larger device areas are necessary when DMOS micromirrors are implemented. Conventional modes of micromirror control are therefore facing a technical challenge due to the difficulties that the accuracy of gray scale has to be sacrificed for the benefit of smaller and more cost effective micromirror displays, due to the operational voltage limitations.

There are many patents related to light intensity control. These patents include U.S. Pat. Nos. 5,589,852, 6,232,963, 6,592,227, 6,648,476, and 6,819,064. There are further patents and patent applications related to the different shapes of light sources. These patents includes U.S. Pat. Nos. 5,442,414, 6,036,318, and Application 20030147052. U.S. Pat. No. 6,746,123 discloses special polarized light sources for preventing light loss. However, these patents and patent application do not provide an effective solution to overcome the limitations caused by insufficient gray scales in the digitally controlled image display systems.

Furthermore, there are many patents related to spatial light modulation including U.S. Pat. Nos. 2,025,143, 2,682,010, 2,681,423, 4,087,810, 4,292,732, 4,405,209, 4,454,541, 4,592,628, 4,767,192, 4,842,396, 4,907,862, 5,214,420, 5,287,096, 5,506,597, and 5,489,952. However, these inventions have provided a direct resolution to overcome the limitations and difficulties discussed above.

Therefore, a need still exists in the art of image display systems, applying digital control of a micromirror array as a spatial light modulator, for new and improved systems such that the difficulties and limitations discussed above can be resolved.

### SUMMARY OF THE INVENTION

Therefore, one aspect of the present invention is to decrease the size of a spatial light modulator (SLM) and to implement a spatial light modulator of a reduced size in a projection apparatus.

A first exemplary embodiment of the present invention provides a projection apparatus, comprising a light source, a plurality of spatial light modulators each comprising a mirror capable of deflecting an incident light emitted from the light source in an intermediate direction between two mutually different first and second directions, along with the first and second directions, a projection optical system for projecting a modulation light modulated by the spatial light modulator, a first joinder prism comprising a first optical surface to which at least two of the incident lights with mutually different frequencies are incident, a second optical surface which ejects the incident light incident from the first optical surface and to which the modulation light is incident, and a selective reflection surface for reflecting the incident light incident from the first optical surface and transmitting the modulation light, and a second joinder prism comprising a third optical surface to which the modulation light ejected from the first joinder prism is incident, a synthesis surface for synthesizing, in the same light path, the modulation lights with different frequencies incident from the third optical surface, and an ejection surface which is equipped at a position approximately opposite to the projection optical system and which ejects a synthesized light synthesized on the synthesis surface, wherein the first optical surface is approximately perpendicular to the synthesis surface.

A second exemplary embodiment of the present invention provides the projection apparatus according to the first exemplary embodiment, further comprising a third joinder prism which is placed in a light path of the incident light and between the light source and first joinder prism and which is in a similar form to the second joinder prism.

A third exemplary embodiment of the present invention provides the projection apparatus according to the second exemplary embodiment, wherein the third joinder film comprises an incidence surface to which the incident light is incident, a separation surface for separating the incident light incident from the incidence surface, and a fourth optical surface for ejecting the incident light separated on the separation surface to the first optical surface, wherein the fourth optical surface is placed opposite to the first optical surface.

A fourth exemplary embodiment of the present invention provides the projection apparatus according to the first exemplary embodiment, wherein the second joinder prism comprises a fifth optical surface, which is approximately perpendicular to the synthesis surface and to which a portion of the modulation light is incident, wherein the modulation light is incident to the fifth optical surface at an angle smaller than the critical angle.

A fifth exemplary embodiment of the present invention provides the projection apparatus according to the first exemplary embodiment, wherein the second joinder prism comprises a fifth optical surface which is approximately perpendicular to the synthesis surface and to which a portion of the modulation light is incident, and the projection apparatus further comprises a prism joined to the second joinder prism on the fifth optical surface, wherein the prism comprises a first flat surface, which is the joinder surface between the present prism and second joinder prism, and to which the modulation light ejected from the second joinder prism is incident at an angle smaller than the critical angle, and a second flat surface to which the modulation light incident from elsewhere other than the joinder surface is incident at an angle no smaller than the critical angle.

A sixth exemplary embodiment of the present invention provides the projection apparatus according to the second exemplary embodiment, wherein the width of the second joinder prism in a direction parallel to the third optical surface and parallel to the deflection locus formed by the modulation light is approximately equal to the diameter of the entrance pupil of the projection optical system.

A seventh exemplary embodiment of the present invention provides the projection apparatus according to the second exemplary embodiment, wherein the direction in which the incident light is incident to the third joinder prism is approximately the same as the direction of the synthesized light ejected from the second joinder prism.

An eighth exemplary embodiment of the present invention provides the projection apparatus according to the fourth exemplary embodiment, further comprising a light absorption member that is placed in the extended optical axis of the modulation light incident to the fifth optical surface and outside of the second joinder prism or in the proximity of the fifth optical surface.

A ninth exemplary embodiment of the present invention provides the projection apparatus according to the fourth exemplary embodiment, further comprising heat dissipation member that is placed in the extended optical axis of the modulation light incident to the fifth optical surface and outside of the second joinder prism or in the proximity of the fifth optical surface.

A tenth exemplary embodiment of the present invention provides a projection apparatus, comprising a light source, a plurality of spatial light modulators each comprising a micromirror capable of deflecting an incident light emitted from the light source in an intermediate direction between two mutually different first and second directions, along with the first and second directions, a separation-use prism for separating the illumination light into lights with different wavelengths and ejecting the separated illumination lights to the micromirror, and a synthesis-use prism which is formed similarly to the separation-use prism and which is placed in inclination to the present separation-use prism by a predetermined angle and which comprises a synthesis surface for synthesizing, in the same light path, the modulation lights modulated by the micromirror.

An eleventh exemplary embodiment of the present invention provides the projection apparatus according to the tenth exemplary embodiment, further comprising a projection optical system, wherein the synthesis-use prism ejects the synthesized light synthesized on the synthesis surface toward the projection optical system.

A twelfth exemplary embodiment of the present invention provides the projection apparatus according to the tenth exemplary embodiment, wherein the predetermined angle is approximately 90 degrees.

A thirteenth exemplary embodiment of the present invention provides the projection apparatus according to the tenth exemplary embodiment, wherein the predetermined angle is two times the maximum deflection angle of the micromirror relative to the horizontal state thereof.

A fourteenth exemplary embodiment of the present invention provides the projection apparatus according to the tenth exemplary embodiment, further comprising a projection optical system, wherein the modulation light deflected in the first direction is incident to the synthesis-use prism and then is incident to a surface of the synthesis-use prism, the surface opposite to the projection optical system, and the modulation light deflected in the second direction is incident to the synthesis-use prism and then is incident to an optical surface of the synthesis-use prism, the optical surface approximately perpendicular to the synthesis surface at an angle smaller than the critical angle.

### BRIEF DESCRIPTION OF THE DRAWINGS

The present invention is described in detail below with reference to the following Figures.

FIG. 1A is a functional block diagram for showing the configuration of a projection apparatus according to a conventional technique;

FIG. 1B is a top view diagram for showing the configuration of a mirror element of the projection apparatus according to a conventional technique;

FIG. 1C is a circuit schematic diagram for showing the configuration of the drive circuit of a mirror element of the projection apparatus according to a conventional technique;

FIG. 1D is a timing diagram for showing the format of image data used in the projection apparatus according to a conventional technique;

FIG. 2 is a diagram for showing a diagonal perspective view of a mirror device arraying, in two dimensions on a device substrate, a plurality of mirror elements used for controlling the reflecting direction of incident light by the deflection of mirrors;

FIG. 3 is a side view diagram for showing the relationship among the numerical aperture NA1 of an illumination light path, the numerical aperture NA2 of a projection light path and the tilt angle α of a mirror;

FIG. 4A is side view for illustrating the etendue in light transmission using a discharge lamp light source and projecting an image by way of an optical device;

FIG. 4B is a side view for illustrating the use of a discharge lamp light source and the projection of an image by way of an optical device;

FIG. 4C is a side view for illustrating the use of a laser light source and the projection of an image by way of an optical device;

FIG. 5A is a top view of the mirror element of a mirror device according to a preferred embodiment of the present invention;

FIG. 5B is a cross-sectional diagram (taken along the line B-B′ in FIG. 5A) as viewed from the side, showing a configuration of the mirror element of a mirror device according to a preferred embodiment of the present invention;

FIG. 5C is a cross-sectional diagram (taken along the line A-A′ in FIG. 5A) as viewed from the side, showing a configuration of the mirror element of a mirror device according to a preferred embodiment of the present invention;

FIG. 6A is an image diagram for showing diffraction light generated when the light is reflected by a mirror;

FIG. 6B is a diagram for showing diffraction light generated when the light is reflected by a mirror;

FIG. 7A is a top view of an exemplary modification of the mirror element of a mirror device according to the embodiment of the present invention;

FIG. 7B is a cross-sectional diagram for showing an exemplary modification of the mirror element of a mirror device according to the embodiment of the present invention;

FIG. 8 is a cross-sectional diagram of the mirror element implemented in a mirror device according to the embodiment of the present invention;

FIG. 9A is a top view for showing a form of an electrode included in the mirror element of a mirror device according to the embodiment of the present invention;

FIG. 9B is a side cross-sectional view diagram for showing the electrode (from FIG. 9A) included in the mirror element of a mirror device according to the embodiment of the present invention;

FIG. 10 is a diagram for showing another form of an electrode included in the mirror element of a mirror device according to the embodiment of the present invention;

FIG. 11 is a side cross-sectional view diagram for showing another form of an electrode included in the mirror element of a mirror device according to the embodiment of the present invention;

FIG. 12A is a top view diagram for showing another form of an electrode included in the mirror element of a mirror device according to the embodiment of the present invention;

FIG. 12B is a side cross-sectional view diagram for showing another form of an electrode (from FIG. 12A) included in the mirror element of a mirror device according to the embodiment of the present invention;

FIG. 13 is a side view diagram for showing another form of an electrode included in the mirror element of a mirror device according to the embodiment of the present invention;

FIG. 14A is a side view diagram for showing another form of an electrode included in the mirror element of a mirror device according to the embodiment of the present invention;

FIG. 14B is a side view diagram for showing another form of an electrode included in the mirror element of a mirror device according to the embodiment of the present invention;

FIG. 15A is a side view diagram for showing another form of an electrode included in the mirror element of a mirror device according to the embodiment of the present invention;

FIG. 15B is a side view diagram for showing another form of an electrode included in the mirror element of a mirror device according to the embodiment of the present invention;

FIG. 16A is a side view diagram for showing another form of an electrode included in the mirror element of a mirror device according to the embodiment of the present invention;

FIG. 16B is a side view diagram for showing another form of an electrode included in the mirror element of a mirror device according to the embodiment of the present invention;

FIG. 16C is a side view diagram for showing another form of an electrode included in the mirror element of a mirror device according to the embodiment of the present invention;

FIG. 17 is a functional block diagram for showing the configuration of a mirror device according to the embodiment of the present invention;

FIG. 18A is a diagram delineating the state in which incident light is reflected towards a projection optical system by deflecting the mirror of a mirror element;

FIG. 18B is a diagram delineating the state in which incident light is not reflected towards a projection optical system by deflecting the mirror of a mirror element;

FIG. 18C is a diagram delineating the state in which incident light is reflected towards and away from a projection optical system repeatedly by free-oscillating the mirror of a mirror element;

FIG. 19 is a timing diagram for showing a transition response between the ON state and OFF state of the mirror of a mirror device according to a preferred embodiment of the present invention;

FIG. 20A shows a cross-section of a mirror element that is configured to be equipped with only one address electrode and one drive circuit, as another embodiment of the mirror element of a mirror device according to the embodiment of the present invention;

FIG. 20B is an outline diagram of the mirror element shown in FIG. 20A;

FIG. 21A shows a top view diagram and a cross-sectional diagram of a mirror element with the area size of a first electrode part of one address electrode greater than the area size of a second electrode part (S1>S2), with the connection part between the first and second electrode parts is in the same structural layer as the first and second electrode parts;

FIG. 21B shows a top view diagram, and a cross-sectional diagram, both of a mirror element structured such that the area size S1 of a first electrode part of one address electrode is greater than the area size S2 of a second electrode (S1>S2), and such that the connection part between the first and second electrode parts is in a different structural layer from that of the first and second electrode parts;

FIG. 21C shows a top view diagram, and a cross-sectional diagram, both of a mirror element structured such that the area size S1 of a first electrode part of one address electrode is equal to the area size S2 of a second electrode (S1=S2), and such that the distance G1 between a mirror and the first electrode part is less than the distance G2 between the mirror and the second electrode part (G1<G2);

FIG. 22 is a diagram for showing the data inputs to a mirror element shown in FIG. 21A, the voltage application to an address electrode, and the deflection angles of the mirror, in a time series;

FIG. 23 is a cross-sectional diagram depicting a situation in which an f/10 light flux, which possesses a coherent characteristic, is reflected by a spatial light modulator, for which the deflection angles of the ON light state and OFF light state of a mirror are set at ±3 degrees, respectively;

FIG. 24A is a front cross-sectional diagram of an assembly body that packages two mirror devices by using a package substrate;

FIG. 24B is a top view diagram of the assembly body shown in FIG. 24A, with a cover glass and an intermediate member removed;

FIG. 25A is a front view diagram of a two-panel projection apparatus comprising a plurality of mirror devices packaged by a single package;

FIG. 25B is a rear view diagram of the two-panel projection apparatus shown in FIG. 25A;

FIG. 25C is a side view diagram of the two-panel projection apparatus shown in FIG. 25A;

FIG. 25D is a top view diagram of the two-panel projection apparatus shown in FIG. 25A;

FIG. 26 is a functional block diagram for showing the configuration of a single-panel projection apparatus according to the embodiment of the present invention;

FIG. 27A is a functional block diagram for showing the configuration of a multi-panel projection apparatus according to the embodiment of the present invention;

FIG. 27B is a functional block diagram for showing the configuration of an exemplary modification of a multi-panel projection apparatus according to the embodiment of the present invention;

FIG. 27C is a functional block diagram for showing the configuration of an exemplary modification of a multi-panel projection apparatus according to another preferred embodiment of the present invention;

FIG. 28A is a diagram for showing an exemplary modification of an optical prism comprised in an exemplary configuration of a projection apparatus according to a preferred embodiment;

FIG. 28B is a diagram for illustrating an exemplary modification of an optical prism comprised in an exemplary configuration of a projection apparatus according to the embodiment;

FIG. 28C is a diagram for illustrating an exemplary modification of an optical prism comprised in an exemplary configuration of a projection apparatus according to the embodiment;

FIG. 29 is a diagram for illustrating another exemplary configuration of a projection apparatus according to the embodiment;

FIG. 30 is a diagram for illustrating an exemplary configuration of a projection apparatus according to an embodiment;

FIG. 31A is a diagram for illustrating an exemplary configuration of an optical prism comprised in an exemplary configuration of the projection apparatus according to the embodiment;

FIG. 31B is a diagram for illustrating an exemplary configuration of an optical prism comprised in an exemplary configuration of the projection apparatus according to the embodiment;

FIG. 32A is a diagram for illustrating the optical system of a projection apparatus according to a preferred embodiment of the present invention;

FIG. 32B is a diagram for illustrating the optical system of a projection apparatus according to a preferred embodiment of the present invention;

FIG. 33 is a diagram for illustrating the optical system of a projection apparatus according to a preferred embodiment of the present invention;

FIG. 34 is a diagram for showing an exemplary configuration of the projection apparatus according to the embodiment;

FIG. 35 is a diagram for showing the case of equipping constituent components on the same substrate in another exemplary configuration of the projection apparatus according to the embodiment;

FIG. 36 is a functional block diagram for showing the control unit of a projection apparatus according to a preferred embodiment of the present invention;

FIG. 37A is a data structure diagram for showing the image data used in the embodiment of the present invention;

FIG. 37B is a data structure diagram for showing the image data used in the embodiment of the present invention;

FIG. 38A is a chart for showing a control signal of a projection apparatus according to the embodiment of the present invention;

FIG. 38B is a chart for showing a control signal of a projection apparatus according to the embodiment of the present invention; and

FIG. 38C is a chart for showing an expanded portion of a control signal of a projection apparatus according to the embodiment of the present invention;

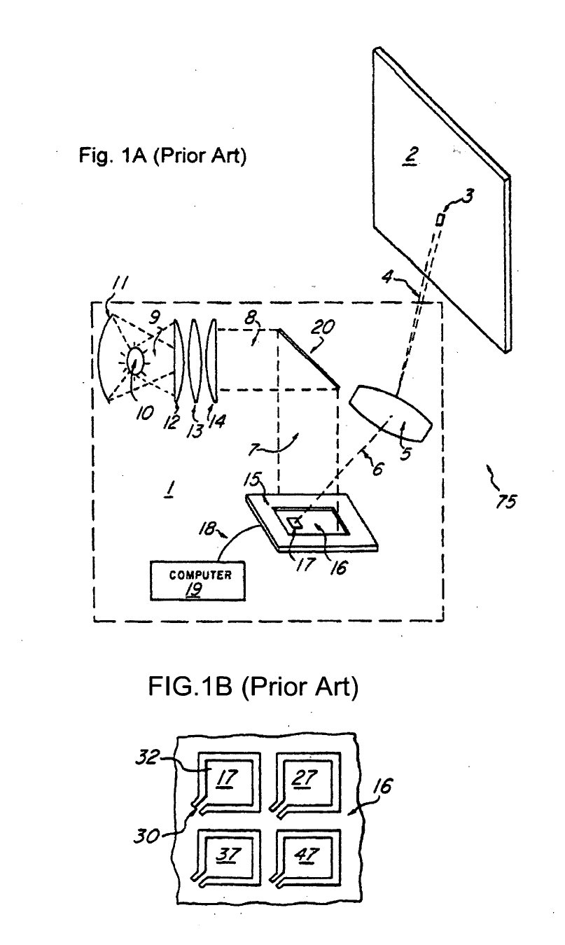

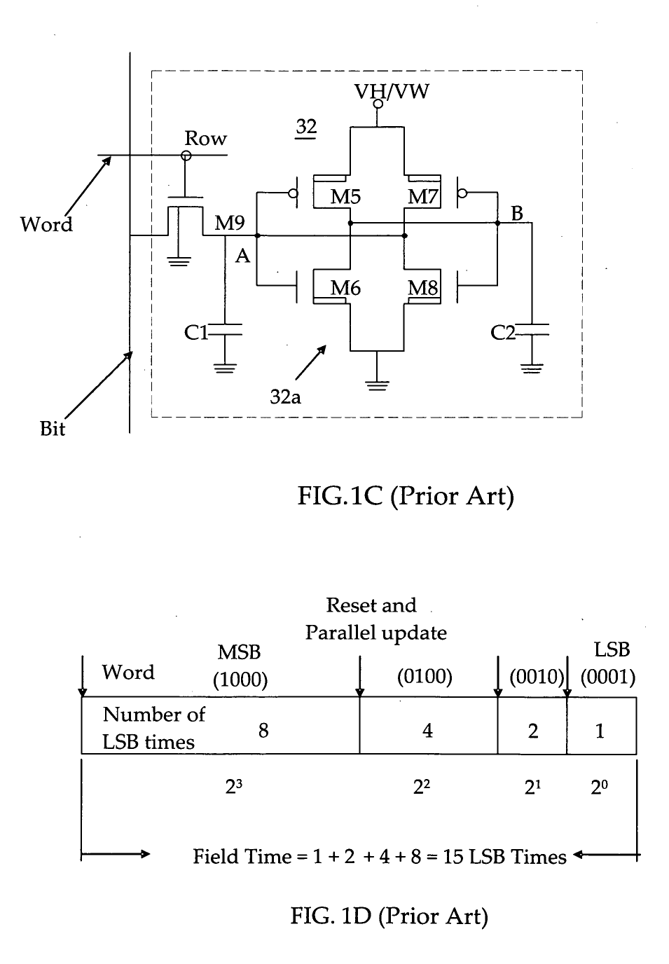

### DESCRIPTION OF THE PREFERRED EMBODIMENTS

First is a description of an outline of an example of a mirror device according to a preferred embodiment of the present invention.

### [Outline of the Device]

Image projection apparatuses implemented with a spatial light modulator (SLM), such as a transmissive liquid crystal, a reflective liquid crystal, a mirror array and other similar image modulation devices, are widely known.

A spatial light modulator is formed as a two-dimensional array of optical elements, ranging in number from tens of thousands to millions of miniature modulation elements, with the individual elements enlarged and displayed, as the individual pixels corresponding to an image to be displayed, onto a screen by way of a projection lens.

Spatial light modulators generally used for projection apparatuses primarily include two types: 1.) a liquid crystal device, formed by sealing a liquid crystal between transparent substrate, for modulating the polarizing direction of incident light and providing them with a potential and 2.) a mirror device deflects miniature micro electro mechanical systems (MEMS) mirrors with electrostatic force and controls the reflecting direction of illumination light.

One embodiment of the above described mirror device is disclosed in U.S. Pat. No. 4,229,732, in which a drive circuit using MOSFET and deflectable metallic mirrors are formed on a semiconductor wafer substrate. The mirror can be deformed by electrostatic force supplied from the drive circuit and is capable of changing the reflecting direction of the incident light.

Meanwhile, U.S. Pat. No. 4,662,746 has disclosed an embodiment in which one or two elastic hinges retain a mirror. If the mirror is retained by one elastic hinge, the elastic hinge functions as a bending spring. In a mirror supported by two elastic hinges, these two elastic hinges function as torsion springs to incline the mirror, and thereby deflecting the reflecting direction of the incident light.

The following is an outline description of the configuration of the mirror device.

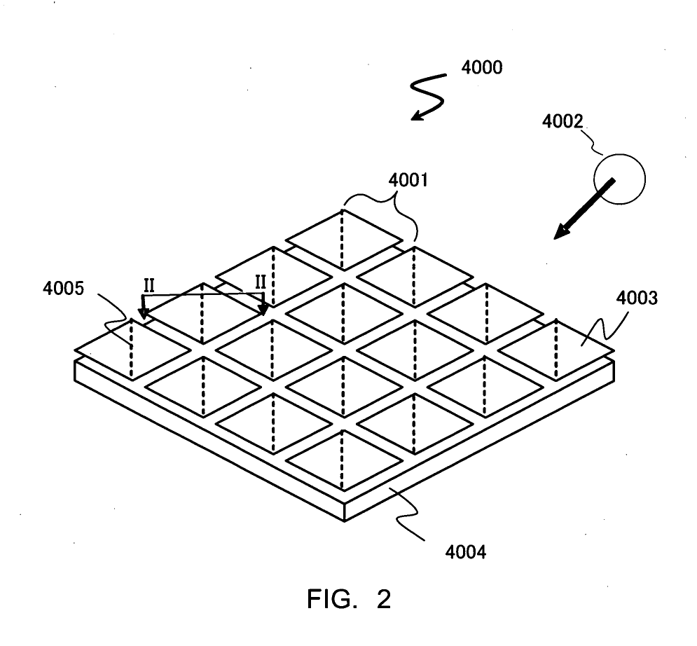

FIG. 2 is a diagram of a diagonal view of a mirror device that includes micromirrors 4003 configured as two-dimensional arrays. Each of the plurality of mirror elements is controlled to oscillate and deflect to specific angles for reflecting the incident light according to the mirror control signals. The mirror device 4000 includes mirror elements 4001 arranged as two-dimensional arrays on a device substrate 4004. Each of these mirror elements includes address electrodes (not shown here), elastic hinge (not shown here), and a mirror 4003 supported by the elastic hinge. In FIG. 2, each of these multiple mirror elements 4001 comprises a square mirror 4003. The square mirrors 4003 are arrayed along two horizontal directions in constant intervals on the device substrate 4004. Applying a voltage to the address electrode formed on the device substrate 4004 controls the mirror 4003 implemented in each mirror element 4001 to deflect to different tilt angles according to the operational state of the mirror. The mirror driven by a drive electrode abuts a landing electrode, which is structured separately from the drive electrode, and thereby a prescribed maximum tilt angle is maintained. A “landing chip”, which possesses a spring property, is formed on the point of contact between the landing electrode and the mirror to aid the mirror to reverse an oscillation direction when controlled by a voltage applied to an electrode on the opposite side of the hinge. The parts forming the landing chip and the landing electrode are maintained at the same potential so that contact will not cause a shorting or other similar disruption.

### [Outlines of Mirror Size and Resolution]

The size of a mirror for implemented in such a mirror device is between 4 μm and 10 μm on each side. The mirrors are placed on a semiconductor wafer substrate to have a configuration for minimizing the gap between adjacent mirrors. Smaller gaps reduce random and interfering reflection lights from the gap to prevent such reflections from degrading the contrast of the displayed images.

Furthermore, the ratio (referred to as “aperture ratio” hereinafter) of the effective reflection surface to the pixel placement region is commonly set at approximately no less than 80%, with the reflection ratio approximately designated at no lower than 80%. The gap between adjacent mirrors is preferably reduced to a range between 0.15 μm and 0.55 μm, while avoiding physical interference with adjacent mirror elements. A mirror device with improved aperture also has an advantage to reduce the energy irradiated on the device substrate through the gap between adjacent mirrors and accordingly decrease operational failures caused by extraneous heating and a photoelectric effect.

The mirror device is formed on a substrate that includes an appropriate number of mirror elements. Each mirror element is applied to modulate a corresponding image display element known as a pixel. The number of image display elements appropriate for displaying image of specific resolution is determined according to image display standards in compliance to the resolution requirements of a display specified by the Video Electronics Standards Association (VESA) and to the television-broadcasting standard. For example, in the case of configuring a mirror device in compliance with the WXGA (with the resolution of 1280×768) as specified by VESA and in which the size of each mirror is 10 μm, the diagonal length of the display area will be about 0.61 inches, thus producing a sufficiently small mirror device

### [Outline of the Introduction of Laser Light Source]

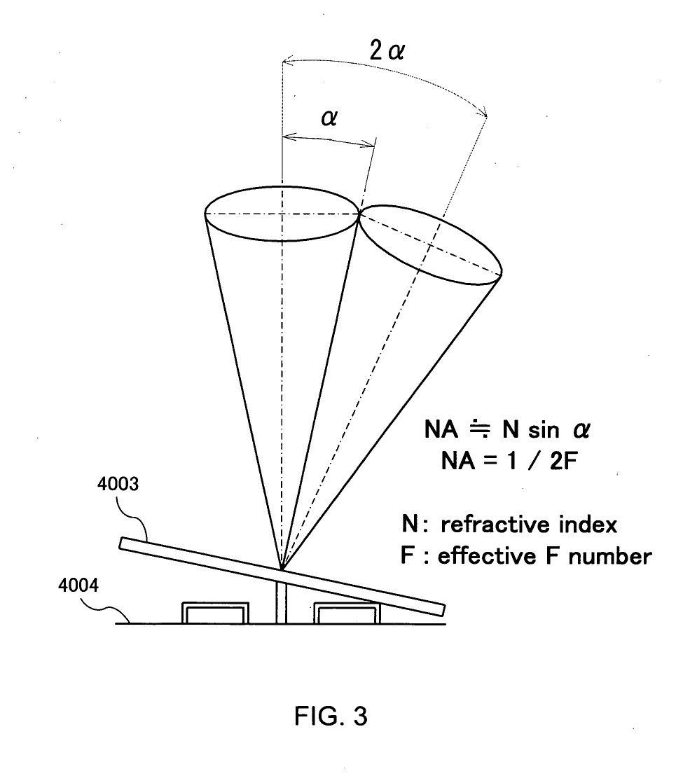

In the projection apparatus implemented with a reflective spatial light modulator configured as the above-described mirror device, there is a close relationship among the numerical aperture (NA) NA1 of an illumination light path, the numerical aperture NA2 of a projection light path, and the tilt angle α of a mirror. FIG. 3 shows the relationship among them.

The following discussion assumes that the tilt angle α of a mirror 4003 is 12 degrees. When a modulated light reflected by the mirror 4003 and incident to the pupil of the projection light path is set perpendicular to a device substrate 4004, the illumination light is incident at an angle inclined by 2α, that is, 24 degrees, relative to the perpendicular axis of the device substrate 4004. For the light beam reflected by the mirror to be most efficiently incident to the pupil of the projection lens, it is advantageous for the numerical aperture of the projection light path to be equal to the numerical aperture of the illumination light path. If the numerical aperture of the projection light path is smaller than that of the illumination light path, the illumination light cannot be sufficiently transmitted into the projection light path. On the other hand, if the numerical aperture of the projection light path is larger than that of the illumination light path, the illumination light can be entirely transmitted onto the projection lens becomes excessively large, which increases the inconvenience in terms of configuring the projection apparatus. Furthermore, in this case, the light fluxes of the illumination light and projection light must be directed apart from each other because the optical members of the illumination system and those of the projection system must be physically placed in separate locations in an image display system. As shown in FIG. 3, by designing a layout to transmit the aforementioned two light fluxes adjacent to each other may reduce the extraneous space between the light fluxes of the illumination light and that of the projection light. From the above considerations, when a mirror device with the tilt angle of a mirror at 12 degrees is used, the numerical aperture (NA) NA1 of the illumination light path and the numerical aperture NA2 of the projection light path are preferably set as follows:

NA1=NA2=sin α=sin 12°

Letting the F-number of the illumination light path be F1 and the F-number of the projection light path be F2, the numerical aperture can be converted into an F-number as follows:

F1=F2=1/(2*NA)=1/(2*sin 12°)=2.4

In order to maximize the transmission of illumination light emitted from a light source with non-directivity in the emission direction of light, such as a high-pressure mercury lamp or xenon lamp, which are generally used for a projection apparatus, it is necessary to maximize the projection angle of light on the illumination light path side. Since the numerical aperture of the illumination light path is determined by the specific tilt angle of a mirror to be used, the tilt angle of the mirror needs to be large in order to increase the numerical aperture of the illumination light path.

Increasing of the tilt angle of mirror, however, requires a higher drive voltage and a larger distance between the mirror and the electrode for driving the mirror because a greater physical space needs to be secured for tilting the mirror. The electrostatic force F generated between the mirror and electrode is derived by the following equation:

F=(ε*S*V²)/(2*d²),

where “S” is the area size of the electrode, “V” is the voltage, “d” is the distance between the electrode and mirror, and “ε” is the permittivity of vacuum.

The equation clearly illustrates that the drive force is decreased in proportion to the second power of the distance d between the electrode and mirror. Conventionally, the drive voltage may be increased to compensate for the decrease in the drive force associated with the increase in the distance. However, the drive voltage is about 5 to 10 volts in the drive circuit, by means of a CMOS process used for driving a mirror, and therefore a relatively special process such as a DMOS process is required if a drive voltage in excess of about 10 volts is needed. A DMOS process would be disadvantageous for manufacturing the mirror device due to the cost increase in manufacturing the mirror device.

Furthermore, for the purpose of cost reduction, it is advantageous to obtain as many mirror devices as possible from a single semiconductor wafer substrate in order to improve the productivity. That is, shrinking the pitch between mirror elements reduces the size of the mirror device overall. However, it is clear that the area size of an electrode is reduced in association with a size reduction of the mirror, which also leads to less driving power.

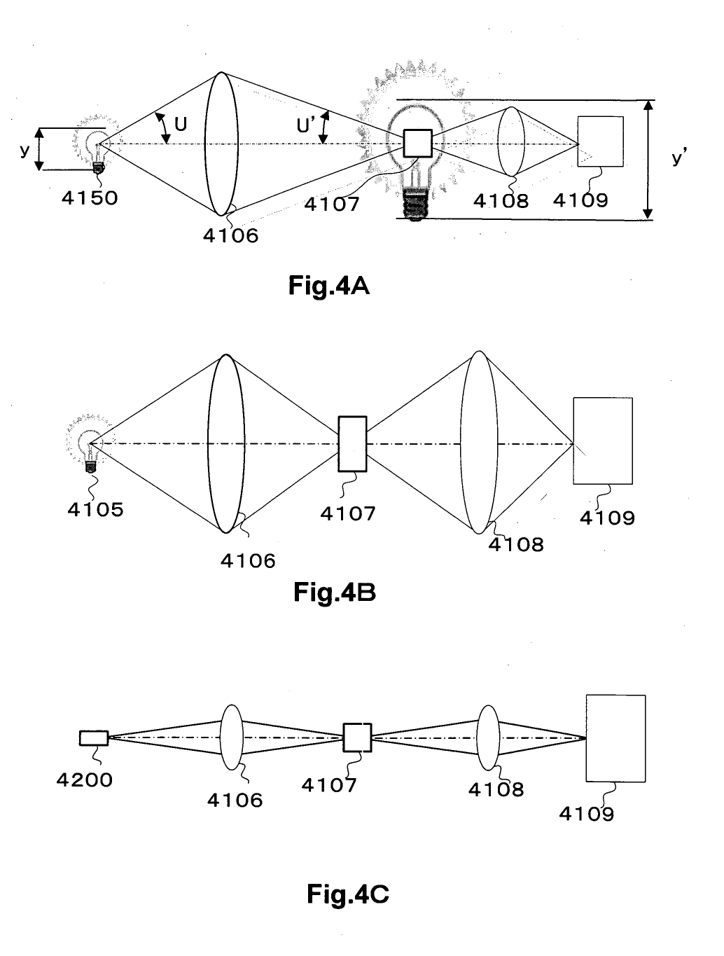

Along with these requirements for miniaturizing a mirror device, there is a design tradeoff for further consideration because of the fact that the larger a mirror device, the brighter the display image when a conventional light lamp is used as the light source. Attributable to an optical functional relationship generally known as etendue, the efficiency of the non-polarized light projected from the conventional lamp may be substantially reduced. The adverse effects must be taken into consideration as an important factor for designing and configuring an image projection system, particularly for designing the light sources. FIG. 4A is diagram for explaining an optical parameter etendue by illustrating the etendue for an optical system implemented with an arc discharge lamp light source for projecting an image using an optical device.

Let “y” represent the size of a light source 4150 and “u” represent the angle of light with which an optical lens imports the light from the light source. Further, let “u′” be the converging angle on the image side converged by using the optical lens 4106, and “y′” be the size of an image projected onto a screen 4109, by way of a projection lens 4108 after using an optical device 4107 for the converged light. Specifically, there is a relationship known as the etendue among the size y of the light source 4150, the import angle u of light, the converging angle u′ on the image side, and the size y′ of an image, as follows:

y*u=y′*u′

Based on this relationship, the smaller the optical device 4107 attempting to image the light source 4150, the smaller the import angle u of light becomes. Because of this, when the optical device 4107 is made smaller, the image becomes darker as a result of limiting the import angle u of light. Therefore, when using an arc discharge lamp with low directivity, the import angle u of light needs to be appropriately large in order to maintain the brightness of an image.

FIG. 4B is a diagram illustrating the use of an arc discharge lamp light source and the projection of an image by way of an optical device. The light output from an arc discharge lamp light source 4105 is converged by using an optical lens 4106, and irradiated onto the optical device 4107. Then, the light passing through the optical device 4107 is projected onto a screen 4109 by way of a projection lens 4108.

The larger the optical lens used in this case, the higher the converging capacity and the better the usage efficiency of light. However, increasing the size of the optical device 4107 is contradictory to the demand for shrinking the spatial light modulator or making the projection apparatus more compact.

In contrast, a laser light source has a higher directivity of light and a smaller expansion of light flux than those of a discharge lamp light source. Therefore, a projected image can be made sufficiently bright without the need to increase the size of the optical lens or optical device. Further, if the projected image is not sufficiently bright, adjustment of the output of the laser light source can increase the brightness of the projected images. Also in this case, because of the high directivity of laser light, the light intensity can be increased without allowing a substantial expansion of light flux.

FIG. 4C is a diagram illustrating the use of a laser light source and the projection of an image by way of an optical device. The laser light emitted from a laser light source 4200 is made to be incident to an optical device 4107 by way of an optical lens 4106. Then, the light passing through the optical device 4107 is projected onto a screen 4109 by way of a projection lens 4108.

In this case, the usage efficiency of light for the optical lens 4106 and optical device 4107 is improved by taking advantage of the high directivity of the laser light. A projected image can be made brighter without a need to increase the size of the optical lens 4106 or optical device 4107. This eliminates the problem of etendue, making it possible to miniaturize the optical lens 4106 and optical device 4107, leading to a more compact projection apparatus.

### [Outline of Resolution Limit]

The following is an outline description of a resolution limit.

An examination of the limit value of the aperture ratio of a projection lens used for a projection apparatus, which displays the display surface of a mirror device in enlargement, in view of the resolution of an image to be projected, leads to the following.

Where “Rp” is the pixel pitch of the mirror device, “NA” is the aperture ratio of a projection lens, “F” is an F-number, and “λ” is the wavelength of light, the limit “Rp” with which any adjacent pixels on the projection surface are separately observed is derived by the following equation:

Rp=0.61*λ/NA=1.22*λ*F

When the pitch between mirror elements is decreased by using a miniaturized mirror, the relationship among the aperture ratio NA, which is theoretically required for resolving individual mirrors, the F-number for the projection lens, and the corresponding deflection angle of the mirror, is given by the following tables for the wavelength of light at λ=400 nm, the green light (at λ=650 nm) and the red light (at λ=800 nm), respectively.

The NA required for resolving, in the projected image, adjacent mirror elements and the tilt angle of a mirror for separating the illumination light and projection light with the respective

### NA: at λ=400 nm

| Mirror | Aperture | F-number for | |
|---|---|---|---|
| device pixel | ratio: | projection | Deflection angle |
| pitch: μm | NA | lens | of mirror: degrees |
| 4 | 0.061 | 8.2 | 3.49 |
| 5 | 0.049 | 10.2 | 2.79 |
| 6 | 0.041 | 12.3 | 2.33 |
| 7 | 0.035 | 14.3 | 2.00 |
| 8 | 0.031 | 16.4 | 1.75 |
| 9 | 0.027 | 18.4 | 1.55 |
| 10 | 0.024 | 20.5 | 1.40 |
| 11 | 0.022 | 22.5 | 1.27 |

### At λ=650 nm:

| Mirror | Aperture | F-number for | |
|---|---|---|---|
| device pixel | ratio: | projection | Deflection angle |
| pitch: μm | NA | lens | of mirror: degrees |
| 4 | 0.099 | 5.0 | 5.67 |
| 5 | 0.079 | 6.3 | 4.54 |
| 6 | 0.066 | 7.6 | 3.78 |
| 7 | 0.057 | 8.8 | 3.24 |
| 8 | 0.050 | 10.1 | 2.84 |
| 9 | 0.044 | 11.3 | 2.52 |
| 10 | 0.040 | 12.6 | 2.27 |
| 11 | 0.036 | 13.9 | 2.06 |

### At λ=800 nm:

| Mirror | Aperture | F-number for | |
|---|---|---|---|
| device pixel | ratio: | projection | Deflection angle |
| pitch: μm | NA | lens | of mirror: degrees |
| 4 | 0.122 | 4.1 | 6.97 |
| 5 | 0.098 | 5.1 | 5.58 |
| 6 | 0.081 | 6.1 | 4.65 |
| 7 | 0.070 | 7.2 | 3.99 |
| 8 | 0.061 | 8.2 | 3.49 |
| 9 | 0.054 | 9.2 | 3.11 |
| 10 | 0.049 | 10.2 | 2.79 |
| 11 | 0.044 | 11.3 | 2.54 |

Based on the above tables, it is clear that a sufficient F-number for a projection lens required for resolving, in the projected image, individual pixels with, for example, 10 μm pixel pitch is theoretically F=20.5. The projection lens has an extremely small aperture when the wavelength of illumination light is λ=400 nm. In the meantime, the mirror would have a sufficient deflection angle of mere 1.4 degrees to provide the required resolution. The mirror device can be controlled and the mirror elements may be driven with a very low drive voltage.

However, as discussed above, the image brightness would be significantly reduced when a conventional non-coherent lamp used as a light source is implemented with an illumination lens matched with such a projection lens. Accordingly, a laser light source is implemented to circumvent the above-described problem attributable to the etendue. The implementation of the laser light source makes it possible to increase the F-number for the illumination and projection optical systems to the number indicated in the table and to reduce the deflection angle of a mirror element as a result, thus enabling the configuration of a compact mirror device with a low drive voltage.

Furthermore, the introduction of a laser light source provides the benefit of lowering the drive voltage by introducing the laser light source, making it possible to further reduce the thickness of the circuit-wiring pattern of the control circuit controlling the mirror. It is possible to further reduce power consumption by setting the deflection angle of the mirror at a minimum for each frequency of light as the target of modulation. That is, the deflection angle of the mirror can be reduced for a mirror device modulating, for example, blue light as compared to the deflection angle of a mirror modulating red light. It is thus possible for a projection apparatus to be configured without increasing the sizes of the optical components used in the apparatus when, for example, single color laser light sources are used for light sources, the respective illumination light paths are individually provided, and the optimal NAs are set for the respective illumination light paths.

It is also possible to cause the laser light source to perform pulse emission by configuring a circuit that alternately emits the pulse emission of the ON and OFF lights for a predetermined period. Controlling the pulse emission of the light source makes it possible to adjust intensity in accordance with the image signal (that is, in accordance with the brightness and hue of the entire projection image) and to express the finer gradations of the display image. Further, lowering the output of the laser light makes it possible to vary the dynamic range of an image and to darken the entire screen in response to a dark image.

Furthermore, performing a pulse control makes it possible to turn OFF a laser light source as appropriate during a period where no image is displayed or during a period of changing the colors of a display image in one frame. As a result, a temperature rise due to the irradiation of extraneous light onto a mirror device can be alleviated.

The following is a detail description of a first preferred embodiment of the present invention, taking into consideration of the configuration of the above described mirror device.

### First Embodiment

The following is a description, in detail, of a mirror device according to the present embodiment with reference to the accompanying drawings.

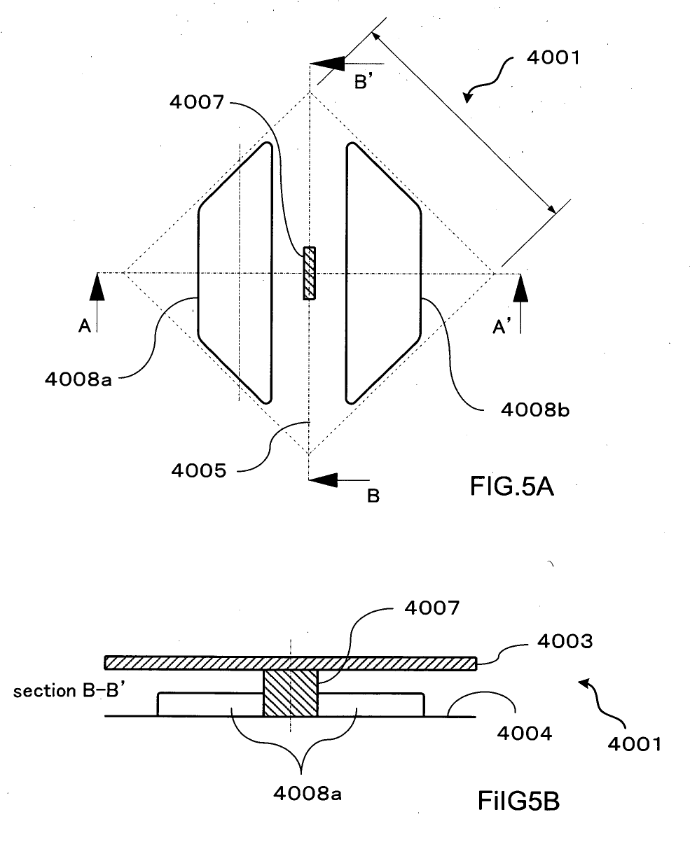

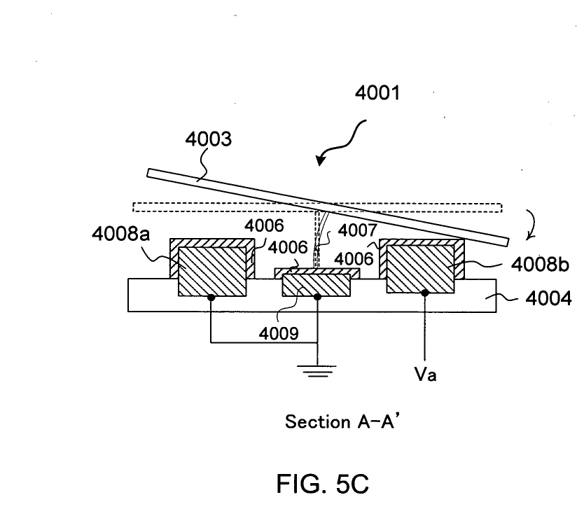

FIGS. 5A through 5C are respectively a top view and side cross sectional views of a mirror element implemented in a mirror device according to the present embodiment. FIG. 5A shows a mirror element, as viewed from above, with the mirror removed. FIG. 5B is a diagram of a cross-section of the mirror element of FIG. 5A taken along the line B-B′ depicted in FIG. 5A. FIG. 5C is a diagram of a cross-section of the mirror element of FIG. 5A taken along the line A-A′ depicted in FIG. 5A. The mirror element 4001 comprises a mirror 4003, an elastic hinge 4007 for supporting the mirror 4003, two address electrodes (i.e., address electrodes 4008a and 4008b) and memory cells (i.e., first memory cell 4010a and second memory cell 4010b—that correspond to the respective address electrodes.

In the mirror element shown in FIGS. 5A through 5C, the mirror 4003 is made of a highly reflective material, such as aluminum or gold, is supported by the elastic hinge 4007, of which the entirety or a part (e.g., the connection part with a fixed part, the connection part with a moving part or the intermediate part) is made of a silicon material, a metallic material or the like, and the mirror 4003 is placed on the device substrate 4004. Specifically, the silicon material may be composed of a poly-silicon, single crystal silicon, amorphous silicon, and combination of or similar kinds of materials, while the metallic material may include aluminum, titanium, or an alloy of them. Alternatively, a composite material produced by layering different materials may be used. Ceramic or glass may also be used to form the elastic hinge 4007.

The mirror 4003 is formed in the approximate shape of a square, with the length of a side, ranging between 4 μm and 10 μm in an exemplary embodiment. Further, the mirror pitch may be between 4 μm and 10 μm. The deflection axis 4005 of the mirror 4003 is on the diagonal line thereof.

The light emitted from a light source may be a coherent light such as a laser light source, to project onto the mirror 4003 along an orthogonal or diagonal direction relative to the deflection axis 4005.

The following is a description of the reason for placing the deflection axis of the mirror 4003 on the diagonal line thereof.

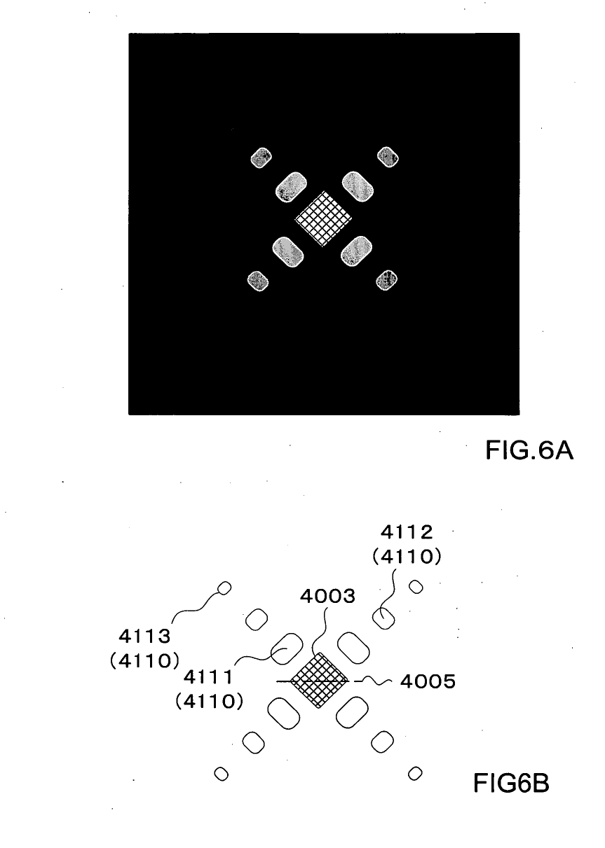

FIGS. 6A and 6B are diagrams for showing the diffracted light patterns generated when the light is reflected by a mirror of a mirror device.

As shown in the figures, the diffracted light is generated as a result of irradiating the light onto a mirror shown in the center of the diagrams, and the diffracted light 4110 spreads in directions perpendicular to the four sides of the mirror 4003 as the primary diffracted light 4111, the secondary diffracted light 4112, the tertiary diffracted light 4113, and so on. As shown in FIG. 6A, the light intensity decreases gradually with the primary diffracted light 4111, secondary diffracted light 4112, tertiary diffracted light 4113, and so on. When using a laser light source, the coherence is improved by the uniformity of the wavelength of a laser light, distinguishing the diffracted light 4110. Note that the diffracted light 4110 also possesses an expansion to the depth direction of the mirror 4003 in three dimensions.

The mirror device 4000 shown in FIG. 2 can be configured to set the diagonal direction of the mirror 4003 as the deflection axis thereof, thereby preventing the diffracted light 4110 from entering the projection optical system.

As a result, the diffracted light 4110 does not enter the projection optical system, and thereby the contrast of a projected image is improved. It is also possible to enhance the contrast by setting the deflecting angle of the mirror 4003 at a large angle relative to the incidence pupil of the projection lens and by maintaining the numerical aperture of the illumination light at a lower value, thereby separating the OFF light from the incidence pupil of the projection lens by a greater distance. This is the reason for placing the deflection axis of the mirror 4003 on the diagonal line thereof.

The lower end of the elastic hinge 4007 is connected to the device substrate 4004 that includes a circuit for driving the mirror 4003. The upper end of the elastic hinge 4007 is connected to the bottom surface of the mirror 4003. In the exemplary embodiment, an electrode for securing an electrical continuity and an intermediate member for improving the strength of a member and improving the strength of connection may be placed between the elastic hinge 4007 and the device substrate 4004, or between the elastic hinge 4007 and the mirror 4003.

Further, in the exemplary embodiment shown in FIG. 5C, a hinge electrode 4009 is formed between the elastic hinge 4007 and device substrate 4004. Note that a simple notation of “electrode” means the address electrode in the following description.

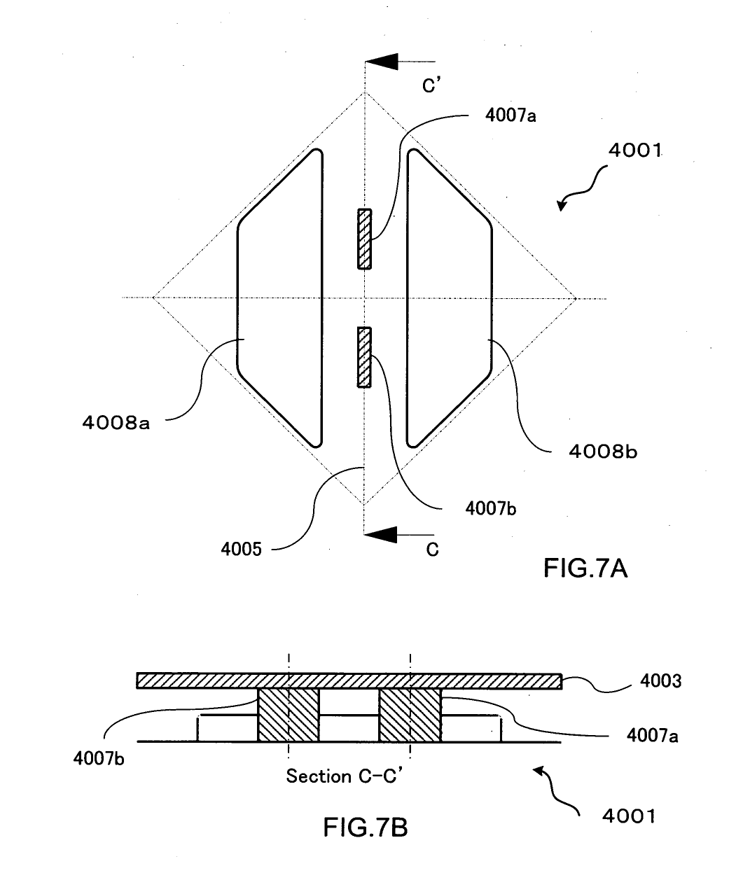

FIGS. 7A and 7B are diagrams showing an example of a modification of a mirror element of a mirror device according to the present embodiment. FIG. 7A is a diagram of the mirror element, as viewed from above, with the mirror removed. FIG. 7B is a diagram of a cross-section of FIG. 7A as taken along the line C-C′ depicted in FIG. 7A.

Note that a plurality of elastic hinges (refer to 4007a and 4007b) may be placed along the deflection axis 4005 of the mirror 4003, as shown in FIGS. 7A and 7B. Such a placement of elastic hinges is advantageous because the mirror is stabilized during a deflection operation. When a plurality of elastic hinges is placed, as shown in FIGS. 7A and 7B, the interval between the elastic hinges, or the interval between the multiple intermediate members placed between the hinge and substrate should be as large as possible, preferably no less than 30% of the deflection axis length of the mirror.

As shown in FIG. 5C, the electrodes 4008a and 4008b are placed on the top surface of the device substrate 4004 and opposite to the bottom surface of the mirror 4003 for driving the mirror 4003. The address electrodes are placed in either symmetrical or nonsymmetrical locations relative to the deflection axis 4005. The address electrodes may be formed with aluminum, tungsten or copper. The mirror element 4001 further includes two memory cells, i.e., a first memory cell 4010a and a second memory cell 4010b, to apply voltages to the address electrodes 4008a and 4008b.

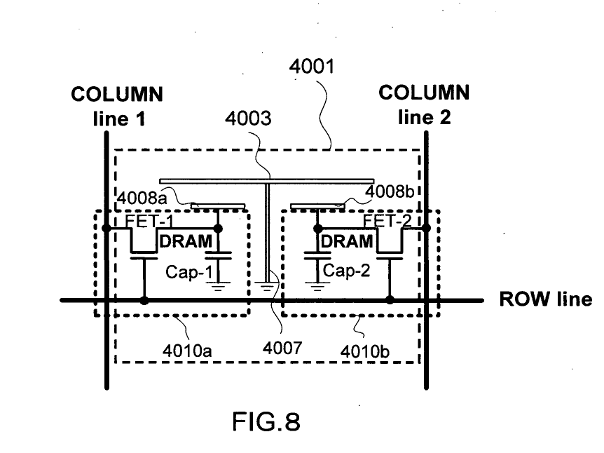

As shown in FIG. 8, the first and second memory cells 4010a and 4010b each includes a dynamic random access memory (DRAM) implemented with the field effect transistors (FETs) and a capacitance in this configuration. The memory cells 4010a and 4010b may be implemented with different types of memory devices such as a static random access memory (SRAM), or similar kinds of memory circuits other than DRAM.

Furthermore, the individual memory cells 4010a and 4010b are connected to the respective address electrodes 4008a and 4008b to receive signals from a COLUMN line 1, a COLUMN line 2, and a ROW line.

In the first memory cell 4010a, an FET-1 is connected to the address electrode 4008a to a COLUMN line 1 and ROW line, respectively, and a capacitance Cap-1 is connected between the address electrode 4008a and GND (i.e., the ground). Likewise, in the second memory cell 4010b, an FET-2 is connected to the address electrode 4008b, to COLUMN line 2 and ROW line, respectively, and a capacitance Cap-2 is connected between the address electrode 4008b and GND.

Controlling the signals on the COLUMN line 1 and ROW line applies a predetermined voltage to the address electrode 4008a, thereby making it possible to tilt the mirror 4003 towards the address electrode 4008a. Likewise, controlling the signals on the COLUMN line 2 and ROW line applies a predetermined voltage to the address electrode 4008b, thereby making it possible to tilt the mirror 4003 towards the address electrode 4008b.

Note that a drive circuit for each of the memory cells 4010a and 4010b is generally formed inside the device substrate 4004. Controlling the respective memory cells 4010a and 4010b, in accordance with the signal of image data, enables control of the deflection angle of the mirror 4003 and carries out the modulation and reflection of the incident light.

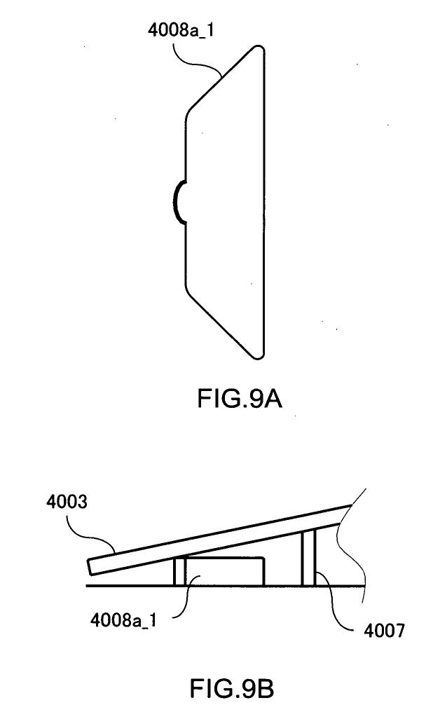

The following is a description of the address electrode comprised in a mirror element according to the present embodiment. FIGS. 9A, 9B, 10, 11, 12A, 12B, 13, 14A, 14B, 15A, 15B, 16A, 16B and 16C are diagrams that describe the different forms of address electrodes included in the mirror element 4001 according to the present embodiment.

The present embodiment is configured such that the address electrode also functions as a stopper for determining the deflection angle of the mirror. The deflection angle of the mirror is the angle determined by the aperture ratio of a projection lens that satisfies a theoretical resolution determined by the pitch of adjacent mirrors on the basis of the equation below:

Rp=0.61*λ/NA=1.22*λ*F

In other words, the deflection angle of a mirror may not be set at a lower angle than the determined angle. Since a laser light is transmitted with a uniform phase, the diffracted light has a higher light intensity than the light emitted from a mercury lamp. Therefore, the adverse effects of the diffracted light from a coherent light projected from a laser light source can be prevented by setting the deflection angle of mirror at a larger angle than the appropriate angle calculated from the numerical aperture NA of the light flux of a laser light source and the F-number for a projection lens, thereby preventing the diffracted light from being reflected towards the projection lens. In an exemplary embodiment, the deflection angle of a mirror may be 10 to 14 degrees, or 2 to 10 degrees, relative to the horizontal state of the mirror 4003. In a configuration in which the address electrode also serves as a stopper, the space available for the electrode is significantly increased compared to a conventional configuration with the address electrode formed separately from the stopper. The mirror device implemented with such mirror element can therefore be further miniaturized.

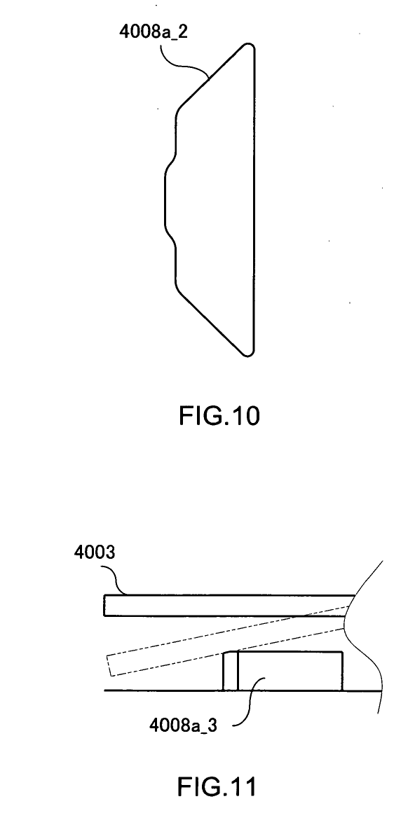

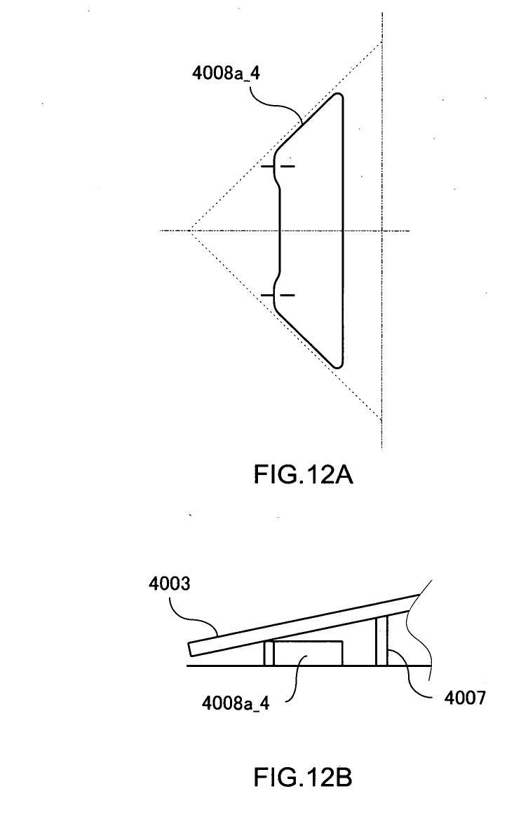

“Stiction” is a well-known phenomenon in which a mirror 4003 sticks to the contact surface between the mirror 4003 and address electrode (i.e., also a stopper) due to surface tension or intermolecular force when the mirror is deflected. Accordingly, part of the address electrode may be configured as a circular arc, as shown in FIGS. 9A and 9B, so as to reduce contact with the mirror 4003 to a single point, or to a line of contact, as shown in FIG. 10, in order to reduce stiction between the mirror 4003 and address electrode. The performance of the mirror elements in the mirror device may be adversely affected as a result of excessive contact force between the parts of the address electrode in contact with the mirror 4003. In order to prevent the adverse effects, the mirror may be configured to incline in the same angle as the tilt angle of the mirror 4003 to adjust the contact pressure, as shown in FIG. 11. Note that the address electrode contacts with the mirror 4003 face to face in a single spot in the example shown in FIG. 11. The address electrode may also contact the mirror 4003 in multiple places, as shown in FIGS. 12A and 12B, and is not limited to a single spot. The configuration as shown in FIGS. 12A and 12B is preferable because the deflecting direction of the mirror is stably maintained. In this case, the individual contact points are preferably placed apart from each other at a distance no less than 30% of the diagonal size of the mirror.

Further, a part of the address electrode, including at least the part contacting the mirror 4003, may be provided with an inactive surface material, such as halide, in order to reduce the occurrence of stiction between the mirror 4003 and address electrode. Moreover, an elastic member formed as an integral part of the electrode may be used as a stopper.

The address electrode is configured to have a shape of a trapezoid includes a top and a bottom side, which are approximately parallel to the deflection axis 4005. The trapezoid further includes sloped sides approximately parallel to the contour line of the mirror 4003 of the mirror device, in which the deflection axis 4005 of the mirror 4003 is matched with the diagonal line thereof, as shown in FIG. 5A. Since the address electrode and stopper are not separately manufactured as in the conventional method, the electrode-stopper may be conveniently manufactured. The address electrode may also be configured with the above-described trapezoid divided into multiple parts. In order to prevent a random reflection light from entering into the projection light path, at least a part of the address electrode may be covered with a low reflectance material or a thin film layer having the film thickness substantially equivalent to ¼ of the wavelength λ of the visible light.

A difference in potentials needs to be generated between the mirror and the address electrode to drive the mirror by electrostatic force. The present embodiment using the electrode also as stopper is configured to provide the surface of the electrode and/or the rear surface of the mirror with an insulation layer(s) in order to prevent an electrical shorting at the point of mirror contact with the electrode. If the surface of the address electrode is provided with an insulation layer, the configuration may also be such that the insulation layer is provided to only a part of the electrode, including the part in contact with the mirror. FIG. 5C exemplify the case of providing the surface of the address electrode (i.e., 4008a and 4008b) with an insulation layer 4006. The insulation layer is made of an oxidized compound, azotized compound, silicon, or silicon compound, e.g., SiC, SiO₂, Al₂O₃, and Si. The material and thickness of the insulation layer is determined so that the dielectric strength voltage is maintained at no less than the voltage required to drive the mirror, preferably no less than 5 volts. For example, the dielectric strength voltage may be configured to be two times the drive voltage of the mirror or higher, 3 volts or higher, or 10 volts or higher. Further, selecting an insulation material resistant to the etchant used in the production process makes it possible for the material to also function as the electrode protective film in the process of etching a sacrificial layer in the production process, thereby simplifying the production process.

The following description is for an exemplary embodiment to show the size and shape of an address electrode.

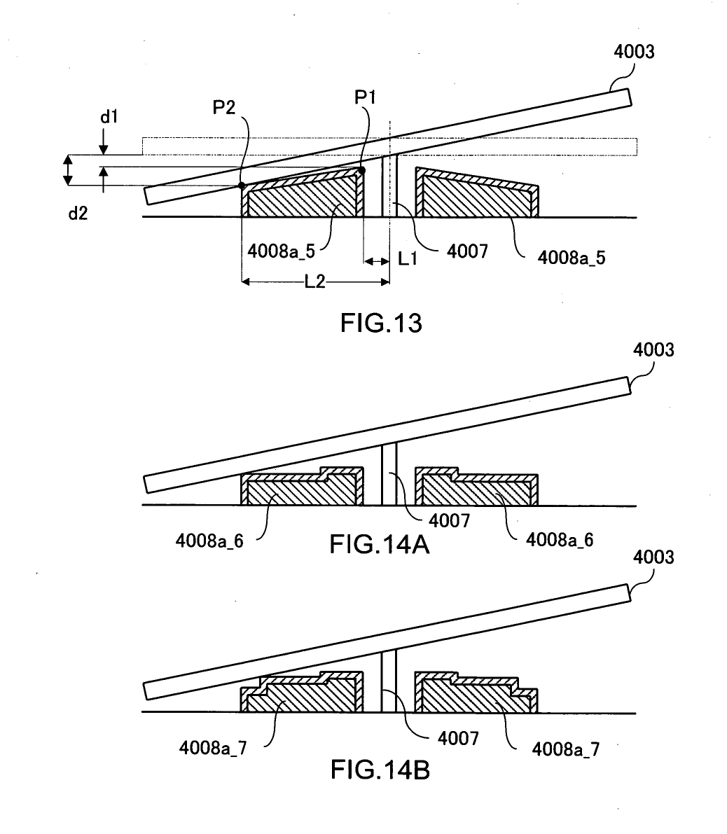

Referring to FIG. 13, “L1” is the distance between the deflection axis and the edge of the address electrode on the side closer to the deflection axis of the mirror 4003; “L2” is the distance between the deflection axis and the edge of the address electrode on the side farther from the deflection axis, and “d1” and “d2” are the distances between the mirror's bottom surface and the address electrode at the respective edges. “P1” is a representative point on the electrode edge on the side closer to the deflection axis of the mirror, and “P2” is a representative point on the electrode edge on the side farther from the deflection axis.

The exemplary embodiment as shown in FIG. 13 is a case in which the address electrode is formed so that: d1<d2. In this configuration, the stopper that determines the tilt angle of the mirror 4003 is preferably placed at the point “P2”, in consideration of a production variance of the electrode height that influences the deflection angle of the mirror. The present embodiment is accordingly configured to satisfy the relationship of:

d1>(L1*d2)/L2

This configuration provides an efficient space utilization of the space under the mirror and maintains a stable deflection angle of the mirror. Note that, while in the example shown in FIG. 13, the points P1 and P2 form a continuous slope, an address electrode with a stepped slop may also be formed, as shown in FIGS. 14A and 14B, for ease of production.

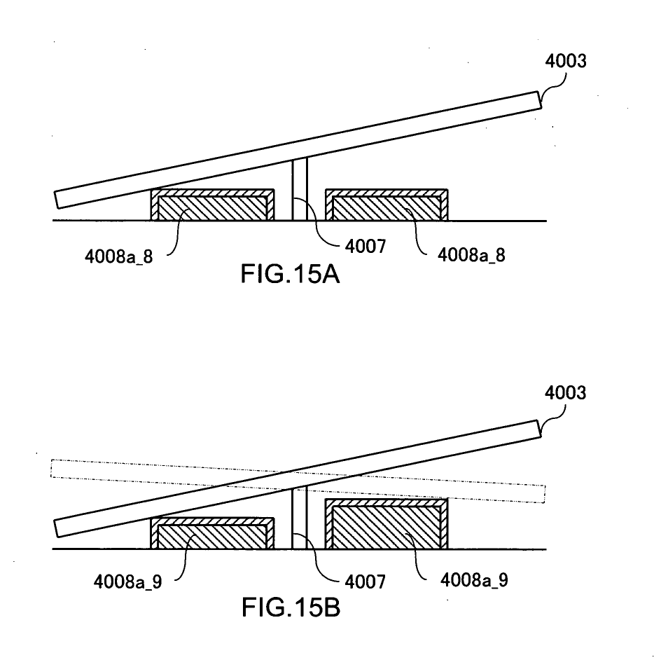

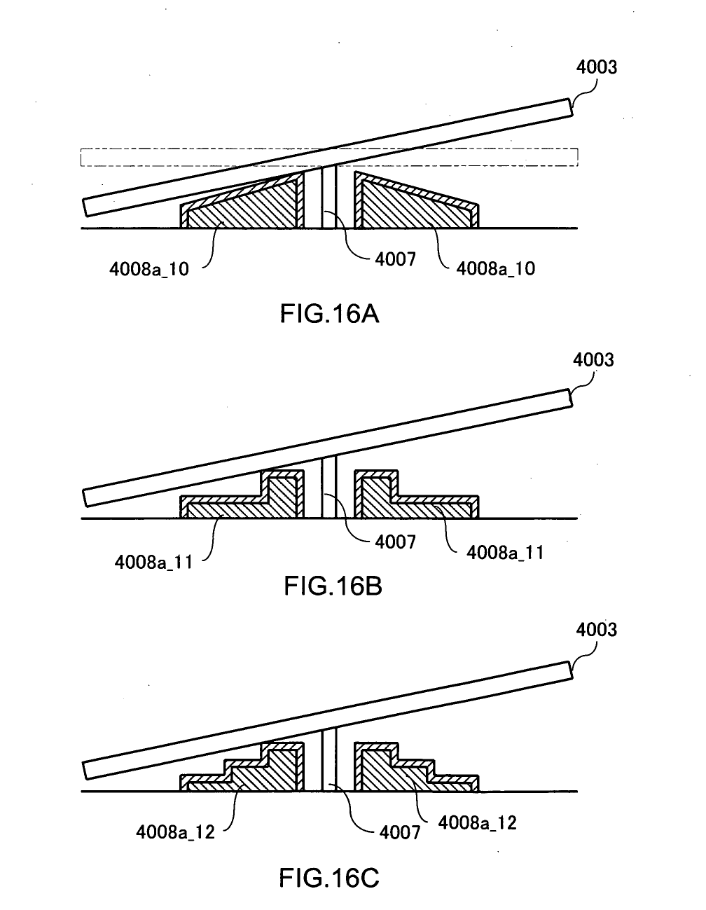

Furthermore, it is possible to configure the address electrode so that the deflection angle of the mirror 4003, when it comes into contact with the address electrode on one side, is the same as the deflection angle of the mirror 4003, when it comes in contacts with the address electrode on the other side, as shown in FIG. 15A, or such that the aforementioned two deflection angles are different, as shown in FIG. 15B. Specifically, the address electrode may be configured to deflect the mirror to have a greater deflection angle in the OFF state than that in the ON state. When the reduction of stiction between the address electrode and mirror is a consideration, the closer the contact point to the deflection axis, the more advantageous it is because the momentum impeding the motion of the mirror due to stiction is smaller. If stiction is still a concern, even when an address electrode is coated with a layer for preventing stiction, the configurations as shown in FIGS. 16A, 16B and 16C are viable. In FIGS. 16A, 16B and 16C the stoppers are formed closer to the deflection axis, i.e. not on the external parts of the address electrode farthest from the deflection axis.

When the electrode is configured so that d1=d2, the point on the electrode determining the deflection angle of the mirror is P2, and the configuration is determined to satisfy the following equation:

cot θ=d2/L2

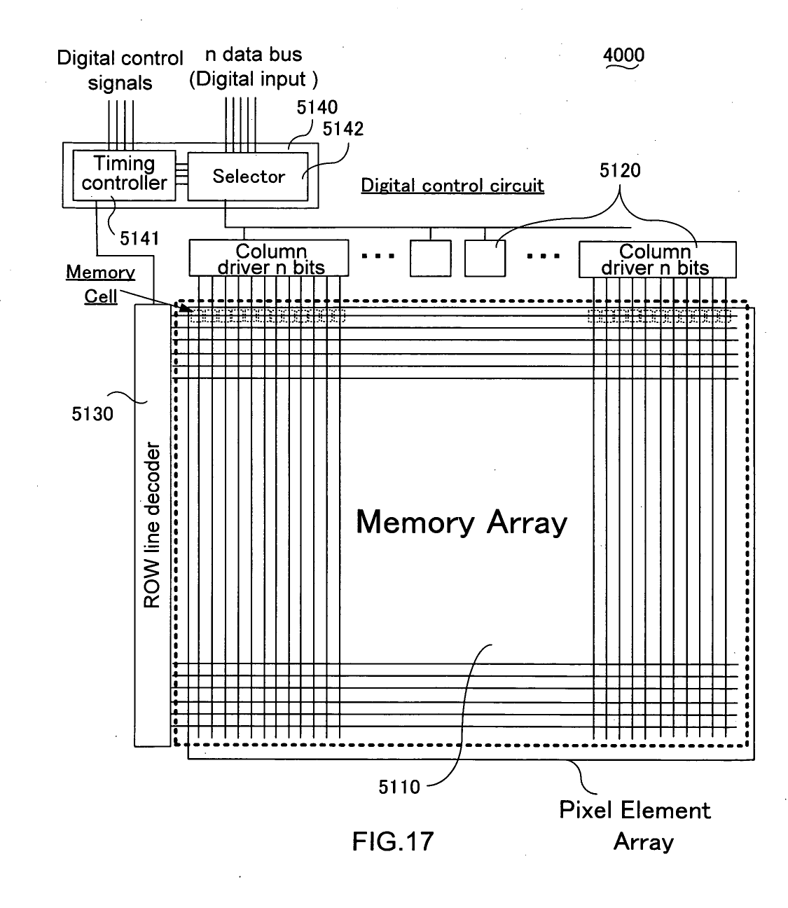

The following is an outline description of the circuit implemented in the mirror device according to the present embodiment. As shown in FIG. 17, the mirror device 4000 according to the present embodiment includes a mirror element array 5110, column drivers 5120, ROW line decoders 5130, and an external interface unit 5140.

The external interface unit 5140 includes a timing controller 5141 and a selector 5142. The timing controller 5141 controls the ROW line decoder 5130 on the basis of a timing signal from the SLM controller (shown in drawing). The selector 5142 supplies the column driver 5120 with digital signal incoming from the SLM controller.

In the mirror element array 5110, a plurality of mirror elements 4001 is arranged in arrays at the positions where individual bit lines, which are vertically extended respectively from the column drivers 5120, crosses individual word lines which are horizontally extended respectively from the ROW decoders 5130.

An electrical voltage is applied to the address electrodes 4008 (i.e., the address electrodes 4008a and 4008b) in each mirror element 4001. The electrical voltage is applied to the address electrodes 4008) through the memory cells (i.e., the first memory cell 4010a and the second memory cell 4010b) shown as shown in FIG. 8. The voltage applied to the electrodes is based on the signals from the bit lines and word line. Specifically, the bit lines correspond to the COLUMN lines 1 and 2, which are shown in FIG. 8, and the word line corresponds to the ROW line shown in FIG. 8. The address electrodes 4008a and 4008b are noted as OFF electrode 5116 and ON electrode 5115, respectively, in the following description for convenience.

Another method of driving a mirror to display an image with higher levels of gray scale resolution with a reduced drive voltage is disclosed in US Patent Application 20050190429. In this disclosure, a mirror is controlled to freely oscillate in an oscillation state. The oscillation has an inherent oscillation frequency. The mirror operated in oscillating state projects an intensity of light that is about 25% to 37% of the emission light intensity when a mirror is controlled under a constant ON state.

According to such a control, it is no longer required to drive the mirror at a high speed to achieve a higher resolution of gray scale. A high level of gray scale resolution is achievable with a hinge of a low spring constant for supporting the mirror. The drive voltage may be reduced. This method, combined with the method of decreasing the drive voltage by decreasing the deflection angle of a mirror, as described above, would produce an even greater improvement.

As described above, the use of a laser light source makes it possible to decrease the deflection angle of a mirror and to shrink the mirror device without causing a degradation of brightness, and further, the use of the above described oscillation control enables a higher level of gradation without causing an increase in the drive voltage.

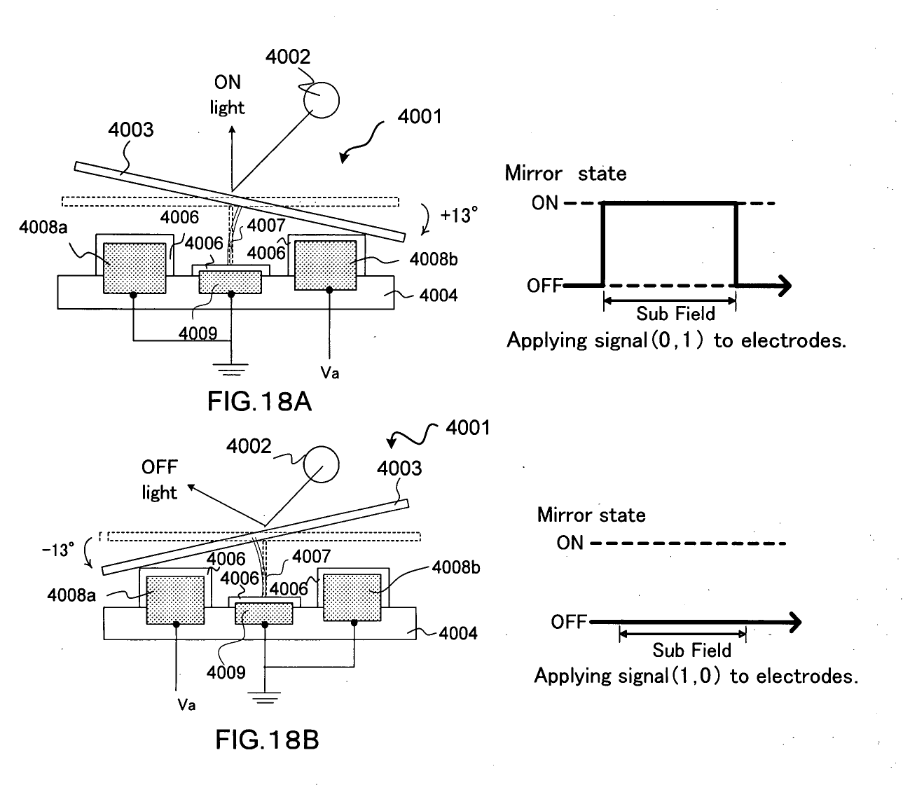

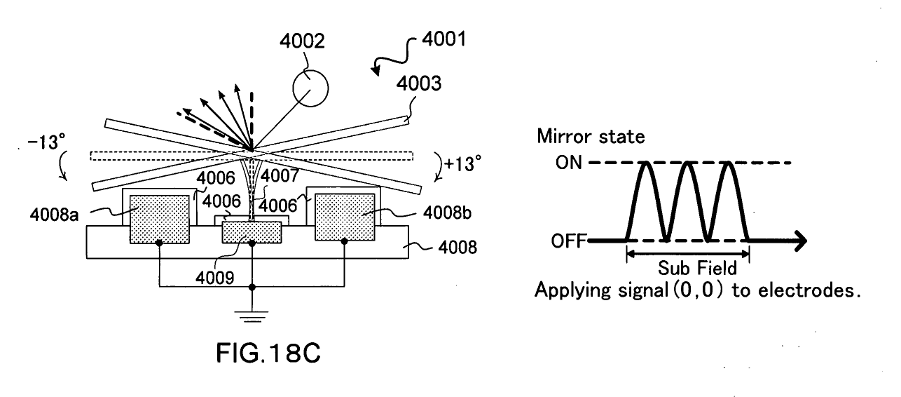

FIG. 18A is a diagram delineating the state reflecting an incident light toward a projection optical system by deflecting the mirror of a mirror element. Note that this case exemplifies the case of designating the deflection angle at 13 degrees, a deflection angle, however, is not limited this angle.

Giving a signal (0, 1) to the memory cells 4010a and 4010b (which are not shown here) described in FIG. 8 applies a voltage of “0” volts to the address electrode 4008a of FIG. 18A and applies a voltage of “Va” volts to the address electrode 4008b. As a result, the mirror 4003 is deflected from a deflection angle of “0” degrees, i.e., the horizontal state, to that of +13 degrees attracted by a coulomb force in the direction of the address electrode 4008b to which the voltage of “Va” volts is applied. This causes the incident light to be reflected by the mirror 4003 toward the projection optical system (which is called the ON light state).

Note that the present patent application defines the deflection angles of the mirror 4003 as “+” (positive) for clockwise (CW) direction and “−” (negative) for counterclockwise (CCW) direction, with “0” degrees as the initial state of the mirror 4003. Further, an insulation layer 4006 is provided on the device substrate 4004, and a hinge electrode 4009 connected to the elastic hinge 4007 is grounded through the insulation layer 4006.

FIG. 18B is a diagram delineating the state in which an incident light is not reflected toward a projection optical system by deflecting the mirror of a mirror element.

Giving a signal (1, 0) to the memory cells 4010a and 4010b (which are not shown here) described in FIG. 8 applies a voltage of “Va” volts to the address electrode 4008a, and “0” volts to the address electrode 4008b. As a result, the voltage of “Va” volts is applied to the address electrode 4008a to generate a Coulomb force to draw the mirror 4003 to deflect from a deflection angle of “0” degrees, i.e., the horizontal state, to a tilt angle of −13 degrees. This causes the incident light to be reflected by the mirror 4003 to elsewhere other than the light path toward the projection optical system (which is called the OFF light state).

FIG. 18C is a diagram delineating the state in which reflecting and not reflecting an incident light toward a projection optical system are repeated by free-oscillating the mirror of a mirror element.

In either of the states shown in FIGS. 18A and 18B, in which the mirror 4003 is pre-deflected, giving a signal (0, 0) to the memory cells 4010a and 4010b (which are not shown here) applies a voltage of “0” volts to the address electrodes 4008a and 4008b. As a result, the Coulomb force, which has been generated between the mirror 4003 and the address electrode 4008a or 4008b, is eliminated so that the mirror 4003 performs a free oscillation within the range of the deflection angles ±13 degrees in accordance with the property of the elastic hinge 4007. The incident light is reflected toward the projection optical system only within the range of a deflection angle to produce the ON light in association with the free oscillation of the mirror 4003. The mirror 4003 repeats the free oscillations, changing over frequently between the ON light state and OFF light state. Controlling the number of changeovers makes it possible to finely adjust the intensity of light reflected toward the projection optical system (which is called a free oscillation state).

The total intensity of light reflected by means of the free oscillation toward the projection optical system is certainly lower than the intensity when the mirror 4003 is continuously in the ON light state and higher than the intensity when it is continuously in the OFF light state. That is, it is possible to make an intermediate intensity between those of the ON light state and OFF light state. Therefore, a higher gradation image can be projected than with the conventional technique by finely adjusting the intensity as described above.

Although not shown in the drawing, an alternative configuration may be such that only a portion of light is made to enter the projection optical system by reflecting an incident light in the initial state of a mirror 4003. Configuring as such, a reflection light enters the projection optical system in higher intensity than that when the mirror 4003 is continuously in the OFF light state and lower intensity than that when the mirror 4003 is continuously in the ON light state (which is called an intermediate light state).

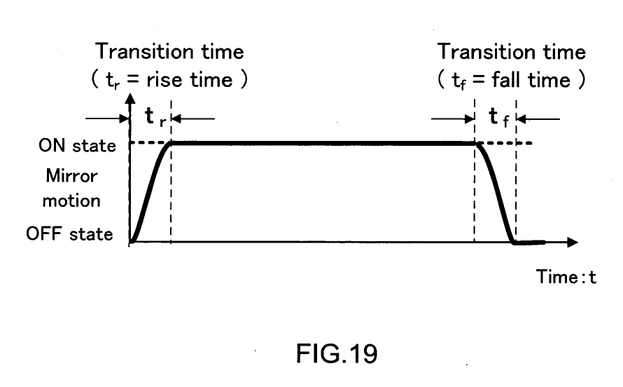

FIG. 19 is a chart showing the transition time between the ON state and OFF state of the mirror 4003. In a transition from the OFF state, in which the mirror 4003 abuts the address electrode 4008a, to the ON state in which the mirror 4003 is abuts the address electrode 4008b, a rise time tᵣ, in the early stage of starting the transition, is required before the mirror 4003 fully reaches the ON state; in a transition from the ON state to the OFF state, a fall time t_{f} is likewise required before the mirror fully reaches the OFF state. Note that the following description combines the rise time tᵣ and fall time t_{f}, known generally as the mirror changeover transition time t_{M}, when they are not distinguished from one another.

The following description outlines the natural oscillation frequency of the oscillation system of a mirror device according to the present embodiment.

The reduction of the drive voltage to achieve a higher resolution of gray scales by controlling the mirrors in a free oscillation is already described above. For a mirror device controlled by a pulse width modulator to operate with a free oscillation intermediate state by applying a control word with a LSB, there is a functional relationship between the length of time represented by the LSB and the natural frequency of the oscillation for a mirror supported on a hinge. The natural oscillation cycle T of an oscillation system=2*π*√(I/K)=LSB time/X [%]; where:

I: the rotation moment of an oscillation system,

K: the spring constant of an elastic hinge,

LSB time: the LSB cycle at displaying n bits, and

X [%]: the ratio of the light intensity obtained by one oscillation cycle to the Full-ON light intensity of the same cycle

Note that:

“I” is determined by the weight of a mirror and the distance between the center of gravity and the center of rotation;

“K” is determined from the thickness, width, length, material and cross-sectional shape of an elastic hinge; and

“LSB time” is determined from one frame time, or one frame time and the number of reproduction bits, in the case of a single-panel projection method.

“X” is determined as described above, particularly from the F-number of a projection lens and the intensity distribution of an illumination light. For example, when a single-panel color sequential method is employed, the ratio of emission intensity by one oscillation is assumed to be 32%, and the minimum emission intensity in a 10-bit grayscale is to be obtained by an oscillation, then “I” and “K” are designed so as to have a natural oscillation cycle as follows:

T=1/(60*3*2¹⁰*0.32)≈17.0 μsec.

In contrast, when a conventional PWM control is employed to make the changeover transition time t_{M} of a mirror approximately equal to the natural oscillation frequency of the oscillation system of the mirror and the LSB is regulated so that a shortage of the light intensity in the interim can be sufficiently ignored, the gray scale reproducible with the above described hinge is about 8-bit, even if the LSB is set at five times the changeover transition time t_{M}. Specifically, the control process of this invention when implemented with the elastic hinge is able to display an image of a 10-bit grayscale in contrast to the projection apparatuses applying conventional control process would be able to display an image of only about an 8-bit grayscale.

In the single-panel projection apparatus described above, an example configuration attempting to obtain, for example, 13-bit grayscale is as follows:

LSB time=( 1/60)*(⅓)*(½¹³)=0.68 μsec

If a configuration is such that the light intensity obtained in one cycle for the optical projection system is 38% of the intensity obtained from controlling a mirror in a constant ON state for the same cycle, the oscillation cycle T is as follows:

T=0.68/0.38=1.8 μsec

In contrast, when attempting to obtain an 8-bit grayscale in the multi-panel projection apparatus described above, an example comprisal is as follows:

LSB time=( 1/60)*(⅓)*( 1/28)=21.7 μsec

If a configuration is such that the light intensity obtained in one cycle for the optical projection system is 20% of the intensity obtained from controlling a mirror in a constant ON state for the same cycle, the oscillation cycle T is as follows:

T=21.7/0.20=108.5 μsec.

As described above, the present embodiment is configured to set the natural oscillation cycle of the oscillation system, which includes an elastic hinge, between 1.8 μsec and 110 μsec; and to use three deflection state, i.e., a first deflection state (ON state), in which the light modulated by the mirror element is reflected towards the projection light path, a second deflection state (OFF state), in which the light is reflected in a direction away from the projection light path, and a third deflection state (oscillation state), in which the mirror oscillates between the first and second deflection states. A higher resolution of gray scales is achievable without increasing the drive voltage of the mirror element.

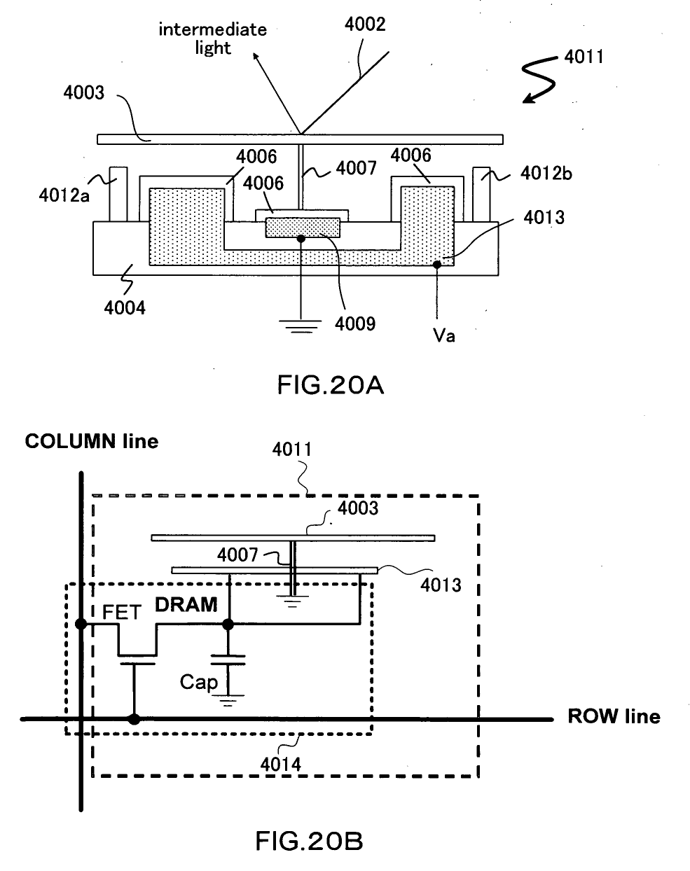

FIG. 20A shows a cross-section of a mirror element that is configured to be implemented with only one address electrode and one drive circuit as another embodiment of a mirror element.

The mirror element 4011 shown in FIG. 20A includes an insulation layer 4006 on a device substrate 4004 including one drive circuit for deflecting a mirror 4003. Further, an elastic hinge 4007 is formed on the insulation layer 4006. The elastic hinge 4007 supports one mirror 4003, and one address electrode 4013, which is connected to the drive circuit, is equipped under the mirror 4003.

Note that the area sizes of the address electrode 4013 exposed above the device substrate 4004 are configured to be different between the left side and right side of the deflection axis of the elastic hinge 4007, or mirror 4003, with the area size of the exposed part of the address electrode 4013 on the left side of the elastic hinge 4007 being larger than the area size on the right side, in FIG. 20A.

Specifically, the mirror 4003 is deflected by the electrical control of one address electrode 4013 and drive circuit. Further, the deflected mirror 4003 is retained at a specific deflection angle by contacting with stopper 4012a or 4012b, which are formed in the vicinity of the exposed parts on the left and right sides of the address electrode 4013.

More specifically, an alternative configuration may eliminate the stopper for allow more areas to form the electrode as described above with the mirror contacting the address electrode directly.

Furthermore, a hinge electrode 4009 connected to the elastic hinge 4007 is grounded through the insulation layer 4006 as part of the mirror element 4011.

The present patent application calls the part, which is exposed above the device substrate 4004, of the address electrode 4013 of FIG. 20A as electrode part, in specific, calls the left part as “first electrode part” and the right part as “second electrode part, with the deflection axis of the elastic hinge 4007 or mirror 4003 referred to as the border.

As such, the applying of a voltage by configuring the address electrode 4013 to be asymmetrical, that is, the area size of the left side is different from that of the right side, in relation to the deflection axis of the elastic hinge 4007 or mirror 4003, generates the difference in coulomb force between (a) and (b), where (a): a coulomb force generated between the first electrode part and mirror 4003, and (b): a coulomb force generated between the second electrode part and mirror 4003. The mirror 4003 can be deflected by differentiating the Coulomb force between the left and right sides of the deflection axis of the elastic hinge 4007 or mirror 4003.

Meanwhile, FIG. 20B is an outline diagram of a cross-section of the mirror element 4011 shown in FIG. 20A. Requiring only one address electrode 4013 makes it possible to reduce the two memory cells 4010a and 4010b, which correspond to the two address electrodes 4008a and 4008b in the configuration of FIG. 8, to one memory cell 4014. This in turn makes it possible to reduce the amount of wiring for controlling the deflection of the mirror 4003.

Other comprisals are similar to the configuration described for FIG. 8B and therefore the description is not provided here.

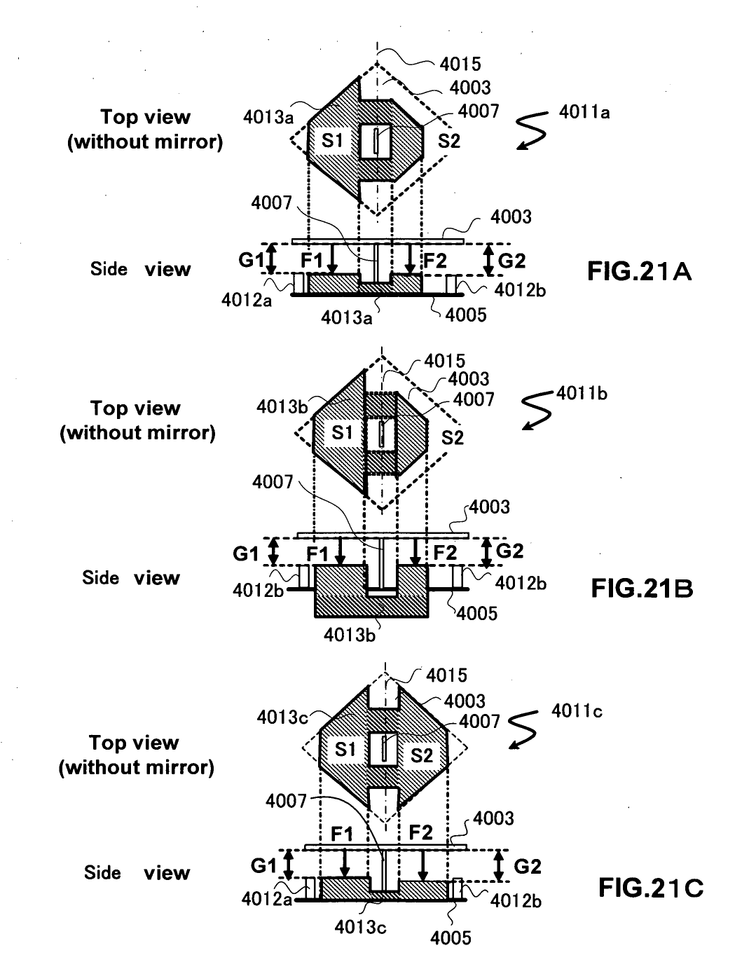

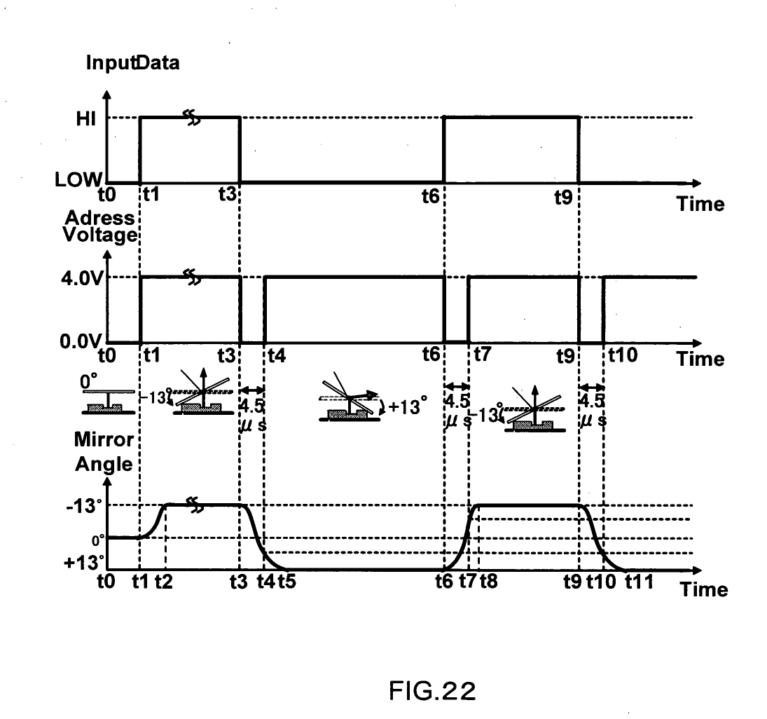

The following is a description, in detail, of a single address electrode 4013 controlling the deflection of a mirror with reference to FIGS. 21A, 21B, 21C and 22.

Mirror elements 4011a and 4011b respectively shown in FIGS. 21A and 21B each is configured such that the respective area sizes of the first and second electrode parts of one address electrode 4013 on the left and right sides, sandwiching the deflection axis 4015 of the mirror 4003, are different from each other (i.e., asymmetrical).

FIG. 21A shows a top view diagram, and a cross-sectional diagram, both of a mirror element 4011a structured such that the area size S1 of a first electrode part of one address electrode 4013a is greater than the area size S2 of a second electrode part (S1>S2), and such that the connection part between the first and second electrode parts is in the same structural layer as the first and second electrode parts.

In contrast, FIG. 21B shows a top view diagram, and a cross-sectional diagram, both of a mirror element 4011b structured such that the area size S1 of a first electrode part of one address electrode 4013b is greater than the area size S2 of a second electrode part (S1>S2), and such that the connection part between the first and second electrode parts is in a different structural layer from the first and second electrode parts.

The following is a description of the control for the deflecting operation of a mirror in the mirror element 4011a or 4011b, each respectively shown in FIG. 21A or 21B.

FIG. 22 is a diagram showing a data input to the mirror elements 4011a or 4011b, the voltage application to the address electrodes 4013a or 4013b, and the deflection angles of the mirror 4003, in a time series.

Referring to FIG. 22, the “data input” is to the mirror element 4011a or 4011b, which is controlled in two states, i.e., HI and LOW, with the HI representing a data input, that is, projecting an image and LOW representing no data input, that is, not projecting an image.

The following description refers to the control of only the mirror element 4011a shown in FIG. 21A, of the two mirror elements 4011a and 4011b (shown in FIG. 21B), unless otherwise noted.

FIG. 22 shows the vertical axis of the “address voltage” represents the voltage applied to the address electrode 4013a or 4013b of the mirror element 4011a or 4011b, and the voltage applied to the address electrode 4013a or 4013b is, for example, “4” volts and “0” volts.

The vertical axis of the “mirror angle” of FIG. 22 represents the deflection angle of the mirror 4003, defining the deflection angle of the mirror 4003 in the state in which it is parallel to the device substrate 4004 to be “0” degrees. Further, with the first electrode part of the address electrode 4013a or 4013b defined as the ON light state side, the maximum deflection angle of the mirror 4003 in the ON light state is set at −13 degrees. On the other hand, with the second electrode part of the address electrode 4013a or 4013b defined as the OFF light state side, the maximum deflection angle of the mirror 4003 in the OFF light state is set at +13 degrees. Therefore, the mirror 4003 deflects within a range in which the maximum deflection angles of the ON light state and OFF light state are ±13.

Note that the deflection angle is designated at 13 degrees as an example; the deflection angle is not limited to that particular angle.

Furthermore, the horizontal axis of FIG. 22 represents elapsed time t.

When the deflecting operation of the mirror 4003 is performed in the configuration of FIGS. 21A and 21B, a voltage is applied to the address electrode 4013a or 4013b at the timing on the basis of the passage of time due to a data input and a data rewrite.

Referring to FIG. 22, no data is inputted between the time t0 and t1, and the mirror 4003 is accordingly in the initial state. That is, the deflection angle of the mirror 4003 is “0” degrees in the state in which no voltage is applied to the address electrode 4013a or 4013b.

At the time t1, a voltage of 4 volts is applied to the address electrode 4013a or 4013b, causing the mirror 4003 to be attracted by a coulomb force generated between the mirror 4003 and address electrode 4013a or 4013b toward the first electrode part having a large area size so that the mirror 4003 shifts from the 0-degree deflection angle at the time t1 to a −13-degree deflection angle at time t2. Then, the mirror 4003 is retained on the stopper 4012a on the first electrode part side.

The distance G1 between the mirror 4003 and the first electrode part and the distance G2 between the mirror 4003 and the second electrode part, when the mirror 4003 is in the initial state, are the same, and the first electrode part has a larger area size than the second electrode part, and therefore the first electrode part can retain a larger amount of charge. As a result, a larger coulomb force is generated for the first electrode part.

Between the time t2 and t3, continuously applying a voltage of 4 volts to the address electrode 4013a or 4013b in accordance with the period in response to the data input causes the mirror 4003 to be retained on the stopper 4012a on the first electrode part side.

Then, at the time t3, stopping the data input applies a voltage of “0” volts to the address electrode 4013a or 4013b. As a result, the Coulomb force generated between the address electrode 4013a or 4013b and mirror 4003 is withdrawn. This causes the mirror 4003 retained on the first electrode part side to be shifted to a free oscillation due to the restoring force of the elastic hinge 4007.

Furthermore, the deflection angle of the mirror 4003 becomes θ>0 degrees, and when a voltage of 4 volts is applied to the address electrode 4013a or 4013b at the time t4 when a coulomb force F1, generated between the mirror 4003 and first electrode part, and a coulomb force F2, generated between the mirror 4003 and second electrode part, constitutes the relationship of F1<F2, and thereby the mirror 4003 is attracted to the second electrode part. Further, the mirror 4003 is retained onto the stopper 4012b of the second electrode part at the time t5.

The reason is that the second power of a distance has a greater effect on a Coulomb force F than the difference in electrical voltages, according to the equation noted above. Therefore, with an appropriate adjustment of the area sizes of the first and second electrode parts, a coulomb force F acts more strongly on the smaller distance G2 of the distance between the address electrode 4013a or 4013b and mirror 4003, despite the fact that the area S2 of the second electrode part is smaller than the area S1 of the first electrode part. As a result, the mirror 4003 can be deflected to the second electrode part.

Note that the transition time of the mirror 4003 between the time t3 and t4 is preferably performed in about 4.5 μsec in order to obtain a high grade of gradation. Further, a control can possibly be performed to turn off the illumination light synchronously with a transition of the mirror 4003, so as to not let the illumination light be reflected and incident to the projection light path during a data rewrite, that is, during the transition of the mirror 4003, between the time t3 and t4.

Continuously applying a voltage to the address electrode 4013a or 4013b between the time t5 and t6 causes the mirror 4003 to be continuously retained to the stopper 4012b of the second electrode part. In this event, no data is input and therefore no image is projected.

Then, at the time t6, a new data input is carried out. The voltage of 4 volts, which has been applied to the address electrode 4013a or 4013b, is changed over to “0” volts at the time t6 in accordance with the data input. This operation withdraws the Coulomb force generated between the mirror 4003 retained onto the second electrode part and the address electrode 4013a or 4013b, similar to the process at time t3, so that the mirror 4003 shifts to a free oscillation state due to the restoring force of the elastic hinge 4007.

A voltage of 4 volts is again applied to the address electrode 4013a or 4013b at the time t7 when a coulomb force F1, which is generated between the mirror 4003 and first electrode part, and a coulomb force F2, which is generated between the mirror 4003 and second electrode part, constitutes the relationship of F1>F2 when the deflection angle of the mirror 4003 becomes θ<0 degrees, and thereby the mirror 4003 is attracted to the first electrode part. Then the mirror 4003 is retained onto the second electrode part at the time t8.

This principle is understood from the description of the action of a coulomb force between the above described time t3 and t5. Also in this event, the transition time of the mirror 4003 between the time t3 and t4 is preferably performed in about 4.5 μsec, and the control is performed in such a manner as to turn off the illumination light synchronously with a transition of the mirror 4003, so as to not let the illumination light be reflected and incident to the projection light path during the transition of the mirror 4003.

Then, continuously applying a voltage of 4 volts to the address electrode 4013a or 4013b between the time t8 and t9 causes the mirror 4003 to be continuously retained on the stopper 4012a of the first electrode part. In this event, data is continuously inputted and images are projected.

Then, the voltage applied to the address electrode 4013a or 4013b is changed from 4 volts to “0” volts as the data input is stopped at time t9. This operation puts the mirror 4003 into the free oscillation state. Then, at the time t10, a voltage is applied to the address electrode 4013a or 4013b, according to the same principle as the period from t3 to t5 and from the time t6 to t8, and thereby the mirror 4003 can be retained onto the stopper 4012b of the second electrode part at the time t11. A repetition of the similar operation enables the control for deflecting the mirror 4003.

The following is a description of the control for returning, to the initial state, the mirror 4003 retained onto the stopper 4012a of the first electrode part or onto the stopper 4012b of the second electrode part.

In order to return to the initial state, the mirror 4003 retained onto the stopper 4012a of the first electrode part or onto the stopper 4012b of the second electrode part in the state in which a voltage is applied to the address electrode 4013a or 4013b, an appropriate pulse voltage is applied.

As an example, the mirror 4003 is shifted to a free oscillation state by changing the voltage applied to the address electrode 4013a or 4013b to “0” volts in the state in which the mirror 4003 is retained onto the stopper 4012a of the first electrode part or onto the stopper 4012b of the second electrode part. When the mirror is performing a free oscillation, the mirror 4003 can be returned to the initial state by temporarily applying an appropriate voltage to the address electrode 4013a or 4013b, thereby generating a coulomb force pulling the mirror 4003 back towards the first electrode part or the second electrode part, either of which the mirror 4003 has been retained onto. That is, the coulomb force generates an acceleration in a direction reverse to the direction in which the mirror 4003 was heading when the distance between the address electrode 4013a or 4013b and the mirror 4003 reaches an appropriate distance as the mirror 4003 tilts from the first electrode part side to the second electrode part side, or vice versa.

Considering the principle of the coulomb force between the mirror and address electrode 4013a or 4013b as described above, the applying of a voltage to the address electrode 4013a or 4013b at an appropriate distance between the mirror 4003 and address electrode 4013a or 4013b also makes it possible to retain the mirror 4003 at the deflection angle of the ON light state by returning the mirror 4003 from the ON light state, or at the deflection angle of the OFF light state by returning the mirror 4003 from the OFF light state.

Note that the control of the mirror 4003 of the mirror elements 4011a and 4011b shown in FIG. 22 is widely applicable to a mirror element that is configured to have a single address electrode and to be asymmetrical about the deflection axis of the elastic hinge or mirror. As described above, the mirror can be deflected to the deflection angle of the ON light state or OFF light state, or put in the free oscillation state, with a single address electrode of a mirror element.

FIG. 21C shows a top view diagram, and a cross-sectional diagram, both of a mirror element 4011c structured such that the area size S1 of a first electrode part of one address electrode is equal to the area size S2 of a second electrode part (S1=S2), and such that the distance G1 between a mirror 4003 and the first electrode part is less than the distance G2 between the mirror 4003 and the second electrode part (G1<G2).

That is, the configuration of FIG. 21C is such that, for the address electrode 4013, the height of the first electrode part is different from that of the second electrode part and such that the distance G1 between the first electrode part and mirror 4003 is less than the distance G2 between the second electrode part and mirror (G1<G2). Furthermore, the address electrode 4013c is electrically connected to the first electrode part and second electrode part on the same layer as the address electrode 4013.

In the case of the mirror element 4011c shown in FIG. 21C, the size of the coulomb force generated between the mirror 4003 and address electrode 4013c in the first electrode part is different from that generated between the mirror 4003 and address electrode 4013c in the second electrode part because the distances between the mirror 4003 and address electrode 4013c are different between the first electrode part and the second electrode part. Therefore, the deflection of the mirror 4003 can be controlled by carrying out a control similar to the case of the above-described FIG. 22.

Note that the deflection angle of the mirror 4003 is retained by using the stoppers 4012a and 4012b in FIGS. 21A, 21B and 21C. The deflection angle of the mirror 4003, however, can be established by configuring an appropriate height of the address electrode 4013a, 4013b or 4013c to also fill the roles of the stoppers 4012a and 4012b.

Further, while the present embodiment is configured to set the control voltages at 4-volt and 0-volt applied to the address electrode 4013a, 4013b or 4013c, such control voltages are arbitrary and other appropriate voltages may be used to control the mirror 4003.

Furthermore, the mirror can be controlled with multi-step voltages to be applied to the address electrode 4013a, 4013b or 4013c. As an example, if the distance between the mirror 4003 and address electrode 4013a, 4013b or 4013c, increasing a coulomb force, the mirror 4003 can be controlled with a lower voltage than that when the mirror 4003 is in the initial state.

As described above, even with the configuration in which each mirror element comprises only one address electrode, the use of three deflection states, i.e. the first deflection state (the ON state) in which the light modulated by the mirror element is headed towards a projection light path, the second deflection state (the OFF state) in which the deflected light is headed away from the projection light path and the third deflection state (the oscillation state) in which the mirror element oscillates between the first and second deflection states, makes it possible to display an image with a high level of gradation without requiring an increase in the drive voltage for the mirror element.

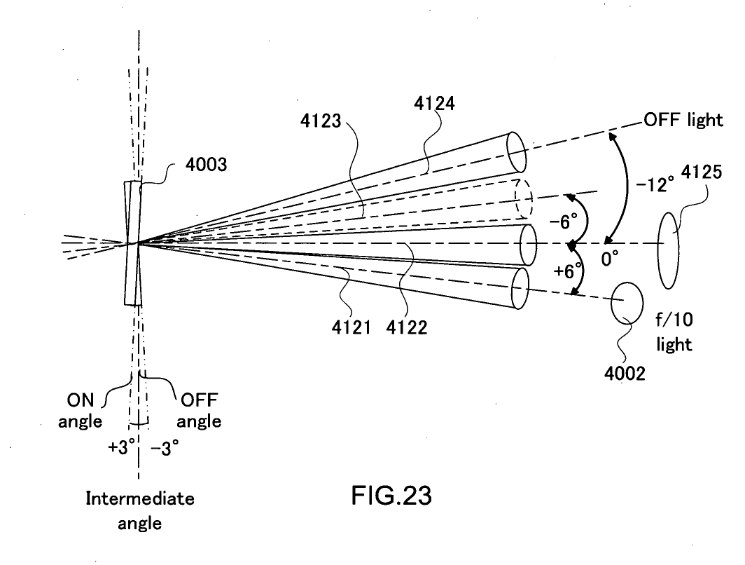

Accordingly, each mirror element of the mirror device according to the present embodiment is configured to change the deflection states of the mirror in accordance with the voltage applied to the electrode, deflecting the light incident to the mirror 4003 to specific directions as shown in the example of FIG. 23.

FIG. 23 is cross-sectional diagram for illustrating a process for reflecting coherent light with an f/10 light flux by a mirror device operated with the deflection angles of the ON light state and OFF light state of a mirror are set at +3 degrees, respectively.

The illumination light ejected from the light source 4002 is incident to the mirror 4003 as depicted by an optical axis 4121. Then, the illumination light is reflected as depicted by an optical axis 4122 in the ON state of the mirror 4003, is reflected as depicted by an optical axis 4124 in the OFF state of the mirror 4003 and is reflected as depicted by an optical axis 4123 in the initial state of the mirror 4003. The configuring as such makes it possible to not allow more securely the diffraction light and scattered light generated by the mirror in the OFF light state or OFF angle to enter a projection optical system 4125.

The following is an outline description of a package used for a mirror device according to the present embodiment.

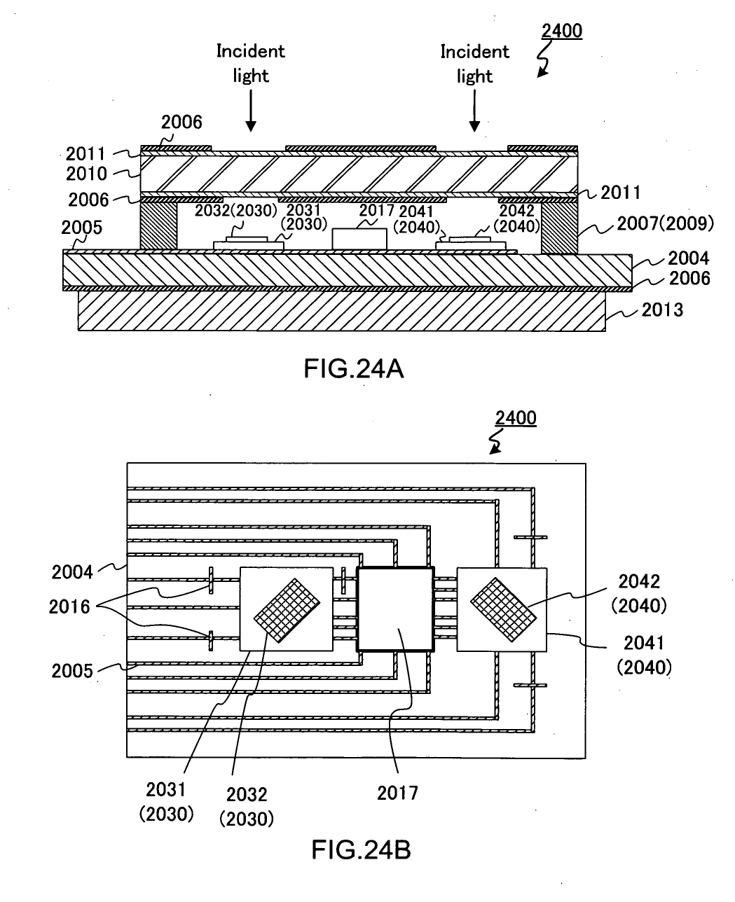

FIGS. 24A and 24B are diagrams for showing the packaging configuration of an assembly body that contains two mirror devices. The assembly body 2400 comprises a cover glass 2010 and a package substrate 2004, which is composed of glass, silicon, ceramics, metal or a composite of some of these materials. The glass used for the package substrate 2004 is preferably a material with high thermal conductivity, i.e., soda ash glass (0.55 to 0.75 W/mK) or Pyrex glass (1 W/mK), for improving radiation efficiency. The assembly body 2400 may comprise a thermal conductive member and a cooling/radiation member 2013 for radiation. The materials for each of these constituent parts are should be selected so that they have, as much as possible, similar values of thermal expansion coefficients in order to prevent a failure in the actual usage environment, such as cracking or parts mutual peeling off from one another.

Further, an intermediate member 2009 for joining the individual constituent members includes a support part 2007, for determining the height of the cover glass 2010, and a joinder member made of fritted glass, solder, epoxy resin, or the like.

The cover glass may further be provided with a light shield layer 2006, to shield the device from extraneous light, and an anti-reflection (AR) coating 2011, to prevent extraneous reflection of incident light. The anti-reflection coating 2011 is a coating made of magnesium fluoride or a nano-structure no wider than the wavelength applied to a glass surface. The light shield layer 2006 is composed of a thin black film layer containing carbon, or a multi-layer structure consisting of a thin black film layer and a metallic layer.

FIG. 24A shows that package may also be able to accommodate a plurality of mirror devices and a control circuit 2017 inside the package. Accommodating multiple devices in one package includes various benefits, in addition to cost reduction. In a projection apparatus comprising the assembly body 2400, the projecting position of each device is basically adjusted by the positional adjustment of the respective optical elements. Thus, when the pixels of the individual mirror devices 2030 and 2040 accurately overlap with each other, the resolution of the projected image is increased, and the colors reflected by the respective mirror devices 2030 and 2040 are projected more sharply. Note that FIGS. 24A and 24B exemplify a configuration in which a mirror array 2032 is placed on a device substrate 2031 and a mirror array 2042 is places on a device substrate 2041.

Furthermore, the control circuit 2017 inside the package with the circuit wiring-pattern 2005 formed with a very large number of lines is formed on a single package substrate. The floating capacity of the circuit wiring-pattern 2005 is therefore reduced. Furthermore, the control circuit 2017 controlled in higher speed than a video signal can be placed at a position equally distanced from the respective mirror devices 2030 and 2040, and the differences of resistance and floating capacity of the respective circuit wiring-patterns 2005 connected to the individual mirror devices 2030 and 2040 are reduced. This enables the use of a mirror device comprising many mirror elements and a mirror device for which a data processing volume is large and which is capable of control in higher number of gray scales. This accordingly enables an image in a high level of gradation and high resolution. Further, the shortening of the circuit wirings to the respective mirror devices makes it easy to synchronize the timing, for controlling the mirror devices, between the respective mirror devices.

Furthermore, the thermal environments of the plural mirror devices placed on a single package substrate are the same and thereby the positional shifts due to thermal expansion of mirror elements of the respective mirror devices become approximately the same. Therefore, the projection conditions can be made to be identical. Further, the controls for the respective mirror devices can also be handled as for same environment so that the control conditions, such as an analogous control of the mirror and the voltage value of memory, can be made the same for the mirror devices.

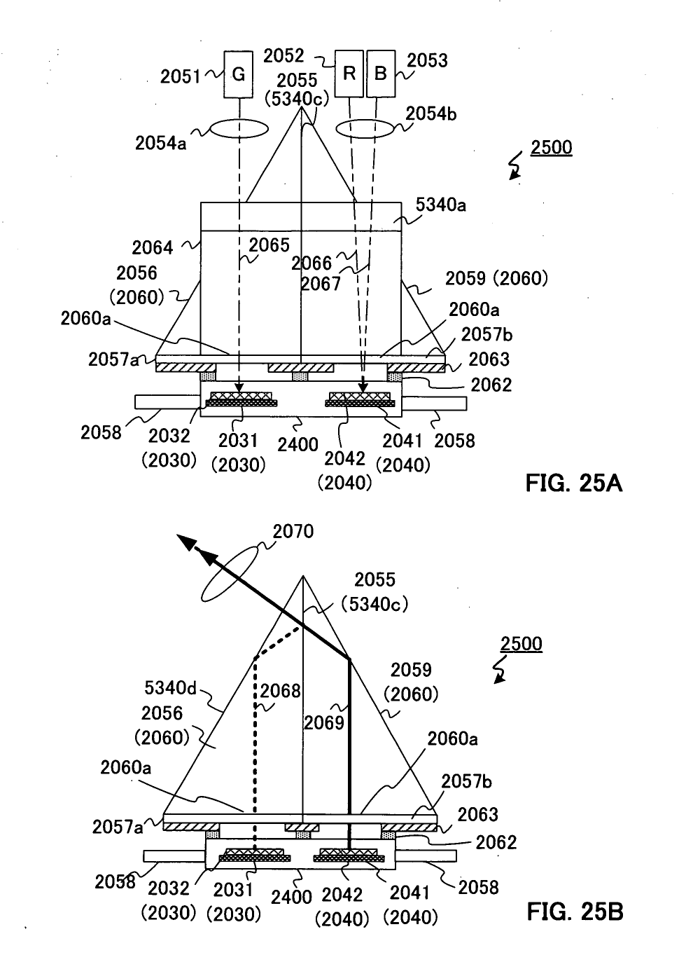

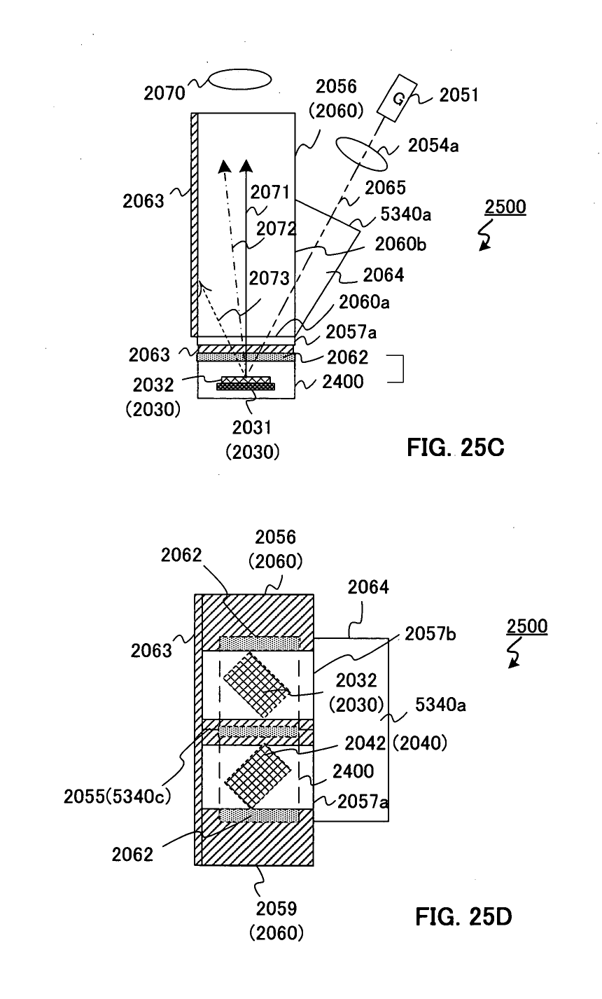

Furthermore, the projection apparatus 2500 shown in FIGS. 25A, 25B, 25C and 25D is configured with the prism members and the cover glass of the assembly body that packages the above described plurality of mirror devices are joined together by way of thermal conductive members 2062. This enables an exchange of heat between the prisms and mirror devices, making it possible to radiate heat by way of a heat radiator or heat sink (not shown in drawing) implemented on the mirror device or prism member. The projection apparatus 2500 shown in FIGS. 25A through 25D is described later in detail.

Note that the mirror devices 2030 and 2040 and the device substrates 2031 and 2041, which are shown in FIGS. 24A through 25D, correspond to the mirror device 4000 and device substrate 4004, respectively, which are shown in FIG. 2; and the mirror arrays 2032 and 2042 shown in FIGS. 24A through 25D correspond to the mirror element array 5110 shown in FIG. 17.

As described above, the mirror device according to the present embodiment is configured with the electrode also carries out a function of a stopper for regulating the deflection angle of a mirror, and thereby, the space utilization efficiency is improved when a mirror element is miniaturized, enabling an increase in the area size of the electrode. Therefore, a parallel application of an oscillation control for a mirror makes it possible to enable both a miniaturization of the mirror device and an enhancement of gradations.

Note that the mirror pitch, mirror gap, deflection angle, and drive voltage of the mirror device according to the present embodiment are not limited to the values shown in the above description. Preferably, they should be within the following ranges (including the values at each end of the range): the mirror pitch is between 4 μm and 10 μm; the mirror gap is between 0.15 μm and 0.55 μm; the maximum deflection angle of mirror is between 2 degrees and 14 degrees; and the drive voltage of mirror is between 3 volts and 15 volts.

### Second Embodiment

With reference to the accompanying drawings, the following is a description of a projection apparatus according to the second embodiment comprising a mirror device described in detail for the first embodiment.

### Embodiment 2-1

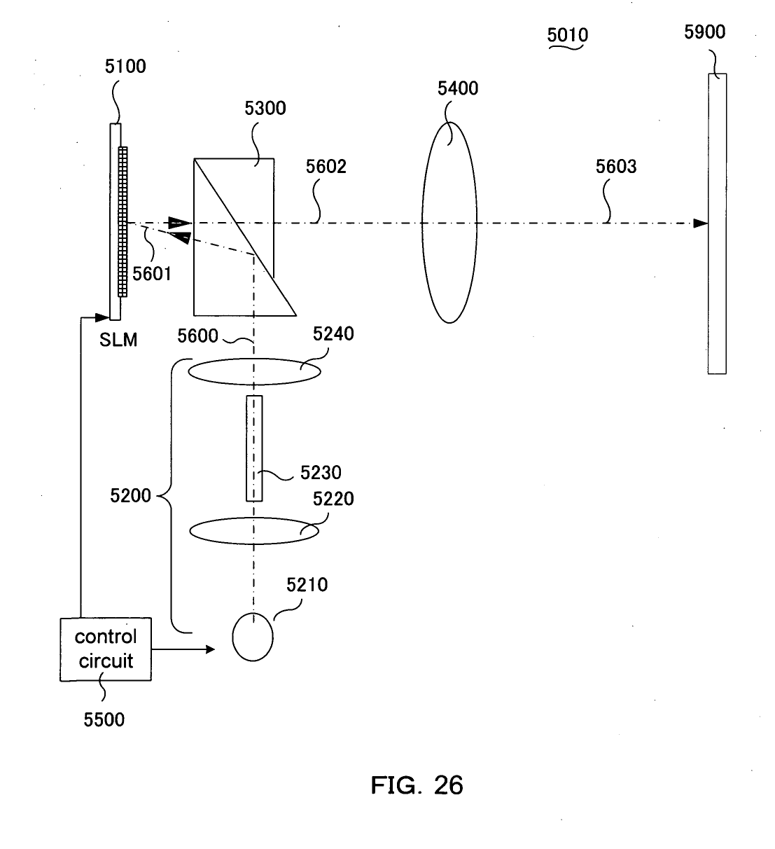

First is a description of the configuration of a single-panel projection apparatus comprising a single spatial light modulator and performing color displays by temporarily changing the frequencies of the projection light, with reference to FIG. 26.

Note that the spatial light modulator according to the present embodiment is specifically the mirror device 4000 described in detain for the first embodiment.

FIG. 26 is a functional block diagram for showing the configuration of a projection apparatus according to a preferred embodiment of the present invention.

A projection apparatus 5010, according to the present embodiment, is a commonly referred to as a single-panel projection apparatus 5010 comprising a single spatial light modulator (SLM) 5100, a control unit 5500, a Total Internal Reflection (TIR) prism 5300, a projection optical system 5400, and a light source optical system 5200, as shown in FIG. 26.

The projection optical system 5400 includes the spatial light modulator 5100 and TIR prism 5300 in the optical axis of the projection optical system 5400, and the light source optical system 5200 is positioned in such a manner that the optical axis thereof matches that of the projection optical system 5400.

The TIR prism 5300 directs the illumination light 5600, which is incoming from the light source optical system 5200 placed on the side towards the spatial light modulator 5100 at a prescribed inclination angle as incident light 5601 and transmits a reflection light 5602, reflected by the spatial light modulator 5100, to the projection optical system 5400.

The projection optical system 5400 projects the reflection light 5602, coming in from the spatial light modulator 5100 and TIR prism 5300, onto a screen 5900 as projection light 5603.

The light source optical system 5200 includes a variable light source 5210 for generating the illumination light 5600. The light source system further includes a condenser lens 5220 for focusing the illumination light 5600, a rod type condenser body 5230, and a condenser lens 5240.

The variable light source 5210, condenser lens 5220, rod type condenser body 5230, and condenser lens 5240 are sequentially placed in the aforementioned order on the optical axis of the illumination light 5600 projected from the variable light source 5210 into the side face of the TIR prism 5300.

The projection apparatus 5010 employs a single spatial light modulator 5100 for projecting a color display on the screen 5900 by applying a sequential color display method. That is, the variable light source 5210, comprising a red laser light source 5211, a green laser light source 5212, and a blue laser light source 5213 (not shown in drawing) that allows independent controls for the light emission states, divides one frame of display data into multiple sub-fields (in this case, three sub-fields: red (R), green (G) and blue (B)) and makes each of the light sources emit each respective light in a time series at the time band corresponding to the sub-field of each color. This process will be described in greater detail later. Note that the red laser light source 5211, green laser light source 5212 and blue laser light source 5213 may alternatively be replaced with light emitting diodes (LEDs), respectively.

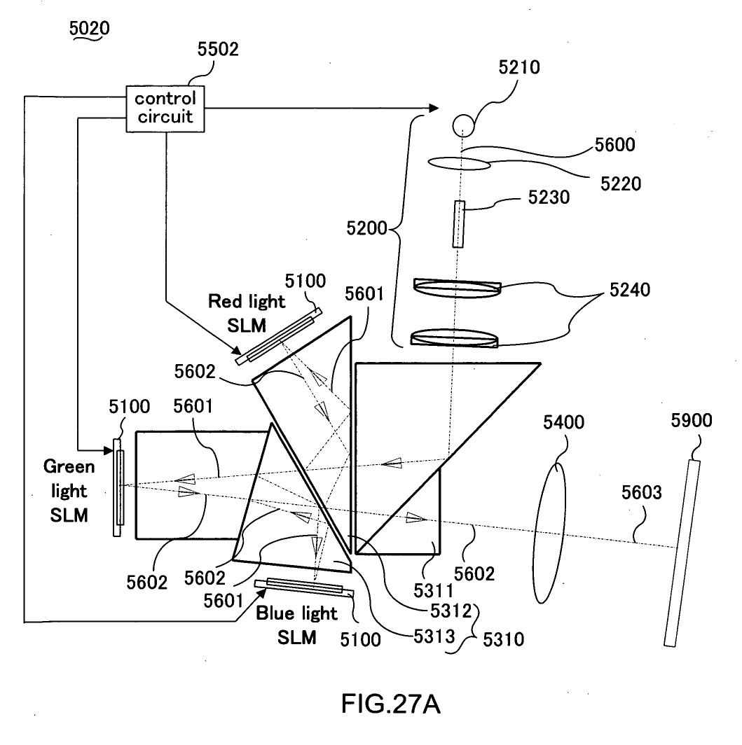

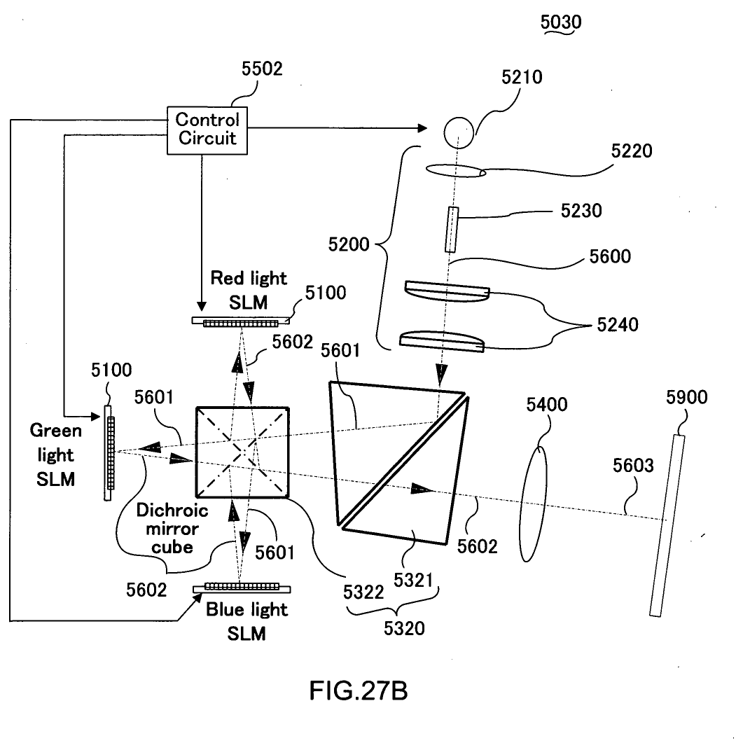

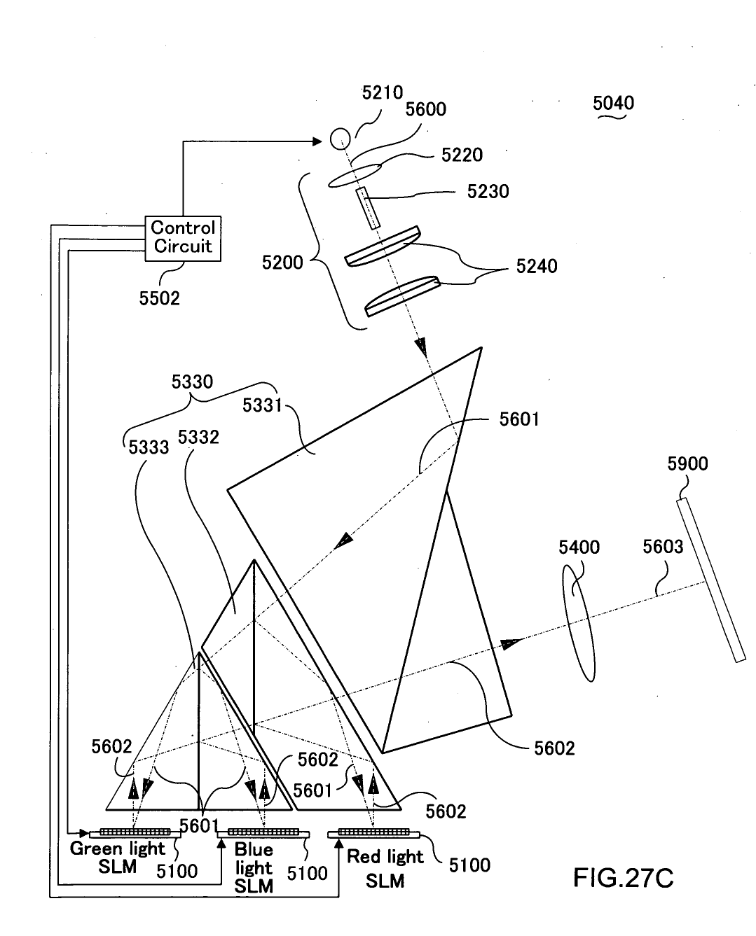

The following is a description of a multi-panel projection apparatus using a plurality of spatial light modulators to continuously modulate the illumination lights with respectively different frequencies using the individual spatial light modulators and carrying out a color display by synthesizing the modulated illumination lights, with reference to FIG. 27A.

FIG. 27A is a functional block diagram for showing the configuration of a projection apparatus according to another preferred embodiment of the present invention.

The projection apparatus 5020 is a commonly known as multiple-plate projection apparatus comprising a plurality of spatial light modulators 5100, which is the main difference from projection apparatus 5010 described above. Further, the projection apparatus 5020 includes a control unit 5502 in place of the control unit 5500.

The projection apparatus 5020 includes a plurality of spatial light modulators 5100, and further includes a light separation/synthesis optical system 5310 disposed between the projection optical system 5400 and each of the spatial light modulators 5100.

The light separation/synthesis optical system 5310 includes a TIR prism 5311, a prism 5312 and a prism 5313.

The TIR prism 5311 directs the illumination light 5600, incident from the side of the optical axis of the projection optical system 5400, to the spatial light modulator 5100 as incident light 5601.

The prism 5312 has separates the red (R) light from an incident light 5601, incident by way of the TIR prism 5311 and, making the red light incident to the red light-use spatial light modulators 5100, directs the reflection light 5602 of the red light to the TIR prism 5311.

Likewise, the prism 5313 separates the blue (B) and green (G) lights from the incident light 5601, passing through the TIR prism 5311 to project onto the blue color-use spatial light modulators 5100 and green color-use spatial light modulators 5100, directs the reflection light 5602 of the green light and blue light to the TIR prism 5311.

Therefore, the spatial light modulations of the three color lights R, G and B are carried out simultaneously at three spatial light modulators 5100, respectively, and the reflection lights resulting from the respective modulations are projected onto the screen 5900 as the projection light 5603, by way of the projection optical system 5400; thus a color display is carried out.

Note that various modifications are possible for a light separation/synthesis optical system and are not limited to the light separation/synthesis optical system 5310.

FIG. 27B is a functional block diagram for showing the configuration of a modified embodiment of a multi-panel projection apparatus according to another preferred embodiment of the present invention.

The alternate embodiment includes a light separation/synthesis optical system 5320 in place of the above described light separation/synthesis optical system 5310. The light separation/synthesis optical system 5320 includes a TIR prism 5321 and a cross-dichroic mirror 5322.

The TIR prism 5321 directs an illumination light 5600, projected from the lateral direction of the optical axis of the projection optical system 5400, to the spatial light modulators 5100 as incident light 5601.

The cross dichroic mirror 5322 separates red, blue and green lights from the incident light 5601, incoming from the TIR prism 5321, making the incident lights 5601 of the three colors enter the red-use, blue-use and green-use spatial light modulators 5100, respectively, and also converging the reflection lights 5602, reflected by the respective color-use spatial light modulators 5100, and directing the light towards the projection optical system 5400.

FIG. 27C is a functional block diagram for showing the configuration of yet another modified embodiment of a multi-panel projection apparatus according to the present embodiment.

The projection apparatus 5040 is configured, in contrast from the above described projection apparatuses 5020 and 5030, to place, so as to be adjacent to one another in the same plane, a plurality of spatial light modulators 5100 corresponding to the three colors R, G and B on one side of a light separation/synthesis optical system 5330. This configuration makes it possible to consolidate the multiple spatial light modulators 5100 into the same packaging unit, and thereby saving space.

The light separation/synthesis optical system 5330 includes a TIR prism 5331, a prism 5332 and a prism 5333. The TIR prism 5331 has the function of directing, to spatial light modulators 5100, the illumination light 5600, incident in the lateral direction of the optical axis of the projection optical system 5400, as incident light.

The prism 5332 serves the functions of separating a red color light from the incident light 5601 and directing it towards the red color-use spatial light modulator 5100, and of capturing the reflection light 5602 and directing it to the projection optical system 5400.

Likewise, the prism 5333 serves the functions of separating the green and blue incident lights from the incident light 5601, making them incident to the individual spatial light modulators 5100 implemented for the respective colors, and of capturing the green and blue reflection lights 5602 and directing them towards the projection optical system 5400.

Unlike the above described single-panel projection apparatus, a visual problem such as a color break usually does not occur in a multi-panel projection apparatus since the individual primary colors are constantly projected. Furthermore, a bright image can be obtained because the light emitted from the light source can be effectively utilized. On the other hand, there are other challenges, such as a more complicated adjustment for the positioning of the spatial light modulator corresponding to the lights of individual colors and an increase in the size of the apparatus.

The above description has described a three-panel projection apparatus comprising three spatial light modulators as an example of a multi-panel projection apparatus.

### Embodiment 2-2

The following is a description of a two-panel projection apparatus comprising two spatial light modulators (i.e., mirror devices) as an example of a multi-panel projection apparatus.

FIGS. 25A, 25B, 25C and 25D show the configuration of a two-panel projection apparatus 2500 comprising the assembly body 2400, shown in the above described FIGS. 24A and 24B, which is obtained by one package accommodating two mirror devices 2030 and 2040.

The two-panel projection apparatus 2500 does not project only one color of three colors R, G and B in sequence, nor does it project the R, G and B colors continuously and simultaneously, as in the case of a three-panel projection apparatus. A two-panel projection apparatus projects an image by continuously projecting, for example, a green light source possessing high visibility, a red light source, and a blue light source in sequence.

The two-panel projection apparatus 2500 is capable of changing over colors in high speed by means of pulse emission in 180 kHz to 720 kHz by comprising laser light sources, thereby making it possible to obscure flickers caused by changing over among the light sources of the respective colors. It may be alternatively configured to use a light emitting diode (LED) light source in place of the laser light source.

Note that the present configuration using laser light sources emitting the colors red (R), green (G) and blue (B), is arbitrary. Laser lights of colors cyan (C), magenta (M) and yellow (Y) may be also used. Further an R light closer to the wavelength of G, in place of a pure R, a G light closer to the wavelength of R or B, in place of a pure Q and a B light closer to the wavelength of G, in place of a pure B may be used. Further, laser lights of four wavelengths or more, obtained by combining the aforementioned colors, may be used.

Further, a projection method of continuously projecting the brightest color and changing over among the other colors in sequence on the basis of the image signals can also be adopted. Such a projection method can also be applied to a configuration that makes R, G and B lights correspond to the respective mirror devices, as in the three-panel projection method.

FIG. 25A is a front view diagram of a two-panel projection apparatus 2500; FIG. 25B is a rear view diagram of the two-panel projection apparatus 2500; FIG. 25C is a side view diagram of the two-panel projection apparatus 2500; and FIG. 25D is a top view diagram of the two-panel projection apparatus 2500.

The following is a description of the optical comprisal and principle of projection of the two-panel projection apparatus 2500 shown in FIGS. 25A through 25D.

The projection apparatus 2500 shown in FIGS. 25A through 25D includes a green laser light source 2051, a red laser light source 2052, a blue laser light source 2053, illumination optical systems 2054a and 2054b, two triangular prisms 2056 and 2059, ¼ wavelength plates 2057a and 2057b, two mirror devices 2030 and 2040 accommodated in a single package, a circuit board 2058, a light guide prism 2064 and a projection lens 2070.

The two triangular prisms 2056 and 2059 are joined together to constitute one color synthesis prism 2060. Further, the joined part (i.e., a surface of synthesis 2055a) between the two triangular prisms 2056 and 2059 is provided with a polarization beam splitter film 2055 or coating. The color synthesis prism 2060 primarily carries out a function of synthesizing the light reflected by the two mirror devices 2030 and 2040.

The polarization beam splitter film 2055 is a filter for transmitting only an S-polarized light and reflecting P-polarized light.

A slope face of the right-angle triangle cone light guide prism 2064 is adhesively attached to the front surface of the color synthesis prism 2060, with the bottom of the light guide prism 2064 facing upward. The green laser light source 2051, the illumination optical system 2054a corresponding to the green laser light source 2051, the red laser light source 2052, the blue laser light source 2053, and the illumination optical system 2054d corresponding to the red laser light source 2052 and blue laser light source 2053 are disposed beyond the bottom surface 2064a of the light guide prism 2064, with the respective optical axes of the green laser light source 2051, red laser light source 2052, blue laser light source 2053 being aligned perpendicularly to the bottom surface of the light guide prism 2064.

Specifically, the light guide prism 2064 is implemented for causing the respective lights of the green laser light source 2051, red laser light source 2052 and blue laser light source 2053 to perpendicularly enter the color synthesis prism 2060. Such a light guide prism 2064 makes it possible to reduce the amount of the reflection light caused by the color synthesis prism 2060 when the laser light enters the color synthesis prism 2060.

Further, ¼ wavelength plates 2057a and 2057b are implemented on the bottom surface of the color synthesis prism 2060, on which a light shield layer 2063 (i.e., a light absorption member) is applied to the regions other than the areas where the light is irradiated on the individual mirror devices 2030 and 2040. Because of this, the light shield layer 2063 is also applied between the mirror device 2030 and mirror device 2040. Note that the ¼ wavelength plates 2057a and 2057b may alternatively be implemented on the cover glass of the package.

Furthermore, a light shield layer 2063 is formed also on the rear surface of the color synthesis prism 2060.

Further, the two mirror devices 2030 and 2040, which are accommodated in a single package, are disposed under the ¼ wavelength plates 2057a and 2057b. That is, the configuration is such that the two mirror devices are sealed by the bottom surface (i.e., the principal surface) of the optical member constituted by the light guide prism 2064, color synthesis prism 2060 and ¼ wavelength plates 2057a and 2057b.

The cover glass of the package is joined to the color synthesis prism 2060 with a thermal conduction member 2062 functions as a joinder layer. This joinder layer transmits heat from the cover glass of the package to the color synthesis prism 2060 through the thermal conduction member 2062. Furthermore, the circuit boards 2058, comprising a control circuit(s) for controlling the individual mirror devices 2030 and 2040, are formed on both sides of the package.

Further, the mirror devices 2030 and 2040 are respectively placed to form a 45-degree angle relative to the four sides of the outer circumference of the package on the same horizontal plane. That is, the placement the mirror devices 2030 and 2040 is such that the deflecting direction of each mirror element of the mirror devices 2030 and 2040 is approximately orthogonal to the slope face forming the color synthesis prism 2060 and to the plane on which the reflection lights are synthesized. It is very important that a high degree of precision be used in positioning the mirror devices 2030 and 2040 within the package, in relation to the color synthesis prism 2060, by means of the positioning pattern 2016.

Incidentally, the illumination optical systems 2054a and 2054b each includes a convex lens, a concave lens and other components, and the projection lens 2070 includes a plurality of lenses and other components.

The following is the principle of projection of the projection apparatus 2500 shown in FIGS. 25A through 25D.

In the projection apparatus 2500, the individual laser lights 2065, 2066 and 2067 are incident from the front direction and are reflected by the two mirror devices 2030 and 2040 toward the rear direction, and then an image is projected by way of the projection lens 2070 located in the rear.

The following is a description of the projection principle starting from the incidence of the individual laser lights 2065, 2066 and 2067 to the reflection of the respective laser lights 2065, 2066 and 2067 at the two mirror devices 2030 and 2040 toward the rear direction, with reference to the front view diagram of the two-panel projection apparatus shown in FIG. 25A.

The respective laser lights 2065, 2066 and 2067 emitted from the S-polarized green laser light source 2051, and the P-polarized red laser light source 2052 and blue laser light source 2053 are made to be incident to the color synthesis prism 2060 by way of the illumination optical systems 2054a and 2054b, respectively corresponding to the laser lights 2065, and 2066 and 2067, and by way of the light guide prism 2064. Then, having transmitted through the color synthesis prism 2060, the S-polarized green laser light 2065 and the P-polarized red and blue laser lights 2066 and 2067 are incident to the ¼ wavelength plates 2057a and 2057b, which are placed on the bottom surface of the color synthesis prism 2060. Having passed through the ¼ wavelength plates 2057a and 2057b, the individual laser lights 2065, 2066 and 2067 respectively change the polarization by the amount of ¼ wavelength to become a circular polarized light state.

Then, having passed through the ¼ wavelength plates 2057a and 2057b, the circular polarized green laser light 2065 and the circular polarized red and blue laser lights 2066 and 2067 are respectively incident to the two mirror devices 2030 and 2040 that are accommodated in a single package. The individual laser lights 2065, 2066 and 2067 are modulated and reflected by the corresponding mirror devices so that the rotation directions of the circular polarization are reversed.

Specifically, the red laser light 2066 and blue laser light 2067 are incident to the mirror device 2040; the assumption is that the mirror device 2040 is configured to perform modulation on the basis of a video image signal corresponding to either wavelength.

Note that at least portions of the individual light fluxes of the red laser light 2066 and blue laser light 2067 overlap with each other and mix in the illumination light paths between the red laser light source 2052 and mirror device 2040 and between the blue laser light source 2053 and mirror device 2040. The mixed light is incident to the mirror device 2040.

Further in this event, an alternative configuration may be such that the incidence angle of the green laser light 2065, incident to the mirror device 2030, is different from that of the red laser light 2066 and blue laser light 2067, which are incident to the mirror device 2040. In such a case, each mirror device causing the above described deflection angle to be decreased to a minimum angle, which is determined by the frequency of the light as the target of modulation, makes it possible to reduce the power consumption of the mirror device and enhance the contrast of a projection image. The deflection angle may be decreased when deflecting light of a shorter wavelength versus with light of a longer wavelength.

The following is a description of the projection principle starting from the reflection of individual laser lights 2065, and 2066 and 2067 to the projection of an image with reference to the rear view diagram of the two-panel projection apparatus shown in FIG. 25B.

The ON light 2068 of the circular polarized green laser and the mixed ON light 2069 of the circular polarized red and blue lasers, which are reflected by the respective mirror devices 2030 and 2040, passes through the ¼ wavelength plates 2057a and 2057b again and enter the color synthesis prism 2060. In this event, the polarization of the green laser ON light 2068 and that of the mixed red and blue laser ON light 2069 are respectively changed by the amount of ¼ wavelengths to become a linear polarized state with 90-degree different polarization axes. That is, the green laser ON light 2068 is changed to a P-polarized light, while the mixed red and blue laser ON light 2069 is changed to an S-polarized light.

Then, the green laser ON light 2068 and the mixed red and blue laser ON light 2069 are respectively reflected by the outer side surface (i.e., a reflection surface) of the color synthesis prism 2060, and the P-polarized green laser ON light 2068 is reflected again by the polarization beam splitter film 2055. Meanwhile, the S-polarized mixed red and blue laser ON light 2069 passes through the polarization beam splitter film 2055. Then, the green laser ON light 2068 and red and blue laser mixed ON light 2069 are incident to the projection lens 2070, and thereby a color image is projected. Note that the optical axes of the respective lights incident to the projection lens 2070 from the color synthesis prism 2060 are desired to be orthogonal to the ejection surface of the color synthesis prism 2060. Alternatively, there is also a viable configuration that does not use the ¼ wavelength plates 2057a and 2057b.

With the configuration and the principle of projection as described above, an image can be projected in the two-panel projection apparatus 2500 comprising the assembly body 2400 that packages the two mirror devices 2030 and 2040, which are accommodated in a single package. Note that the assembly body 2400 in this configuration is a mirror device in a broad sense.

FIG. 25C is a side view diagram of the two-panel projection apparatus 2500.

The green laser light 2065 emitted from the green laser light source 2051 orthogonally enters the light guide prism 2064 via the illumination optical system 2054a. With such configuration, by controlling the laser light 2065 to enter into the light guide prism 2064 along an orthogonal direction can minimize the reflection of the laser light 2065.

Then, having passed through the light guide prism 2064, the laser light 2065 passes through the color synthesis prism 2060 and ¼ wavelength plates 2057a and 2057b, which are joined to the light guide prism 2064, and then enters the mirror array 2032 of the mirror device 2030.

In this event, having been reflected by the cover glass, a light shield layer 2063 applied to a surface (i.e., an opposite surface) opposite to the incidence surface before entering the mirror array 2032 of the mirror device 2030 absorbs the laser light 2065.

The mirror array 2032 reflects the laser light 2065 with the deflection angle of a mirror that puts the reflected light in any of the states, i.e., an ON light state in which the entirety of the reflection light is incident to the projection lens 2070, an intermediate light state in which a portion of the reflection light is incident to the projection lens 2070 and an OFF light state in which no portion of the reflection light is incident to the projection lens 2070.

The reflection light of a laser light (i.e., ON light) 2071, from which the ON light state is selected, is reflected by the mirror array 2032 and will be incident to the projection lens 2070.

Meanwhile, a portion of the reflection light of a laser light (i.e., intermediate light) 2072, from which the intermediate state is selected, is reflected by the mirror array 2032 and will be incident to the projection lens 2070.

Furthermore, the mirror array 2032 is controlled to reflect the laser light (i.e., OFF light) 2073 toward the light shield layer 2063 and the reflection light is absorbed.

In this projection apparatus, the light shield layer 2063 may be placed at a position closely adjacent to the rear surface of the color synthesis prism 2060 or placed outside of the color synthesis prism 2060. Either of these locations is on the extended optical axis of the laser light (i.e., the OFF light) 2073. It is also preferable to connect the light shield layer 2063 to a heat dissipation member in order to reduce a temperature rise of the light shield layer 2063 due to the incident light. Also, a configuration may be such that the light shield layer 2063 also functions as the heat dissipation member.

Meanwhile, the configuration is such that the laser light (i.e., the OFF light) 2073 enters the rear surface of the color synthesis prism 2060 at an angle smaller than the critical angle. For example, when the color synthesis prism 2060 is constituted by BK-7 (at the refraction index of 1.51467), the critical angle θ is given by:

θ=sin⁻¹(1/1.51467)□41.3 degrees,

and therefore, in this case, the configuration is such that the incident angle is smaller than 41.3 degrees. This configuration prevents the internal reflection of an extraneous modulation light within the color synthesis prism 2060, thus making it possible to eject the extraneous modulation light to the outside. This in turns enables an enhancement in the contrast of a projection image. It is an easy solution to extraneous modulation light because the light is externally ejected.

With this configuration, the laser light enters the projection lens 2070 at the maximum light intensity of the ON light, at an intermediate intensity between the ON light and OFF light of the intermediate light, and at the zero intensity of the OFF light. This configuration makes it possible to project an image in a high level of gradation. Note that the intermediate light state produces a reflection light reflected by a mirror in which the deflection angle is regulated between the ON light state and OFF light state.

Meanwhile, making the mirror perform a free oscillation causes it to cycle through the three deflection angles, producing the ON light, the intermediate light and the OFF light. Specifically, controlling the number of free oscillations makes it possible to adjust the light intensity and obtain an image in higher level of gradation.

FIG. 25D is a top view diagram of the two-panel projection apparatus 2500.

The mirror devices 2030 and 2040 are placed in the package, forming an approximately 45-degree angle, on the same horizontal plane, in relation to the four sides of the outer circumference of the package, as shown in FIG. 25D, and thereby the light in the OFF light state can be absorbed by the light shield layer 2063 without allowing the light to be reflected by the slope face of the color synthesis prism 2060, and the contrast of an image is improved.

Further, the heat generated inside of the package is conducted to the color synthesis prism 2060 by way of the thermal conduction member 2062 and is radiated to the outside from there. As such, the conduction of the heat generated in the mirror device to the color synthesis prism 2060 improves the radiation efficiency. Further, the heat generated by absorbing light is radiated to the outside instantly because the light shield layer 2063 is exposed to the outside.

When a mirror element reflects the incident light toward a projection lens 2070 at an intermediate light intensity (i.e., an intermediate state), that is, the intensity between the ON light and OFF light states, an effective reflection plane needs to be conventionally taken widely in the longitudinal direction of the slope face of a prism.

In contrast, the projection apparatus 2500 is enabled to provide a wide effective reflection plane in the thickness direction of the color synthesis prism 2060 even when the mirror element as described above has an intermediate state. With this configuration, the total reflection condition with which the reflection light from the mirror element is reflected by the slope face of the color synthesis prism 2060 can be alleviated.

Note that the locus of the optical axis of the modulation light modulated by the mirror (i.e. laser lights corresponding to the ON light state, OFF light state and intermediate light state), is preferred to be configured to be parallel to the synthesis surface 2055a, as indicated by a deflection locus 8404 shown in FIG. 25D. In the configuration described above, the light fluxes to transmit through the color synthesis prism 2060 can be reduced, as compared to the configuration of placing the optical axis locus 8404 of each mirror orthogonal to the synthesis surface 2055a. Reducing the light fluxes makes it possible to configure the color synthesis prism 2060 to be more compact. Further, the use of a laser light source as the light source makes it possible to further miniaturize the color synthesis prism 2060.

Furthermore, it is also preferred to form the bottom surface 2064a of the light guide prism 2064 approximately orthogonal to the synthesis surface 2055a. In such a case, the color synthesis prism 2060 can also be miniaturized.

### Embodiment 2-3

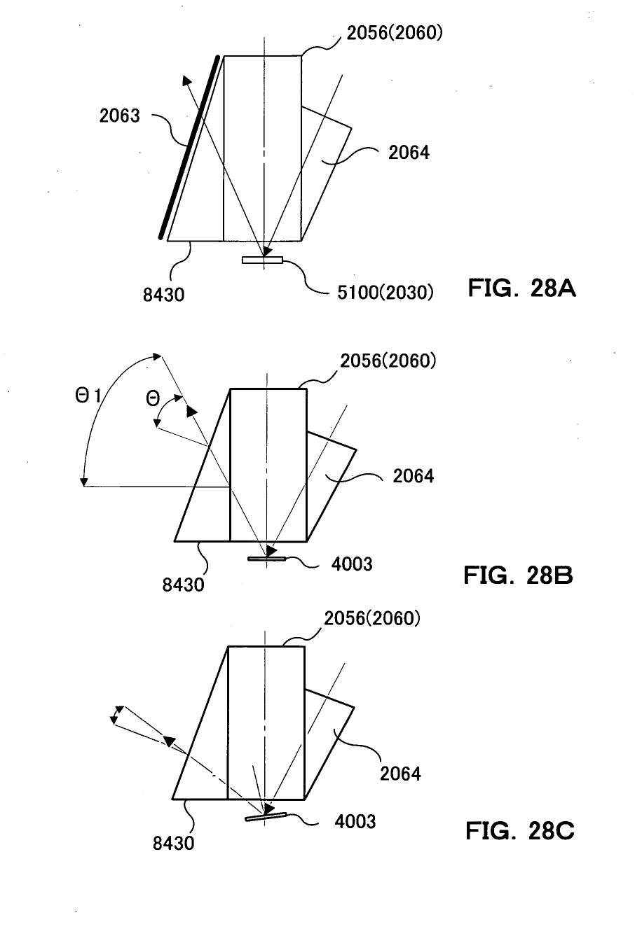

A projection apparatus according to the present embodiment is an exemplary modification of the embodiment 2-2. The projection apparatus according to the present embodiment is configured to further join a right-angle triangle columnar prism 8430 to the color synthesis prism 2060 and also covered with a light shield layer 2063 (i.e., a light absorption member) along the slope surface of the prism 8430, as illustrated in FIG. 28A.

The present embodiment is configured to cause the light shield layer 2063 to absorb extraneous modulation light after the light enters the joinder surface between the color synthesis prism 2060 and prism 8430, and then enters the slope surface thereof at an angle smaller than the critical angle. In this case, if the refraction index of the color synthesis prism 2060 and that of the prism 8430 are configured to be the same, the incidence angle to the prism 8430 may be set at any value and is not limited by the critical angle.

FIGS. 28B and 28C are diagrams for illustrating the optical path of an extraneous modulation light when the refractive index of the color synthesis prism 2060 is different from that of the prism 8430. FIG. 28B illustrates the optical path of a reflection light when the mirror 4003 is horizontal. FIG. 28C illustrates the optical path of a reflection light when the mirror 4003 is in the OFF state. In either case, an OFF light projected as the extraneous light is ejected outside of the prism 8430

Therefore, neither FIGS. 28B nor 28C specifically show the light shield layer 2063. Furthermore, in FIG. 28B, “θ1” indicates the incident angle of a reflection light relative to the joinder surface between the color synthesis prism 2060 and prism 8430, and “θ” indicates the incident angle of the reflection light relative to the slope surface of the prism 8430. If the color synthesis prism 2060 has a different refractive index than the prism 8430, both the “θ1” and “θ” must be smaller than the critical angle that is along a direction closer to the vertical direction relative to the surface of incidence. FIG. 28A shows another exemplary configuration that may also eliminate the light shield layer 2063.

### Embodiment 2-4

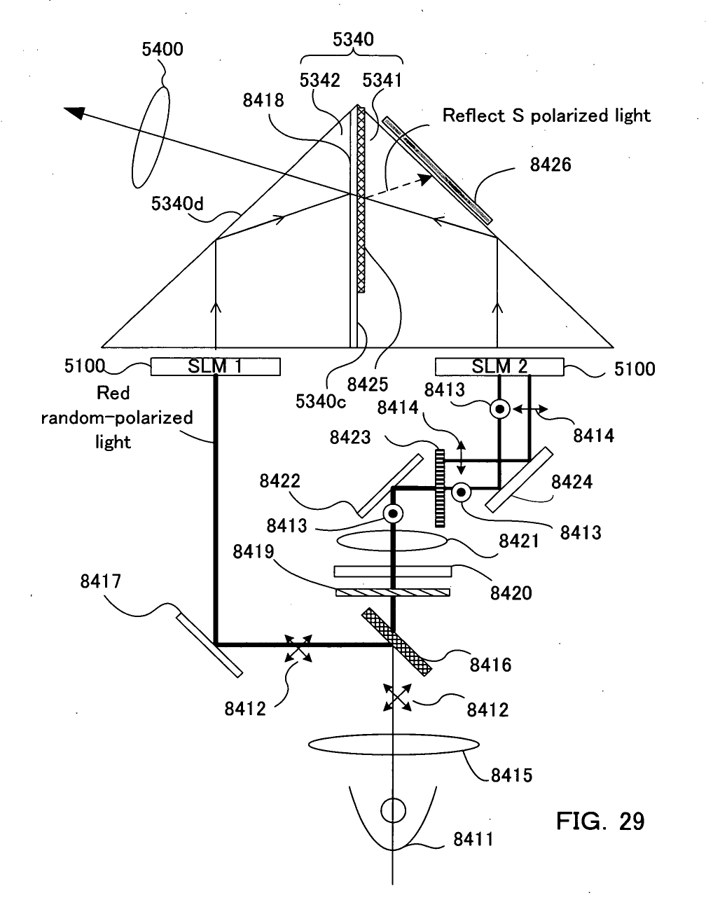

A projection apparatus according to the present embodiment is yet another exemplary modification of the embodiment 2-2. FIG. 29 is a diagram illustrating the configuration of a projection apparatus according to the present embodiment.

The light source, the configuration between the light source and optical prism, and a part of the optical prism are what distinguishes the exemplary configuration illustrated in FIG. 29 from the exemplary configuration shown in FIGS. 25A through 25D. The other components of the configuration are the.

In the exemplary configuration illustrated in FIG. 29, a light source 8411 is the light source emitting white light in a non-polarized state and is, for example, a mercury lamp, xenon lamp or a composite light source, obtaining a multiple wavelength light by irradiating a fluorescent body with a single color light source such as light emitting diode (LED).

FIG. 29 indicates the light in the non-polarization, P-polarization and S-polarization states by using the labels, 8412, 8413 and 8414, respectively.

The light emitted from the light source 8411 passes through an illumination optical system 8415 then transmitting to a dichroic filter 8416. The dichroic filter 8416 reflects the red light (i.e., the light of red frequency component) as part of the lights projected to the dichroic filter 8416 while the green and blue lights (i.e., the lights of green and blue frequency components) transmit through the present dichroic filter 8416.

The red light reflected by the dichroic filter 8416 is then reflected by a retention mirror 8417, is incident to the bottom surface of a light guide prism (not shown in drawing), is then ejected from the bottom surface of the color synthesis prism 5340 and is incident to the spatial light modulators (SLM 1) 5100. The path of the light after entering the spatial light modulator (SLM1) 5100 is basically the same as in the exemplary configuration shown in FIGS. 25A through 25D, and when the mirror is, for example, in an ON state, the light is reflected vertically upwards by the mirror and is re-incident to the bottom surface of the color synthesis prism 5340. Then, the red light incident to the bottom surface of the color synthesis prism is reflected by the slope surface (i.e., an ejection surface 5340d) of the right-angle triangle columnar prism 5342, is further reflected by the joinder surface 5340c that is the synthesis surface and is also synthesized with the light of P-polarization (which is described later). Then, the synthesized light is ejected from the ejection surface 5340d and is incident to a projection optical system 5400. Note that a dichroic color filter 8418 that reflects the light of the red frequency component and transmits the lights of the green and blue frequency components is implemented on the side of the joinder surface 5340c of the prism 5342.

Meanwhile, the green and blue lights transmitted through the dichroic filter 8416 are then polarized by a PS integrator 8419 as a linear polarized light, i.e., a P-polarization state in the present embodiment) and transmitted through a micro lens 8420 and lens 8421 and reflected by a retention mirror 8422 for projecting to a polarization conversion member 8423.

The polarization conversion member 8423 selectively rotates the polarizing direction of the light of a specific frequency component. The polarization conversion member 8423 can be implemented by using a color switch, a Faraday rotator, a photo-elastic modulator, or a wave plate that is inserted into a light path.

The polarization conversion member 8423 of the present embodiment changes the lights transmitted in different frequencies by rotating the polarizing direction. The polarizing directions of the green or blue lights are rotated by 90 degrees. The lights are converted into a S-polarization state for transmitting as output lights from the polarization conversion member 823. Specifically, the green light in the P-polarization state and the blue light in the S-polarization state are output from the polarization conversion member 8423, or the green light in the S-polarization state and the blue light in the P-polarization state are output therefrom.

The P-polarized light and S-polarized light projecting from the polarization conversion member 8423 are then reflected by a retention mirror 8424, are incident to the bottom surface of the light guide prism, are then ejected from the bottom surface of the color synthesis prism and are incident to the spatial light modulator (SLM 2) 5100.

The optical paths of the lights after entering the spatial light modulator (SLM 2) 5100 are basically the same as the optical paths shown in the exemplary configuration as depicted in FIGS. 25A through 25C and FIG. 29. The projection apparatus shown in FIG. 29, however, is implemented on the side the joinder surface 5340c of the prism 5341 with a polarization light beam splitter (PBS) 8425, for transmitting a P-polarized light and reflecting an S-polarized light. The projection apparatus is further implemented with a light absorption member 8426 on the slope surface of the prism 5341 for absorbing the light reflected by the PBS 8425. Accordingly, the optical path, when the mirror is operated in an ON state, is described in the following description.

Specifically, the lights incident to the spatial light modulator (SLM 2) 5100 are reflected vertically upward by the mirror, are re-incident to the bottom surface of the color synthesis prism, are reflected by the slope surface of the right-angle triangle columnar prism 5341 and are then incident to the PBS 8425. Then, of the lights incident to the PBS 8425, the P-polarized light transmits through the present PBS 8425, while the S-polarized light is reflected by the present PBS 8425 to be absorbed by a light absorption member 8426.

The P-polarized light (i.e., green or blue light) transmitting through the PBS 8425, further transmits through the joinder surface 5340c to pass through a dichroic color filter 8418 and synthesized with the above-described red light. The synthesized light is ejected from the ejection surface 5340d of the prism 5342 and is incident to the projection optical system 5400.

As described above, the projection apparatus shown in FIG. 29 also miniaturizes the optical system with the color synthesis prism, and enhance the contrast of a projection image as in the case of the projection apparatus according to the embodiment 2-2 One spatial light modulator (SLM 1) 5100 of the present embodiment shown modulates the red light constantly. Another spatial light modulator (SLM 2) 5100 modulates the green light and blue light alternately. It is well known that the red component is the least amount among the spectrum when a high-pressure mercury lamp is used as the light source. Therefore, the present embodiment is configured to constantly project the red light to compensate for a shortage of the red light in a light source. The light source with red light compensation can therefore effectively enhance the brightness of a projection image. For a light source implemented with a laser light, the laser light source is controlled to project a green light continuously, due to the low emission of the green light in the laser light. As described above, it is also advantageous to configure the projection apparatus for providing the best brightness and contrast of the image display by changing the allocations of the light source lights to the two spatial light modulators compatible with the characteristic of the light source.

### Embodiment 2-5

A projection apparatus according to the present embodiment comprises a light source, a plurality of spatial light modulators each comprising a mirror capable of deflecting an incident light emitted from the light source in an intermediate direction between two mutually different first and second directions, along with the first and second directions, a first joinder prism comprising a first optical surface to which at least two lights with mutually different frequencies are incident, a second optical surface from which the light from the first optical surface is ejected and to which the light modulated by a spatial light modulator is incident and a selective reflection surface reflecting the light from the first optical surface and transmitting a modulation light, a second joinder prism comprising a third optical surface to which a modulation light ejected from the first joinder prism is incident, a synthesis surface for synthesizing a plurality of lights incident to the third optical surface into the same light path and an ejection surface which is placed at a position approximately opposite to a projection lens and which is used for ejecting the synthesized light, wherein the first optical surface of the first joinder prism is approximately perpendicular to the synthesis surface of the second joinder prism.

Specifically, the first direction is defined as the direction in which the light emitted from a light source is deflected when the mirror is in an ON state. In contrast, the second direction is defined as the direction in which the light emitted from a light source is deflected when the mirror is in an OFF state.

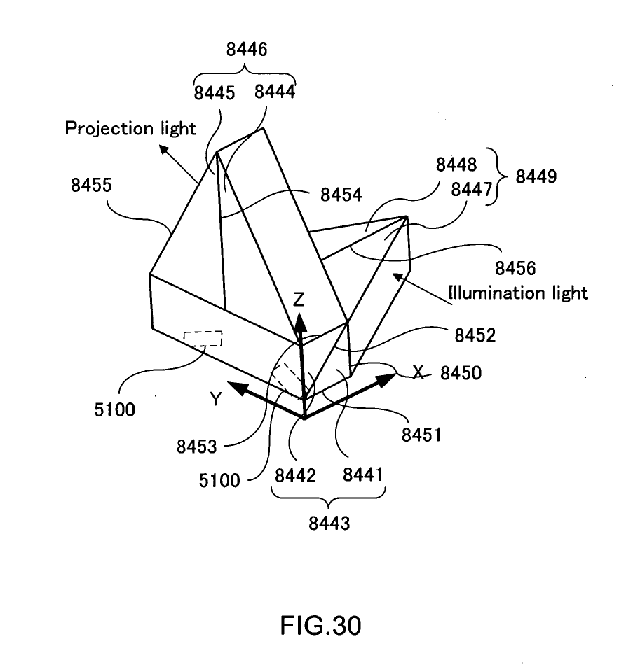

FIG. 30 is a diagram for showing the configuration of a projection apparatus according to the present embodiment, focusing on the optical system. The exemplary configuration shown in FIG. 30 comprises a first joinder prism 8443 structured by joining two right-angle triangle columnar prisms 8441 and 8442 of approximately a same shape. The image projection apparatus further includes a second joinder prism 8446 structured by joining two right-angle triangle columnar prisms 8444 and 8445 of the same form. The image projection apparatus further includes a third joinder prism 8449 which is similar with a second joinder prism 8446, structured by joining two right-angle triangle columnar prisms 8447 and 8448 of the same form.

The joinder surface with or opposite surface to the third joinder prism 8449 the first joinder prism 8443 is a first optical surface 8450 to receive a plurality of lights with individually different frequencies. Specifically, the first optical surface 8450 is perpendicular to the synthesis surface of the second joinder prism 8446 (which is described later). Further, an optical surface 8451 on the first joinder prism 8443 is the second optical surface (noted as “second optical surface 8451” hereinafter), which ejects the light from the first optical surface 8450. Furthermore, the modulation lights modulated by two spatial light modulators 5100 disposed immediately under the first joinder prism 8443 are also projected to the second optical surface 8451. Furthermore, an optical surface 8452 is a selective reflection surface (noted as “selective reflection surface 8452” hereinafter) to serve the function of reflecting the light from the first optical surface 8450 and transmitting a modulation light.

Furthermore, the joinder surface with, or opposite surface to, the first joinder prism 8443 on the second joinder prism 8446 is the third optical surface 8453 to receive the modulation light ejected from the first joinder prism 8443. Furthermore, the joinder surface between the prisms 8444 and 8445 is the synthesis surface 8454 for synthesizing a plurality of lights incident to the third optical surface 8453 into the same light path. Furthermore, the joinder surface between the prisms 8444 and 8445 is configured with a dichroic filter for reflecting the lights of red and blue frequency components and transmitting the light of green frequency component. Furthermore, an optical surface 8455 is the ejection surface (noted as “ejection surface 8455” hereinafter) disposed at a position approximately opposite to a projection lens (i.e., a projection optical system 5400; not shown in a drawing herein) for ejecting the synthesized light and that ejects the synthesized light. That is, the synthesized light synthesized on the synthesis surface 8454 is ejected toward the projection lens (i.e., the projection optical system 5400).

Note that the second joinder prism 8446 corresponds to the color synthesis prism 2060 of the projection apparatus according to the embodiment 2-2.

Further, the third joinder prism 8449 is placed in the optical path of the light between the light source and first joinder prism 8443. On the third joinder prism 8449, the prisms 8447 and 8448 are joined together on the joinder surface 8456. The dichroic filter reflects the light of the green frequency component and transmits the lights of the blue and red frequency components therethrough. The third joinder prism 8449 is thus capable of separating the incident light into lights having different frequencies.

Meanwhile, the exemplary configuration shown in FIG. 30 is also configured such that the deflection loci of the modulation lights modulated by the mirror (noted as “deflection loci” hereinafter), specifically, the loci formed by the optical axes of the modulation lights corresponding to the ON state, OFF state and intermediate state, are approximately parallel to the synthesis surface 8454 of the second joinder prism 8446, similar to the configuration of the projection apparatus according to the embodiment 2-2. Such a configuration makes it possible to reduce the number of light fluxes transmitted through the second joinder prism 8446, as compared to the case of placing the deflection loci of each mirror orthogonal to the synthesis surface. Therefore, this configuration allows a reduction in size of the second joinder prism 8446. Further, the width of the second joinder prism 8446 in a direction parallel to both the deflection loci and the third optical surface (i.e., the direction of X shown in FIG. 30) can be miniaturized to approximately the same size as the diameter of an entrance pupil of a projection optical system.

The incidence surface of the illumination light is placed on the right side of the third joinder prism 8449 when viewed from the direction of the z-axis in FIG. 30. Specifically, the incidence direction of the illumination light is approximately the same as the projecting direction of the projection light. Considering the configuration of the third joinder prism 8449, however, it is understood that the illumination light may be made incident from the left side. If it is configured to make the illumination light incident from the left side, the placement space of the projection lens and illumination optical system can be aligned in the Y+ direction, and thereby the space efficiency of the overall system can be improved.

In a projection apparatus according to the present embodiment configured as described above, when an illumination light is incident to the slope surface (i.e., the incidence surface) of the prism 8447 of the third joinder prism 8449, the green light is reflected by the joinder surface 8456 (i.e., the separation surface) while the red or blue light is transmitted through the joinder surface 8456 (i.e., the separation surface).

The green light reflected by the joinder surface 8456 is reflected by the slope surface of the prism 8447 and is projected from the fourth optical surface opposite to the first optical surface. The green light projected from the fourth optical surface of the third joinder prism 8449 is orthogonally incident to the first optical surface 8450 of the first joinder prism 8443, is reflected by the selective reflection surface 8452, is projected from the second optical surface and is incident to one spatial light modulator 5100. Then, when the mirror 5112 is in the ON state, the incident light is reflected vertically upward, is incident orthogonally to the second optical surface 8451, is transmitted through the selective reflection surface 8452 and is incident to the third optical surface 8453 of the second joinder prism 8446. The path of the green light thereafter, similar to the case of the projection apparatus according to the embodiment 2-2, in which the green light is reflected by the slope surface of the prism 8444, is transmitted through the synthesis surface 8454, and is synthesized with the red or blue light (which is described later) so that the synthesized light is ejected from the ejection surface 8455 to be incident to a projection optical system (which is not shown here).

Meanwhile, having transmitted through the joinder surface 8456 of the third joinder prism 8449, the red or blue light is reflected by the slope surface of the prism 8448, is incident orthogonally to the first optical surface 8450 of the first joinder prism 8443, then is reflected by the selective reflection surface 8452, is ejected from the second optical surface and is incident to the other spatial light modulator 5100, likewise the case of the above description. Then, when the mirror 5112 is in the ON state, the incident light is reflected vertically upward, is incident vertically relative to the second optical surface 8451, is transmitted through the selective reflection surface 8452 and is incident to the third optical surface 8453 of the second joinder prism 8446. The path of the red or blue light thereafter, similar to the case of the projection apparatus according to the embodiment 2-2, in which the red or blue light is reflected by the slope surface of the prism 8445, is reflected by the synthesis surface 8454, then is synthesized with the green light (which is described above) so that the synthesized light is ejected from the ejection surface 8455 to be incident to a projection optical system (which is not shown).

The above description is an exemplary configuration of the projection apparatus according to the present embodiment.

Note that the projection apparatus according to the present embodiment can also be configured to eliminate the third joinder prism 8449. In this case, however, a light source corresponding to the first optical surface 8450 of the first joinder prism 8443 is disposed oppositely to the first optical surface 8450, likewise the case of the projection apparatus according to the embodiment shown in the above described FIGS. 25A through 25D.

Further, in the projection apparatus according to the present embodiment, a portion of the modulation light modulated by the spatial light modulator 5100 is also incident to the structure surface 8446a (i.e., the fifth optical surface) (not shown in the drawing here) that is one side surface the second joinder prism 8446. In this case, the structure surface 8446a (i.e., the fifth optical surface) is preferred to be configured to cause the modulation light to be incident to the structure surface 8446a at an angle smaller than the critical angle.

The modulation light incident to the structure surface 8446a (i.e., the fifth optical surface) is a modulation light when the mirror is, for example, in the intermediate state. The modulation light incident to the structure surface 8446a may alternatively be a modulation light when the mirror is in the OFF state.

Such a configuration causes the modulation light incident to the structure surface 8446a (i.e., the fifth optical surface) to be transmitted through the structure surface 8446a (i.e., the fifth optical surface) without being totally reflected therein, thereby making it possible to remove an extraneous modulation light from within the optical system.

Although not shown in a drawing here, a light shield layer (i.e., light absorption member) may be implemented on the extended optical axis of the modulation light incident to the structure surface 8446a (i.e., the fifth optical surface) and on the outside of the second joinder prism or close to the structure surface 8446a (i.e., the fifth optical surface). This configuration makes it possible to process extraneous modulation light ejected from within the optical system. Specifically, a further preferable configuration is to connect the light shield layer to a heat dissipation member (i.e., heat radiator or heat sink) so as to reduce a temperature rise in the light shield layer due to a modulation light. A further alternative configuration may be to have the light shield layer per se function as heat dissipation member (i.e., heat radiator or heat sink).

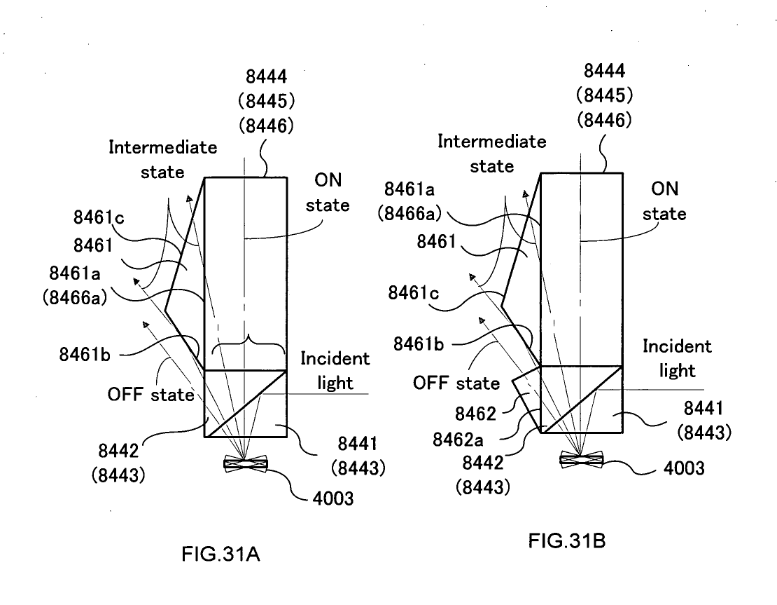

Further, the projection apparatus according to the present embodiment can also be configured to further join a triangle columnar prism 8461 to the structure surface 8446a (i.e., the fifth optical surface) of the second joinder prism 8446 as illustrated in FIG. 31A in order to eliminate an extraneous modulation light in early stage from the second joinder prism 8446; or can also be configured to further join the triangle columnar prism 8461 to the structure surface 8446a (i.e., the fifth optical surface) of the second joinder prism 8446 and also a triangle columnar prism 8462 to the prism 8442 of the first joinder prism 8443 as illustrated in FIG. 31B in order to eliminate an extraneous modulation light from the first joinder prism 8443 and second joinder prism 8446 in early stage.

If the refractive index of the prism 8461 is different from that of the second joinder prism 8446, however, the prism 8461 comprises a flat surface 8461a (i.e., a first flat surface) which is the joinder surface between the prism 8461 and the second joinder prism and to which a modulation light incident to the second joinder prism 8446, the reflection light as a portion of the modulation light when the mirror is in an intermediate state, is incident at an angle no larger than a critical angle; and comprises a flat surface 8461b (i.e., a second flat surface) on which a reflection light not incident to the second joinder prism 8446, the reflection light as a portion of the reflection light when the mirror is in an intermediate state, is incident at an angle no smaller than the critical angle.

Therefore, the modulation light incident to the flat surface 8461a at an angle no larger than the critical angle is transmitted through the prism 8461 as is, also is transmitted through a flat surface 8461c, to which an extraneous light is incident at an angle no larger than the critical angle, and is ejected to the outside. A reflection light irradiated on the flat surface 8461b at an angle no smaller than the critical angle is reflected by the flat surface 8461b to the outside.

With this configuration, the extraneous light when the mirror is in an intermediate state is ejected or reflected by the prism 8461 to the outside in early stage, and thereby the extraneous modulation light is eliminated from inside of the second joinder prism 8446 and accordingly the contrast of a projection image can be enhanced. If the refractive index of the prism 8461 is the same as that of the second joinder prism 8446, the condition for the incidence angle of extraneous light relative to the flat surface 8461a will be relaxed.

Further, if the refractive index of the prism 8462 is different from that of the joinder prism 8442, the prism 8462 comprises a flat surface 8462a to which a modulation light not incident to the second joinder prism 8446, the reflection light as a portion of the reflection light when the mirror is in an intermediate state, is incident at an angle no larger than the critical angle.

Therefore, the reflection light incident to the flat surface 8462a at an angle no larger than the critical angle is transmitted through the prism 8462 as is and is ejected to the outside.

With this configuration, the extraneous modulation light when the mirror is in the intermediate state is ejected to the outside also by the prism 8462, and thereby the extraneous modulation light is eliminated from the first joinder prism 8443 and second joinder prism 8446 and the contrast of a projection image can further be enhanced.

Note that an example in which the modulation light when the mirror is in the OFF state is not incident to the second joinder prism 8446 has been shown here, such case is arbitrary. An alternative configuration may be such that the modulation light when the mirror is in the OFF state is incident to the structure surface 8446a (i.e., the fifth optical surface). In such a case, a preferable configuration is such that the modulation light when the mirror is in the OFF state is incident to the structure surface 8446a (i.e., the fifth optical surface) at an angle smaller than the critical angle.

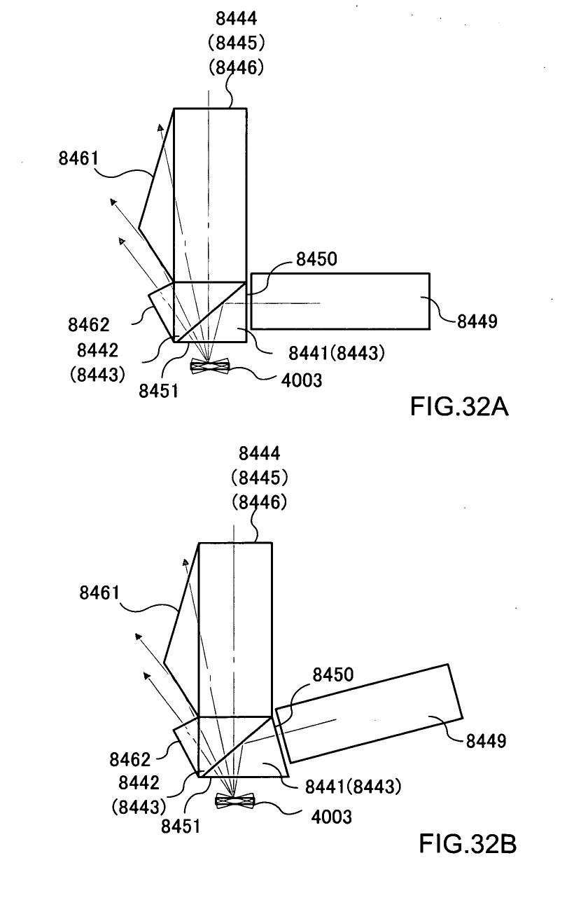

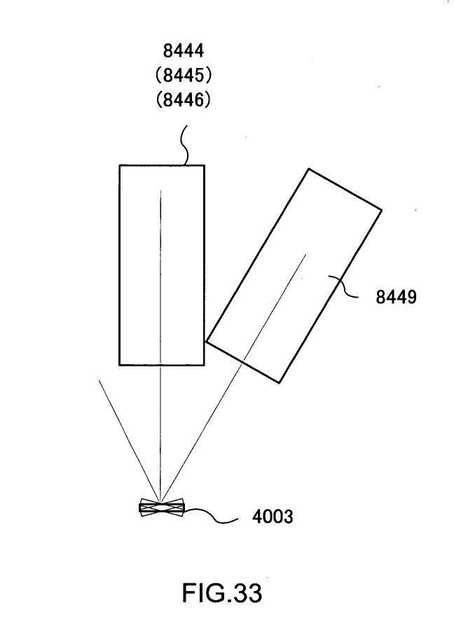

FIGS. 32A, 32B and 33 are diagrams illustrating the side views of the optical system of a projection apparatus according to the present embodiment.

As shown in FIG. 32A, the projection apparatus according to the present embodiment may be configured such that the surface, of the third joinder prism 8449, opposite to the first optical surface 8450 of the first joinder prism 8443 is placed approximately orthogonal to the second optical surface 8451 of the first joinder prism 8443. In such a case, the third joinder prism 8449 is actually placed by inclining approximately 90 degrees relative to the second joinder prism 8446.

Further as shown in FIG. 32B, an alternative configuration may be such that the surface, of the third joinder prism 8449, opposite to the first optical surface 8450 of the first joinder prism 8443 is placed at an angle smaller than 90 degrees relative to the second optical surface 8451 of the first joinder prism 8443. In such a case, the width, in the X direction, of the optical system used for the projection apparatus according to the present embodiment shown in FIG. 30 can be shortened. This configuration enables a further miniaturization of the overall projection apparatus.

Note that a preferable configuration is such that the first optical surface 8450 is placed approximately orthogonally to the synthesis surface of the second joinder prism in either cases of FIGS. 32A and 32B.

Further, the projection apparatus according to the present embodiment may be configured to eliminate the first joinder prism 8443 as shown in FIG. 33.

In such a case, the illumination light emitted from the third joinder prism 8449 will actually be incident directly to the spatial light modulator 5100. Further, the modulation light modulated by the spatial light modulator 5100 will be incident directly to the second joinder prism.

Therefore, the third joinder prism 8449 is placed at a position where the illumination light ejected from the present third joinder prism 8449 is modulated and reflected to an approximately vertical direction by the spatial light modulator 5100. Further specifically, the third joinder prism 8449 is placed in the axis inclined by an angle that is two times the maximum deflection angle of the mirror, with the axis orthogonally to the bottom surface of the second joinder prism as reference. That is, the third joinder prism 8449 is placed, relative to the second joinder prism, by inclining two times the maximum deflection angle of the mirror, the angle relative to the horizontal state of the mirror comprised in the spatial light modulator 5100.

As such, the configuration eliminating the first joinder prism 8443 contributes to a reduction of cost associated with the optical components and a miniaturization of the projection apparatus.

Further, the exemplary configuration shown in FIG. 30 that has been described as an exemplary configuration of the projection apparatus according to the present embodiment is so-called two-panel projection apparatus comprising two spatial light modulators; it can also be configured as so-called three-panel projection apparatus comprising three spatial light modulators as another exemplary configuration.

### Embodiment 2-6

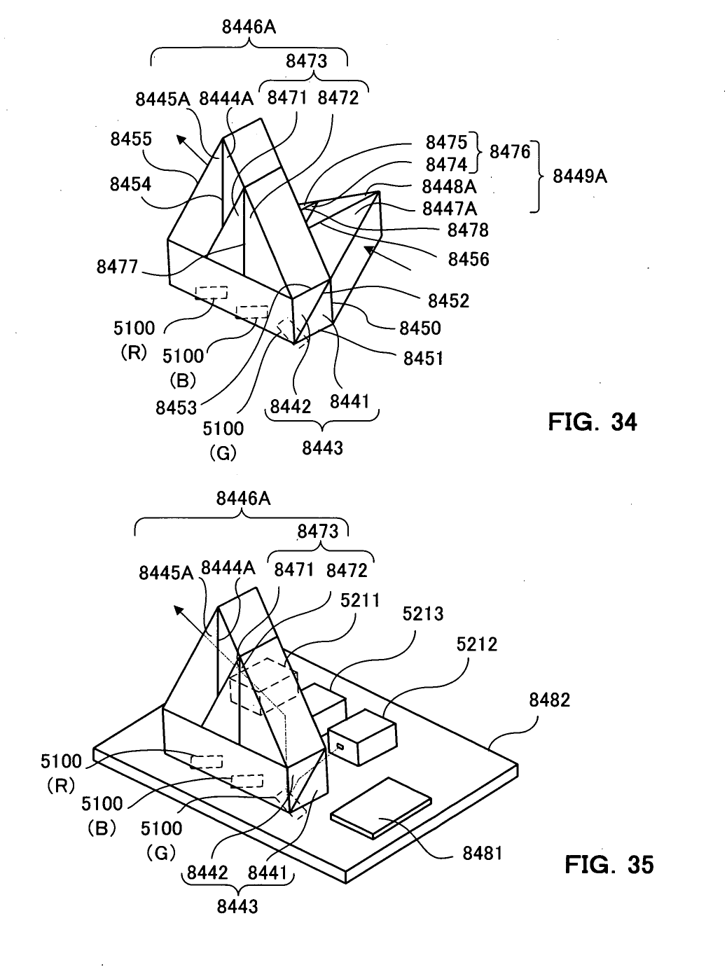

FIG. 34 is a diagram showing an exemplary configuration, mainly showing the optical system, when the projection apparatus according to the present embodiment is configured as a three-panel projection apparatus.

The exemplary configuration shown in FIG. 34 differs from the exemplary configuration shown in FIG. 30 where the configurations of a second joinder prism and of a third joinder prism are different in association with the former comprising three spatial light modulators. The second joinder prism and third joinder prism comprised in the exemplary configuration shown in FIG. 34 are defined as 8446A and 8449A, respectively, in the following description.

The second joinder prism 8446A is configured to replace a part of the second joinder prism 8446 shown in FIG. 30 with a fourth joinder prism 8473 that is structured by joining together two right-angle triangle columnar prisms 8471 and 8472 of the same form. Note that prism 8445A and prism 8444A are the respective remaining parts of the prism 8445 and prism 8444, both of which are parts the second joinder prism 8446 shown in FIG. 30. On the fourth joinder prism 8473, the joinder surface of the prisms 8471 and 8472 is a synthesis surface 8477 used for synthesizing the lights modulated by two spatial light modulators 5100 (G) and 5100 (B) in the same light path. Further, the synthesis surface is covered with a dichroic filter used for reflecting the light of the blue frequency component and transmitting the light of the green frequency component.

Further, the third joinder prism 8449A is a joinder prism similar to the second joinder prism 8446A, and is configured to replace a part of the third joinder prism 8449 with a fifth joinder prism 8476 that is structured by joining together two right-angle triangle columnar prisms 8474 and 8475 of the same form. Note that prism 8447A and prism 8448A are the respective remaining parts of the prism 8447 and prism 8448, both of which are parts of the third joinder prism 8449 shown in FIG. 30. On the fifth joinder prism 8476, the joinder surface 8478 joining the prisms 8474 and 8475 is covered with a dichroic filter used for reflecting the light of the blue frequency component and transmitting the light of the red frequency component.

Note that the exemplary configuration shown in FIG. 34 is configured such that the first optical surface 8450 of the first joinder prism 8443 is structured to be vertical to the synthesis surface 8454 of the second joinder prism 8446A and to the synthesis surface 8477 of the fourth joinder prism 8473.

Meanwhile, the exemplary configuration shown in FIG. 34 is also configured such that the deflection loci of the modulation lights modulated by the three spatial light modulators 5100 are approximately parallel to the synthesis surface 8454 of the second joinder prism 8446A likewise the case of exemplary configuration shown in FIG. 30.

In the projection apparatus according to the present embodiment configured as described above, when an illumination light enters the slope surface of the prism 8447A of the third joinder prism 8449A, the green light is reflected by the joinder surface 8456, and the red and blue lights are transmitted through the joinder surface 8456. Then, having transmitted through the joinder surface 8456, when the red and blue lights enters the slope surface of the prism 8474, the blue light is reflected by the joinder surface 8478, while the red light is transmitted through the joinder surface 8478.

The green light reflected by the joinder surface 8456 is reflected by the slope surface of the prism 8447A, is orthogonally incident to the first optical surface 8450 of the first joinder prism 8443, is reflected by the selective reflection surface 8452, is ejected from the second optical surface 8451 and is incident to the spatial light modulators 5100 (G). Then, when the mirror is in the ON state, the incident light is reflected vertically upward, is incident orthogonally to the second optical surface 8451, is transmitted through the selective reflection surface 8452 and is incident to the third optical surface 8453 of the second joinder prism 8446A. Having entered the third optical surface 8453, the green light is reflected by the slope surface of the prism 8472, is transmitted through the synthesis surface 8477 and is then synthesized with the blue light (which is described later) so that the synthesized light is ejected from the slope surface of the prism 8471 and is incident to the prism 8444A. Having entered the prism 8444A, the synthesized green and blue light transmits through the synthesis surface 8454, and is then synthesized with the red light (which is described later) so that the synthesized light is ejected from the ejection surface 8455 and is incident to a projection optical system (not shown here).

Having been reflected by the joinder surface 8478 of the fifth joinder prism 8476, the blue light is reflected by the slope surface of the prism 8474, is incident orthogonally to the first optical surface 8450 of the first joinder prism 8443, is reflected by the selective reflection surface 8452, is ejected from the second optical surface 8451 and is incident to the spatial light modulators 5100 (B). Then, when the mirror is in the ON state, the incident light is reflected vertically upward, is incident orthogonally to the second optical surface 8451, is transmitted through the selective reflection surface 8452 and is incident to the third optical surface 8453 of the second joinder prism 8446A. Having entered the third optical surface 8453, the blue light is reflected by the slope surface of the prism 8471, is further reflected by the synthesis surface 8477 and is synthesized with the above described green light so that the synthesized light is ejected from the slope surface of the prism 8471 and is incident to the prism 8444A. Having entered the prism 8444A, the green and blue synthesized light is transmitted through the synthesis surface 8454, and is then synthesized with the red light (which is described later) so that the synthesized light is ejected from the ejection surface 8455 and is incident to a projection optical system (not shown in a drawing herein).

Having been transmitted through the joinder surface 8478 of the fifth joinder prism 8476, the red light is reflected by the slope surface of the prism 8475, is incident orthogonally to the first optical surface 8450 of the first joinder prism 8443, is reflected by the selective reflection surface 8452, is ejected from the second optical surface 8451 and is incident to the spatial light modulators 5100 (R). Then, when the mirror is in the ON state, the incident light is reflected vertically upward, is incident orthogonally to the second optical surface 8451, is transmitted through the selective reflection surface 8452 and is incident to the third optical surface 8453 of the second joinder prism 8446. Having entered the third optical surface 8453, the red light is reflected by the slope surface of the prism 8445A, is further reflected by the synthesis surface 8454 and is then synthesized with the above described blue/green synthesized light so that the synthesized light is ejected from the ejection surface 8455 and is incident to a projection optical system (not shown in a drawing herein).

The above description is another exemplary configuration of the projection apparatus according to the present embodiment.

Note that the exemplary configuration shown in FIG. 34 can also be configured to eliminate the third joinder prism 8449. In such a case, however, the light sources of the respectively corresponding colors are implemented opposite to the first optical surface 8450 of the first joinder prism 8443.

Further, in this case, an alternative configuration may be such as to use the red laser light source 5211, green laser light source 5212 and blue laser light source 5213, as the light sources of the respective colors, and place these light sources, the optical system made by joining the first joinder prism 8443 and second joinder prism 8446A together, three spatial light modulators 5100 and a controller 8481 used for controlling the aforementioned components on the same board 8482, as illustrated in FIG. 35. Such a configuration makes it possible to make the projection apparatus more compact.

Further, the configuration shown in FIGS. 31A, 31B, 32A, 32B and 33 can be applied also to the projection apparatus according to the present embodiment.

As described above, the projection apparatuses implemented with a plurality of spatial light modulators according to the embodiments 2-2 through 2-6 achieves improved contrast of a projection image with a more compact projection apparatus.

Note that the projection apparatuses according to the present embodiments may be implemented with alternate embodiments and changed in various manners possible within the scope of the present embodiment.

### Embodiment 2-7

The following is a description of a suitable projection lens when the mirror device comprised in the projection apparatus according to the present embodiment is miniaturized.

If a mirror device with a diagonal size of 0.95 inches is used for a rear projection system with about 65-inch screen size, the required projection magnification ratio is about 68. If a mirror array with a diagonal size of 0.55 inches is used, the required projection magnification ratio is about 118. As such, the projection magnification increases in association with the miniaturization of the mirror array. This ushers in the problem of color aberration caused by a projection lens.

The focal distance of the lens needs to be shortened to increase the projection magnification. Accordingly, the F-number for the projection lens is set at 5 or higher by comprising a laser light source. With this, it is possible to use a projection lens with the F-number at 2 times, and the focal distance at a half, as included in a configuration of a mercury lamp and a focal distance is 15 mm with the F-number at about 2.4 for the projection lens. The usage of a projection lens with a large F-number makes it possible to reduce the outer size of the projection lens. This in turn reduces the image size with which a light flux passes through the illumination optical system, thereby making it possible to suppress a color aberration caused by the projection lens.

Therefore, in the case of using a laser light source with a mirror device miniaturized to between 0.4 inches and 0.87 inches, the deflection angle of mirror can be reduced to between +7 degrees and ±5 degrees, and the F-number for a projection lens can be increased. Alternatively, the setting of the numerical aperture NA of an illumination light flux between 0.1 and 0.04 with the deflection angle of mirror maintained at +13 degrees makes it possible to reflect the OFF light to a large distance from the projection lens, improving the contrast of the projection image.

As described above, the projection magnification of a projection lens can be set at 75× to 120× by reducing the numerical aperture NA of the light flux emitted from a laser light source, using a miniaturized mirror device (diagonal size of 0.4 inches to 0.87 inches) with which the deflection angle of mirror is reduced to between ±7 degrees and ±5, and thereby the F-number for a projection lens is increased.

Meanwhile, when a mirror device is moved forward or backward relative to the optical axis of projection, the distance at which a blur (i.e., becomes out of focus) of a projected image is permissible is called a focal depth. When an image is projected with a permissible blur in a degree of the mirror size by an optical setup of the same focal distance, projection magnification and mirror size, a depth of focus is approximated as follows:

Depth of focus Z=2*(permissible blur)*(F number)

Specifically, the depth of focus Z is proportional to the F-number of a projection lens. That is, the permissible distance of the shift in positions of a placed mirror device, relative to the optical axis of projection, increases with F-number. This factor is represented by the relationship between a permissible circle of confusion and a depth of focus. As an example, where the F number of a projection lens is “8” and the permissible blur is equivalent to a 10 μm mirror size in the above described approximation equation, the depth of focus is:

Z=2*10*8=160 [μm]

Further, where a mirror size is 5 μm and an F-number is 2.4, the depth of focus is 24 μm. Specifically, considering the errors of a projection lens and other components of the optical system, the depth of focus is preferred to be no larger than 20 μm or several micrometers or less. With this in mind, when the top or bottom surface of a package substrate is taken as reference, the difference in heights of the reflection on the surface of mirrors placed respectively on both ends of a mirror array is preferred to be no more than 20 μm.

Further, a blurred image of dust, on the surface of a cover glass, can be made invisible by providing a distance between the mirror surface and the bottom surface of the cover glass of no less than the value of the depth of focus. It is therefore preferable to configure the distance between the top surface of the mirror and the bottom surface of the cover glass with a distance of at least 20 times, or more, of the mirror size.

### Third Embodiment

The following is description, in detail, of the configuration of the control unit of the projection apparatus described for the second embodiment with reference to the accompanying drawings.

### Embodiment 3-1

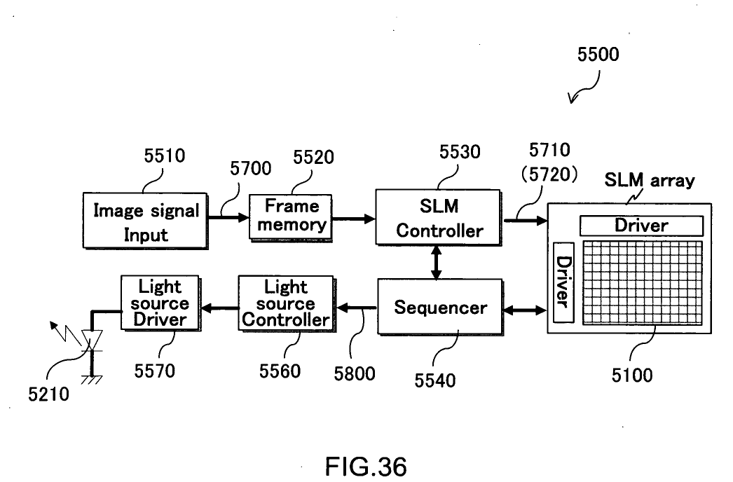

FIG. 36 is a block diagram for illustrating a control unit 5500 implemented in the above described single-panel projection apparatus 5010. The following is a description of the control unit of the projection apparatus according to the present embodiment using, as an example, the control unit 5500 comprised in the single-panel projection apparatus 5010.

The control unit 5500 comprises a frame memory 5520, an SLM controller 5530, a sequencer 5540, a light source control unit 5560 and a light source drive circuit 5570.

The sequencer 5540, constituted by a microprocessor, controls the operation timing of the entirety of the control unit 5500 and spatial light modulators 5100.

The frame memory 5520 retains the amount of one frame of input digital video data 5700 incoming from an external device (not shown in drawing) that is connected to a video signal input unit 5510. The input digital video data 5700 is updated every time the display of one frame is completed in real time.

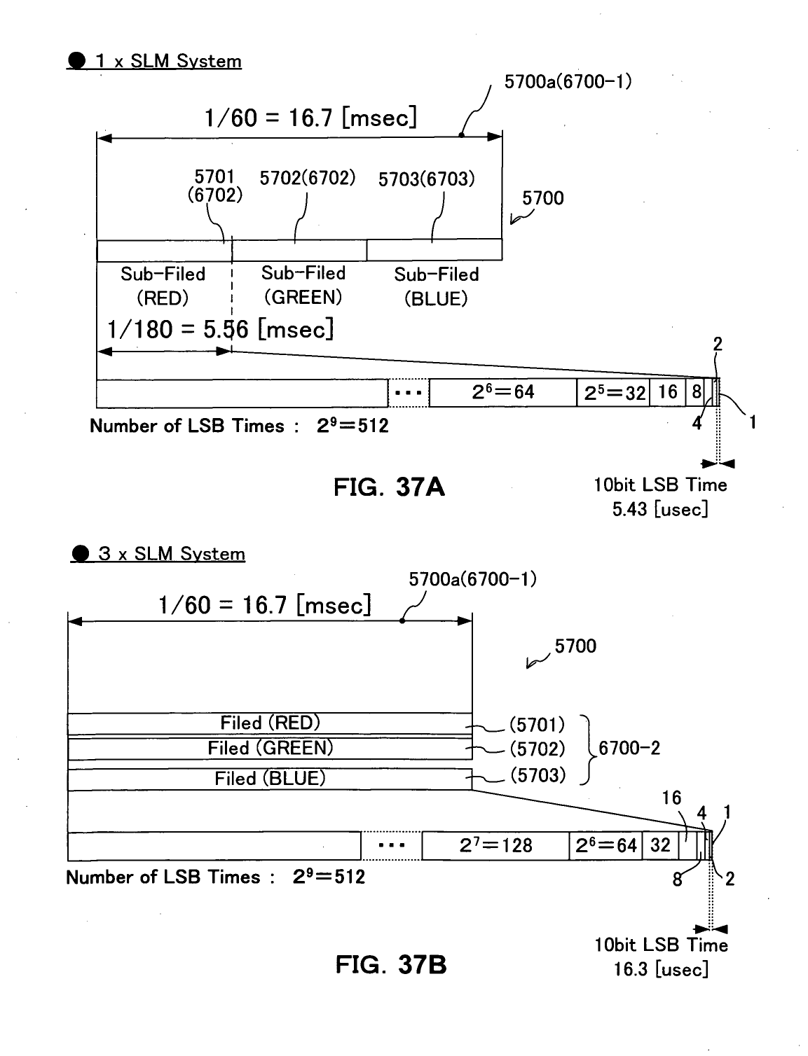

In the case of the single-panel (1×SLM) projection apparatus 5010, one frame (i.e., a frame 6700-1) of the input digital video data 5700 is constituted by a plurality of subfields 6701, 6702 and 6703, in a time sequence, corresponding to the respective colors R, G and B as shown in FIG. 37A in order to carry out a color display by means of a color sequence method.

The SLM controller 5530 separates the input digital video data 5700 read from the frame memory 5520 into a plurality of subfields 6701, 6702 and 6703, then converts them into mirror profiles (i.e., mirror control profiles 6710 and 6720) that are drives signals for implementing the ON/OFF control and oscillation control for the mirror of the spatial light modulator 5100 for each sub-field and outputs the converted mirror profiles to the spatial light modulator 5100.

Note that the mirror control profile 6710 is a mirror control profile consisting of binary data. Specifically, the binary data means the data in which each bit has a different weighting factor and which includes a pulse width in accordance with the weighting factor of each bit. Meanwhile, the mirror control profile 6720 is a mirror control profile consisting of non-binary data. Specifically, the non-binary data means the data in which each bit has an equal weighting factor and which includes a pulse width in accordance with the number of continuous bits of “1”.

The mirror control profile generated by the SLM controller 5530 is also inputted to the sequencer 5540, which in turn transmits a light source profile control signal 5800 to the light source control unit 5560 on the basis of the mirror control profile input from the SLM controller 5530.

The light source control unit 5560 instructs the light source drive circuit 5570 regarding the emission timing and light intensity of an illumination light 5600 required of the variable light source 5210 corresponding to the driving of the spatial light modulator 5100. The variable light source 5210 performs emission so as to emit the illumination light 5600 at the timing and light intensity driven by the light source drive circuit 5570.

With this control, it is possible to change the brightness of a displayed pixel through a continuous adjustment of the emission light intensity of the variable light source 5210 and to control the characteristics of the gradations of the display image in the midst of driving the spatial light modulator 5100, that is, in the midst of displaying an image onto the screen 5900. The emission light intensity of the variable light source 5210 is adjusted by using a mirror control profile used for driving the spatial light modulator 5100, and therefore no extraneous irradiation occurs, making it possible to reduce the heat from and the power consumption of the variable light source 5210.

The description above is based on the example of the control unit 5500 comprised in the single-panel projection apparatus. In the case of a multi-panel projection apparatus, however, a configuration may be such that the SLM controller 5530 and sequencer 5540 control a plurality of spatial light modulators 5100. An alternative configuration may be to equip an apparatus with multiple SLM controllers, in place of the SLM controller 5530, so as to control the respective spatial light modulators 5100.

In the case of a multi-panel projection apparatus, the structure of the input digital video data 5700 is also different. In the case of, for example, the above described multi-panel (3×SLM) projection apparatuses 5020, 5030 and 5040, the input digital video data 5700 corresponding to one frame (i.e., the frame 6700-1) display period is constituted by a plurality of fields 6700-2 (i.e., which are equivalent to the subfields 6701, 6702 and 6703) corresponding to the respective colors R, G and B, and the fields of the respective colors are outputted to the respective of spatial light modulators 5100 simultaneously, as shown in FIG. 37B. Also in this case, these subfields are outputted after being converted into the above described mirror control profile 6710 or mirror control profile 6720 for each of the fields 6700-2.

### Embodiment 3-2

The following is a description, in detail, of the embodiment of controlling the variable light source 5210 with the light source profile control signal 5800 corresponding to the mirror control profile.

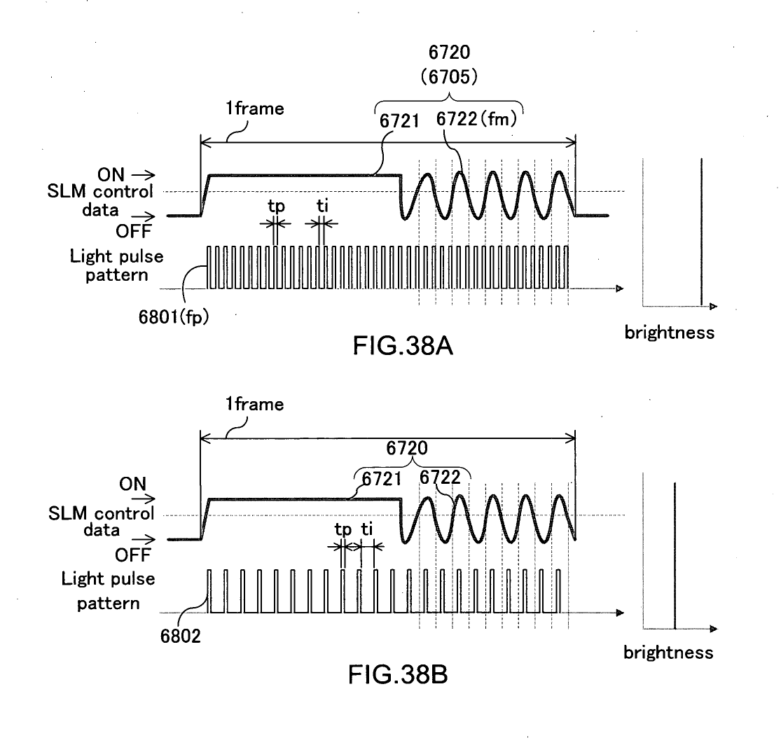

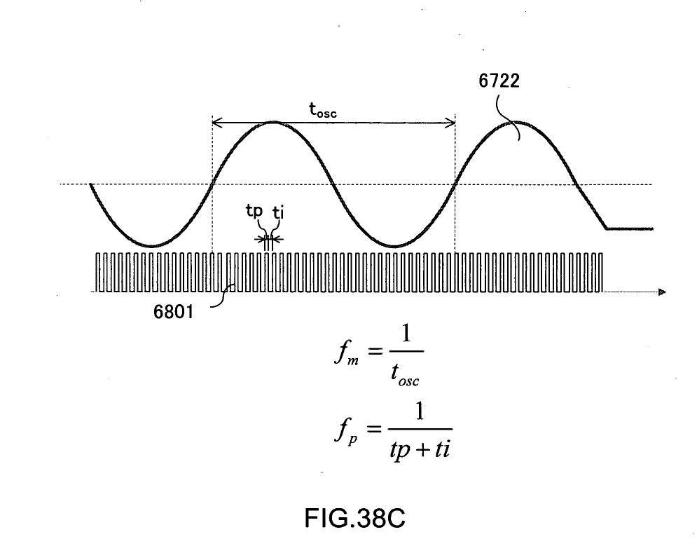

FIGS. 38A and 38B are timing diagram for showing the waveform of a mirror control profile 6720, that is a control signal output from a SLM controller 5530 to a spatial light modulator 5100, and an example of the waveform of a light source pulse pattern 6801 generated by a light source control unit 5560 from a light source profile control signal 5800 corresponding to the aforementioned mirror control profile 6720.

In this case, one frame of the mirror control profile 6720 includes the combination of a mirror ON/OFF control 6721 in the early stage of the frame and a mirror oscillation control 6722 in the later stage of the frame and is used for controlling the tilting operation of the mirror corresponding to the gray scale of the present frame.

The mirror ON/OFF control signal 6721 controls the mirror under either of the ON state or OFF states, and the mirror oscillation control signal 6722 controls the mirror 5112 under an oscillation state in which it oscillates between the ON state and OFF state.

The light source control unit 5560 changes the frequencies of the pulse emission of the variable light source 5210 in accordance with the signal (i.e., mirror control profile 6720) driving the spatial light modulator 5100. The spatial light modulator 5100 is the above described mirror device 4000 and performs a spatial light modulation of the illumination light 5600 by means of a large number of mirrors corresponding to pixels to be displayed and of the tilting operation of the mirrors.

In controlling the mirror element with the mirror oscillation control signal 6722, the pulse emission frequency fp of the variable light source 5210 emitting the illumination light 5600 is preferably either higher (in the case of the light source pulse pattern 6801 shown in FIG. 38A) by ten times, or more, than the oscillation frequency fm of the oscillation control for the mirror, or lower (in the case of the light source pulse pattern 6802 shown in FIG. 38B) by one tenth, or less, than the frequency fm. The reason is that, if the oscillation frequency fm of the mirror and the pulse emission frequency fp of the variable light source 5210 are close to each other, a humming occurs which may hamper an accurate display of gray scales by means of the mirror oscillation control 6722.

FIG. 38C is a timing diagram for illustrating the above described light source pulse pattern 6801, which is shown by enlarging a part of the pulse pattern 6801. The timing diagram corresponds to the mirror oscillation control 6722. The mirror oscillation control 6722 control the mirror to oscillate at an oscillation cycle tosc (1/fm), and in contrast the light source pulse pattern 6801, perform pulse emission at a pulse emission frequency fp (1/(tp+ti)) with [emission pulse width tp+emission pulse interval ti] as one cycle. In this case, the condition is: fp>(fm*10)

Based on what is shown in FIG. 38C, about 32 pulses of emission is carried out during the oscillation cycle tosc of the mirror oscillation control 6722.

As described above, adjustment of the light intensity of the illumination light 5600 emitted from the variable light source 5210 is achievable by changing the frequencies of the pulse emission of the variable light source 5210. Note that the present invention may be changed in various manners possible within the scope of the present invention, and is not limited to the configurations shown in the above-described embodiments.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

What is claimed is:

1. A projection apparatus, comprising:
a light source for projecting a light;
a plurality of spatial light modulators each comprising a micromirror for modulating and deflecting the light projected from the light source in an intermediate direction between a first and second directions and all angles between the first and second directions;
a projection optical system for projecting a modulation light modulated by the spatial light modulator;
a first joinder prism comprising a first optical surface for projecting the light at least two incident lights with mutually different frequencies thereto, a second optical surface for ejecting an incident light from the first optical surface and for projecting a modulation light thereto, and a selective reflection surface for reflecting an incident light from the first optical surface and transmitting the modulation light; and
a second joinder prism comprising a third optical surface for ejecting the modulation light ejected from the first joinder prism, a synthesis surface for synthesizing the modulation lights with different frequencies transmitted from the third optical surface in the same light path, and an ejection surface disposed at a position approximately opposite to the projection optical system for ejecting a synthesized light synthesized on the synthesis surface, wherein the first optical surface is approximately perpendicular to the synthesis surface.

2. The projection apparatus according to claim 1, further comprising
a third joinder prism disposed in a light path of the incident light and between the light source and first joinder prism having a similar shape as the second joinder prism.

3. The projection apparatus according to claim 2, wherein:
the third joinder prism comprises an incidence surface for projecting the incident light thereto, a separation surface for separating the incident light transmitted from the incidence surface, and a fourth optical surface for ejecting the incident light separated on the separation surface to the first optical surface, wherein
the fourth optical surface is disposed opposite to the first optical surface.

4. The projection apparatus according to claim 1, wherein:
the second joinder prism comprises a fifth optical surface approximately perpendicular to the synthesis surface and with a portion of the modulation light projected thereto, wherein
the modulation light is incident to the fifth optical surface at an angle smaller than a critical angle.

5. The projection apparatus according to claim 1, wherein:
the second joinder prism comprises a fifth optical surface approximately perpendicular to the synthesis surface and with a portion of the modulation light projected thereto, and the projection apparatus further comprises a fifth-surface joinder prism joined to the second joinder prism on the fifth optical surface, wherein
the fifth-surface joinder prism comprises a first flat surface constituting a joinder surface between the fifth-surface joinder prism and second joinder prism for transmitting the modulation light ejected from the second joinder prism thereto at an angle smaller than a critical angle, and
a second flat surface for projecting the modulation light incident from elsewhere other than the joinder surface thereto at an angle greater than or equal to the critical angle.

6. The projection apparatus according to claim 2, wherein:
the width of the second joinder prism in a direction parallel to the third optical surface and parallel to the deflection locus formed by the modulation light is approximately equal to the diameter of the entrance pupil of the projection optical system.

7. The projection apparatus according to claim 2, wherein:
the incident light is projected to the third joinder prism along a direction approximately the same as the direction of the synthesized light ejected from the second joinder prism.

8. The projection apparatus according to claim 4, further comprising:
a light absorption member is disposed in the extended optical axis of the modulation light incident to the fifth optical surface and outside of the second joinder prism or near the fifth optical surface.

9. The projection apparatus according to claim 4, further comprising:
a heat dissipation device disposed in the extended optical axis of the modulation light incident to the fifth optical surface and outside of the second joinder prism or near the fifth optical surface.

10. A projection apparatus, comprising:
a light source;
a plurality of spatial light modulators each comprising a micromirror for modulating and deflecting an incident light emitted from the light source in an intermediate direction between a first and a second directions and all angles between the first and second directions;
a wavelength-separation prism for separating an illumination light into lights with different wavelengths for ejecting to the micromirror; and
a synthesis prism disposed with a specific inclination angle relative to the wavelength-separation prism with a synthesis surface for synthesizing the modulation lights modulated by the micromirror transmitting in a same light path.

11. The projection apparatus according to claim 10, further comprising:
a projection optical system, wherein
the synthesis prism ejects the synthesized light synthesized on the synthesis surface toward the projection optical system.

12. The projection apparatus according to claim 10, wherein:
the specific inclination angle is approximately 90 degrees.

13. The projection apparatus according to claim 10, wherein:
the specific inclination angle is two times of a maximum deflection angle of the micromirror relative to the horizontal state thereof.

14. The projection apparatus according to claim 10, further comprising:
a projection optical system, wherein
the modulation light deflected in the first direction is incident to a surface of the synthesis prism, opposite to the projection optical system, and
the modulation light deflected in the second direction is incident to an optical surface of the synthesis prism approximately perpendicular to the synthesis surface at an angle smaller than a critical angle.
